(19) United States
(12) Patent Application Publication
(10) Pub. No.: US 2002/0174049 A1
(43) Pub. Date: Nov. 21, 2002

(54) Apparatus and method for supporting investment decision making, and computer program

(76) Inventor: Yasutomi Kitahara, Tokyo (JP)

Correspondence Address: SUGHRUE MION, PLLC, 2100 Pennsylvania Avenue, NW, Washington, DC, 20037-3213, US

(21) Appl. No.: 10/143,950

(22) Filed: May 14, 2002

(30) Foreign Application Priority Data
May 14, 2001 (JP) 2001-144036
Apr. 24, 2002 (JP) 2002-123164

(51) Int. Cl. G06F 17/60

(52) U.S. Cl. 705/36

(57) ABSTRACT

The apparatus for supporting an investment decision making is provided with profit model editing section which creates or modifies a profit model which shows a relationship between any parameter and cash flow; data set editing section which creates and modified a data set including values of the parameter; a case saving section which saves a case where a profit model is associated with one or plural data sets; and an analysis processing section which performs various analysis processings of a working case comprising the profit model of the case which has been saved by the case saving unit and the one data set or one of the plurality of data sets as the minimum unit of simulation.

### FIELD OF THE INVENTION

The present invention relates to an apparatus and method for supporting an investment decision making, which supports a decision making for an investment to a research and development project accompanying a large scale investment and a high risk in a pharmaceutical company, a biochemical enterprises or the like, and a program which causing a computer to execute the method.

### BACKGROUND OF THE INVENTION

Recently, in a R&D (research and development) investment, its environment varies rapidly, which results in increase in risk of investment and expansion of an amount of investment. In particularly, in order to establish/maintain a priority in a current pharmaceutical industry, a current biochemical industry, or the like, where a production development competition becomes keen and a business developing unit is spreading, it is necessary to examine a business value in a many scenarios as possible about as many products as possible. Much labor is required for such an examination and a business chance will be thrown away unless the examination is made rapidly.

However, in such a situation that economical or business world conditions vary bewilderingly, when a business value evaluation at a fixed point is employed in a conventional manner, even if an elaborate prediction is made, an actual result is much different from an expected value in many cases. It is required to recognize a range of situations including the worst case, which may occur actually, and make a business judgement considering a measure for a risk management. Also, in the judgment of a business value at a fixed point, there is a problem that information about which assumption has a great influence to a business value and whether or not a better result can be obtained by paying attention to management thereof is not made clear.

Also, since judgement processes in business value evaluations made by respective business managers are not standardized, such a phenomenon as fluctuation of accuracy of prediction data, different formats of outputs or the like occurs so that such a non-efficiency as “it is difficult to make a objective comparison between projects”, “it is required to perform additional operation only for the comparison” or the like is generated. Furthermore, such a situation may occur that definitions of evaluation indicators used in respective business value judgements are delicately different from one another so that accurate comparative analysis can not be performed.

Particularly, in recent years, an opportunity for an investment for a biochemical venture is increasing. Regarding the biochemical venture, since it is in an early stage, a success probability is low, it is difficult to calculate a value which a project produces, and since it is a novel field, there is few success examples and it is much difficult to calculate a value which the project produces. Also, such investment lacks a calculation base of a proper contract fee/investment amount. Furthermore, there is a problem that an economical value can not be recognized in a conventional approach.

### SUMMARY OF THE INVENTION

It is an object of the present invention to provided an apparatus and method for supporting an investment decision making, which allows performing valuation (economic value evaluation) of an R&D project accompanying a high risk and a large scale investment, simulating an economic value of the project varying due to various uncertainties and supporting an optimal investment decision making, and a program which causes a computer to execute the method.

The apparatus for supporting an investment decision making according to one aspect of this invention comprises a profit model editing unit which creates or modifies a profit model which shows a relationship between any parameter and cash flow, a data set editing unit which creates and modified a data set including values of the parameter, a case saving unit which saves a case where a profit model which has been created or modified by the profit model editing unit is associated with one or plural data sets which have been created or modified by the data set editing unit, an analysis processing unit which performs various analysis processings of a working case comprising the profit model of the case which has been saved by the case saving unit and the one data set or one of the plurality of data sets as the minimum unit of simulation, and a display unit which displays the analysis result obtained by the analysis processing performed by the analysis processing unit.

The method for supporting an investment decision making according to another aspect of this invention comprises a profit model editing step of creating or changing a profit model which shows a relationship between any parameter and a cash flow, a data set editing step of creating or changing a data set including values of the parameter, a case saving step of saving a case where one profit model created or modified in the profit model editing step is associated with one or plural data sets which has been created or modified in the data set editing step, an analysis processing step of performing various analysis processings of a working case comprising the profit model of the case which has been saved in the case saving step the one data set or one of the plural data sets as a minimum unit of simulation, and a display step of displaying an analysis result obtained by the analysis processing in the analysis processing step.

Other objects and features of this invention will become apparent from the following description with reference to the accompanying drawings.

### BRIEF DESCRIPTION OF THE DRAWINGS

FIG. 1 is a function block diagram which functionally shows a configuration of an apparatus for supporting an investment decision making according to an embodiment of the present invention;

FIG. 2 is an explanatory diagram which shows a data management structure;

FIG. 3 is a project maintenance function screen;

FIG. 4 is an explanatory diagram which shows uncertainties (assumptions) of data items

FIG. 5 is an explanatory diagram which shows an uncertainty about different strategies and assumptions;

FIG. 6 is an explanatory diagram which shows cash flow analysis dump data;

FIG. 7 is an explanatory diagram which shows a cash flow analysis preview;

FIG. 8 is an explanatory diagram which shows another cash flow analysis preview;

FIG. 9 is an explanatory diagram which shows a glass zoom;

FIG. 10 is an explanatory diagram which shows another glass zoom;

FIG. 11 is an explanatory diagram which shows a main screen of a system profile maintenance;

FIG. 12 is an explanatory diagram which shows a spider graph of a sensitivity analysis;

FIG. 13 is an explanatory diagram which shows a unit editor of a system profile maintenance;

FIG. 14 is an explanatory diagram which shows a main screen of a project maintenance/case editor;

FIG. 15 is an explanatory diagram which shows an actuation screen of the project maintenance/case editor;

FIG. 16 is an explanatory diagram which shows a creation project screen of the project maintenance;

FIG. 17 is an explanatory diagram which shows a maintain project screen of the project maintenance;

FIG. 18 is an explanatory diagram which shows a copy project screen of the project maintenance;

FIG. 19 is an explanatory diagram which shows another maintain project screen of the project maintenance;

FIG. 20 is an explanatory diagram which shows a maintain case screen of the project maintenance;

FIG. 21 is an explanatory diagram which shows a copy case screen of the project maintenance;

FIG. 22 is an explanatory diagram which shows another maintain case screen of the project maintenance;

FIG. 23 is an explanatory diagram which shows a creation data set screen of the project maintenance;

FIG. 24 is an explanatory diagram which shows a copy data set screen of the project maintenance;

FIG. 25 is an explanatory diagram which shows a main data set screen of the project maintenance;

FIG. 26 is an explanatory diagram which shows scalar data screen of the project maintenance;

FIG. 27 is an explanatory diagram which shows an AP ALL screen of the project maintenance;

FIG. 28 is an explanatory diagram which shows a complement data screen of the project maintenance;

FIG. 29 is an explanatory diagram which shows a series data screen of the project maintenance;

FIG. 30 is an explanatory diagram which shows a calculation item screen of the project maintenance;

FIG. 31 is an explanatory diagram which shows one example of a series type;

FIG. 32 is an explanatory diagram which shows another example of a series type;

FIG. 33 is an explanatory diagram which shows another example of a series type;

FIG. 34 is an explanatory diagram which shows another example of a series type;

FIG. 35 is an explanatory diagram which shows another example of a series type;

FIG. 36 is an explanatory diagram which shows another example of a series type;

FIG. 37 is an explanatory diagram which shows another example of a series type;

FIG. 38 is an explanatory diagram which shows another example of a series type;

FIG. 39 is an explanatory diagram which shows one example of a distribution type (normal distribution);

FIG. 40 is an explanatory diagram which shows another example of a distribution type (triangular distribution):

FIG. 41 is an explanatory diagram which shows another example of a distribution type (uniform distribution);

FIG. 42 is an explanatory diagram which shows another example of a distribution type (discrete distribution);

FIG. 43 is an explanatory diagram which shows a main screen of modeler;

FIG. 44 is an explanatory diagram which shows an open model screen of the modeler;

FIG. 45 is an explanatory diagram which shows a procedure of edition of the modeler;

FIG. 46 is an explanatory diagram which shows another procedure of edition of the modeler;

FIG. 47 is an explanatory diagram which shows another procedure of edition of the modeler;

FIG. 48 is an explanatory diagram which shows another procedure of edition of the modeler;

FIG. 49 is an explanatory diagram which shows another procedure of edition of the modeler;

FIG. 50 is an explanatory diagram which shows another procedure of edition of the modeler;

FIG. 51 is an explanatory diagram which shows another procedure of edition of the modeler;

FIG. 52 is an explanatory diagram which shows another procedure of edition of the modeler;

FIG. 53 is an explanatory diagram which shows a property screen of an edition of the modeler;

FIG. 54 is an explanatory diagram which shows an item property screen of the modeler;

FIG. 55 is an explanatory diagram which shows another item property screen of the modeler;

FIG. 56 is an explanatory diagram which shows another item property screen of the modeler;

FIG. 57 is an explanatory diagram which shows another item property screen of the modeler;

FIG. 58 is an explanatory diagram which shows a connection property screen of the modeler;

FIG. 59 is an explanatory diagram which shows a main screen of a market share finder;

FIG. 60 is an explanatory diagram which shows another screen of the market share finder;

FIG. 61 is an explanatory diagram which shows a score item input screen of the market share finder;

FIG. 62 is an explanatory diagram which shows another screen of the market share finder;

FIG. 63 is an explanatory diagram which shows a main (menu) screen of a case analysis:

FIG. 64 is an explanatory diagram which shows a set screen for setting a working case loader;

FIG. 65 is an explanatory diagram which shows a main screen of a cash flow analysis;

FIG. 66 is an explanatory diagram which shows a main screen of an advanced cash flow analysis;

FIG. 67 is an explanatory diagram which shows a selection field between a case/data set and measurement of the advanced cash flow analysis;

FIG. 68 is an explanatory diagram which shows a selection field between another case/data set and measurement of the advanced cash flow analysis;

FIG. 69 is an explanatory diagram which shows a main screen of a sensitivity analysis;

FIG. 70 is an explanatory diagram which shows a run parameter screen of the sensitivity analysis;

FIG. 71 is an explanatory diagram which shows another run parameter screen of the sensitivity analysis;

FIG. 72 is an explanatory diagram which shows a target for property screen of the sensitivity analysis;

FIG. 73 is an explanatory diagram which shows a Tornado Chart screen of the sensitivity analysis;

FIG. 74 is an explanatory diagram which shows a spider graph screen of the sensitivity analysis;

FIG. 75 is an explanatory diagram which shows an assumption selection time screen of the sensitivity analysis;

FIG. 76 is an explanatory diagram which shows a measurement selection time screen of the sensitivity analysis;

FIG. 77 is an explanatory diagram which shows a zero point selection time screen of the sensitivity analysis;

FIG. 78 is an explanatory diagram which shows an assumption list screen of the sensitivity analysis;

FIG. 79 is an explanatory diagram which shows a main screen of a property analysis;

FIG. 80 is an explanatory diagram which shows a run parameter screen of the property analysis;

FIG. 81 is an explanatory diagram which shows another run parameter screen of the property analysis;

FIG. 82 is an explanatory diagram which shows another run parameter screen of the property analysis;

FIG. 83 is an explanatory diagram which shows one example of a display graph of the property analysis;

FIG. 84 is an explanatory diagram which shows another example of a display graph of the property analysis;

FIG. 85 is an explanatory diagram which shows another example of a display graph of the property analysis;

FIG. 86 is an explanatory diagram which shows another example of a display graph of the property analysis;

FIG. 87 is an explanatory diagram which shows another example of a display graph of the property analysis;

FIG. 88 is an explanatory diagram which shows a percentile range property screen of the property analysis;

FIG. 89 is an explanatory diagram which shows a another percentile range property screen of the property analysis;

FIG. 90 is an explanatory diagram which shows an assumption list screen of the property analysis;

FIG. 91 is an explanatory diagram which shows a percentile table screen of the property analysis;

FIG. 92 is an explanatory diagram which shows a graph range screen for the property analysis;

FIG. 93 is an explanatory diagram which shows an overlay chart screen of the property analysis;

FIG. 94 is an explanatory diagram which shows another overlay chart screen of the property analysis;

FIG. 95 is an explanatory diagram which shows an overlay chart graph of the property analysis;

FIG. 96 is an explanatory diagram which shows a main screen of a What-If analysis;

FIG. 97 is an explanatory diagram which shows another main screen of the What-If analysis;

FIG. 98 is an explanatory diagram which shows an assumption modifying scroll bar of the What-If analysis;

FIG. 99 is an explanatory diagram which shows a storage field of a strategy of the What-If analysis;

FIG. 100 is an explanatory diagram which shows a screen of a current value and a nominal value at a time of actuation of the What-If analysis;

FIG. 101 is an explanatory diagram which shows a screen when the current value is to be changed to the nominal value in the What-If analysis;

FIG. 102 is an explanatory diagram which shows one example of a display bar of the What-If analysis;

FIG. 103 is an explanatory diagram which shows another example of a display bar of the What-If analysis;

FIG. 104 is an explanatory diagram which shows another example of a display bar of the What-If analysis;

FIG. 105 is an explanatory diagram which shows another example of a display bar of the What-If analysis;

FIG. 106 is an explanatory diagram which shows a main screen of a real option analysis;

FIG. 107 is an explanatory diagram which shows an analysis type selecting screen of a case data analysis;

FIG. 108 is an explanatory diagram which shows an analysis type-case/data matrix screen of the case data analysis;

FIG. 109 is an explanatory diagram which shows an item selecting screen of the case data analysis;

FIG. 110 is an explanatory diagram which shows one example of a display graph of the case data analysis;

FIG. 111 is an explanatory diagram which shows an analysis type-series data main screen of the case data analysis;

FIG. 112 is an explanatory diagram which shows an analysis type-case main screen of the case data analysis;

FIG. 113 is an explanatory diagram which shows an analysis type section screen of a sub-market analysis;

FIG. 114 is an explanatory diagram which shows a main screen of the sub-market analysis;

FIG. 115 is an explanatory diagram which shows another main screen of the sub-market analysis;

FIG. 116 is an explanatory diagram which shows another main screen of the sub-market analysis;

FIG. 117 is an explanatory diagram which shows a main screen of a project valuation;

FIG. 118 is an explanatory diagram which shows an analysis window of the project valuation;

FIG. 119 is an explanatory diagram which shows a procedure of edition of the projection valuation;

FIG. 120 is an explanatory diagram which shows another procedure of edition of the projection valuation;

FIG. 121 is an explanatory diagram which shows another procedure of edition of the projection valuation;

FIG. 122 is an explanatory diagram which shows another procedure of edition of the projection valuation;

FIG. 123 is an explanatory diagram which shows another procedure of edition of the projection valuation;

FIG. 124 is an explanatory diagram which shows another procedure of edition of the projection valuation;

FIG. 125 is an explanatory diagram which shows a root node property screen of the project valuation;

FIG. 126 is an explanatory diagram which shows a scenario node property screen of the project valuation;

FIG. 127 is an explanatory diagram which shows a static case node property screen of the project valuation;

FIG. 128 is an explanatory diagram which shows a dynamic case node property screen of the project valuation;

FIG. 129 is an explanatory diagram which shows a decision point property screen of the project valuation;

FIG. 130 is an explanatory diagram which shows another decision point property screen of the project valuation;

FIG. 131 is an explanatory diagram which shows another decision point property screen of the project valuation;

FIG. 132 is an explanatory diagram which shows a calculation window of the project valuation;

FIG. 133 is an explanatory diagram which shows an analysis window of the project valuation;

FIG. 134 is an explanatory diagram which shows an output image of a probability graph comparison report;

FIG. 135 is an explanatory diagram which shows a project selecting screen of the probability graph comparison report;

FIG. 136 is an explanatory diagram which shows a case selecting screen of the probability graph comparison report;

FIG. 137 is an explanatory diagram which shows a run parameter setting screen of the probability graph comparison report;

FIG. 138 is an explanatory diagram which shows another run parameter setting screen of the probability graph comparison report;

FIG. 139 is an explanatory diagram which shows a report preview screen of the probability graph comparison report;

FIG. 140 is an explanatory diagram which shows an output image of a Tornado Chart comparison report;

FIG. 141 is an explanatory diagram which shows a project selecting screen of the Tornado Chart comparison report;

FIG. 142 is an explanatory diagram which shows a case selecting screen of the Tornado Chart comparison report;

FIG. 143 is an explanatory diagram which shows a run parameter setting screen of the Tornado Chart comparison report;

FIG. 144 is an explanatory diagram which shows another run parameter setting screen of the Tornado Chart comparison report;

FIG. 145 is an explanatory diagram which shows a report preview screen of the Tornado Chart comparison report;

FIG. 146 is an explanatory diagram which shows one example of a profit model;

FIG. 147 is an explanatory diagram which shows contents which shapes of frames of respective items show;

FIG. 148 is an explanatory diagram which shows a calculation logic error;

FIG. 149 is an explanatory diagram which shows a circulation error; and

FIG. 150 is an explanatory diagram which shows a mismatch of Series/Scalar items.

### DETAILED DESCRIPTIONS

Preferred embodiments of the an apparatus and method for supporting an investment decision making, and a program which causes a computer to execute the method according to the present invention will be explained below in detail with reference to the accompanying drawings.

The Overview of an investment decision making apparatus will be first described. An investment decision making apparatus, an investment decision making method and a program which causes a computer to execute the method according to an embodiment of the present invention simulate a profit or a business value of a R&D project of a company to support a decision making of an investment. By utilizing an information technology up to the maximum, complicated and time-consuming calculation of a business value or a business evaluation including many scenarios can be preformed efficiently and effectively. Also, the investment decision making apparatus, the investment decision making method and the program which causes a computer to execute the method according to the present embodiment allows not only analysis of the possibility of a business method in its wide range but also providing of a diversified analysis method in each scenario. In addition of a cash flow analysis, a series of analysis functions required for an R&D investment evaluation including a probability analysis performing a risk and a success probability and a sensitivity analysis analyzing influence of assumptions predicted/set to the business value, such as a What-If analysis, a real/option analysis, a decision tree analysis and the like are provided.

The investment decision making apparatus, the investment decision making method and a RadMap (R&D Modeling and Planning) which is the program which causes a computer to execute the method according to the embodiment of this invention are to perform a valuation (economic value evaluation) of a R&D project accompanying a high risk and a large scale investment, and to simulate the economic value of the project modified according to various uncertainties to support the optimal decision making.

The RadMap can correspond to various analysis requirements from a DCF (discount cash flow) process up to the modest analysis approach (decision tree, real option process). Also, respective analysis functions are integrated and a common project profit model and uncertainty data are utilized in the RadMap.

Also, design tools which can manage a project profit model visually are provided and an evaluation standard common to all companies can be realized by managing uncertainty data of different scenarios (cases) in a centralized manner.

That is, as a fundamental effect obtained by the RadMap introduction, by performing a business evaluation of a project of an R&D investment on one platform, a profit structure model, an evaluation process, and an output for analysis or the like can be integrated. A model of the profit structure of the project stored in the RadMap can utilize a series of stages from an initial stage of the project up to a decision making stage through a detailed examining stage in a consistent manner. The model may be sub-divided according to a stage progress.

Each manager can perform evaluation at each stage using common evaluation processes, common evaluation indicators and integrated terms. By using the RadMap, the optimal investment resource distribution can be performed on the basis of a more accurate value evaluation.

The overview of main functions ((1)-(8)) of the RadMap will be explained below.

(1) Modeler Function (Visualization of Profit Model):

The RadMap manages a profit structure model where a cost structure and a sales structure regarding development, manufacture and sales of product business to be analyzed have been clarified. Thereby, the RadMap dynamically creates a cash flow of the business from assumed assumptions. Measurement and analysis of the business value in the RadMap are performed according to cash flow data created on the basis of the profit model. As a result, an investment evaluation process is standardized, and a modeler function of the RadMap which makes it possible to perform a business value comparison between projects and an investment decision making process accurately and easily can create a business model utilized for analysis by formulating a user-specific business structure on the RadMap in a graphical manner.

(2) Cash Flow Analysis Function (Rapid and Accurate Payability Analysis:

By utilizing a cash flow for investment judgement of a R&D, a business value of an investment project is numerically expressed so that it can be subjected to comparison/evaluation objectively. The RadMap automatically calculates/displays a cash flow instantaneously on the basis of assumption values set in the profit structure model. The cash flow allows analysis/evaluation considering uncertainties since a case of an expected scenario, a case of the worst scenario, and a case of the best scenario are displayed in a list. Sensitivity Analysis Function (grasp of strategically important assumptions).

A RadMap Sensitivity Analysis Function visualizes the magnitude of influence on the business value when “Assumption” data, such as respective costs, sales force number or the like, changes. From the results from the sensitivity analysis will clarify which assumption should the resource be focused on and which to consider a risk avert method in order to maximize the business value.

(3) Probability Distribution Analysis Function (Grasp of Risk):

In an investment evaluation of a fixed point based upon one scenario, though an estimate value can be calculated, it is difficult to measure a magnitude of the risk of the project, a target point attainability or the like. ARadMap Probability Distribution Analysis Function adopts the Monte Carlo Simulation, and it indicates the probability distribution on a graph, and the risk and success probability of the project in an easy understanding manner. In this simulation, a maximum of 10,000 scenarios are created and cash flows for all the scenarios are calculated. Using this result, probabilities of indicators representing investment effects such as NPV, IRR or the like is displayed on a graph. A decision making person or manager does not make judgement on the basis of only an estimate profit of the R&D investment but he/she can make a decision according to the Probability Distribution Function considering a risk included in the business.

(4) What-If Analysis Function (Real Time-Simulation):

A What-If Analysis Function of the RadMap can confirm in real time how the evaluation indicators indicating the business value change when the assumption conditions of the business value estimate are changed and the values of the assumptions are changed. When utilizing the What-If Function in a conference, a meeting or the like, an evaluation process, and an evaluation result can be shared by a plurality of members, which will result in effective promotion of further discussion.

(5) Real Option Analysis Function (Business Value Analysis Considering Risk):

In a Real Option Analysis Function of the RadMap, a business value considering future uncertainty is calculated. When parameters are set on the basis of the results of the cash flow analysis and the risk analysis, an option value can be obtained by an option calculation engine. As the option calculation engine, a Black-Sholes calculation model and a binomial distribution calculation model are provided.

(6) Project Evaluation Function (Expected Value Calculation According to Decision Tree):

A Project Evaluation Function of the RadMap calculates an economy of the project which is the project to be invested from an expected value calculation of a decision tree. It is possible to link the values obtained from the cash flow calculation, the distribution analysis and the real option analysis to utilize them for an expected value calculation.

Market Share Estimate Supporting Function In a Market Share Estimate Supporting Function of the RadMap determines an estimate value of a market share of a product which is to be invested according to a relative evaluation on the basis of a captured share of a competitive product, a past own product or the like. By defining elements affecting the market share and performing scoring of each product, a more objective market shape estimate can be made.

(7) Risk Return/Position Function (Project Portfolio Analysis):

A Risk Return/Position function of the RadMap categorizes respective projects from the results of the cash flow analysis or the risk analysis to support examination of the priority of the projects, a strategy planning for the whole optimal realization or the like.

(8) Composite Cash Flow Analysis Function (Tree Distribution Simulation Considering the Whole Optimization):

A composite cash flow analysis allows comparison between projects different in development term, development site or the like. Simultaneously, by listing cash flows of all of plural projects to be planned, besides an analysis simulation performed along a time axis, such as “when is the climax of investment?”, “is a continuous cash flow expected?”, a resource (personnel, financial and R&D facilities) distribution plan and a capacity estimate/examination are promoted to support a decision making regarding the priority of projects, start timings thereof and the like.

Next, a hardware configuration of the investment decision making supporting apparatus according an embodiment of the present invention will be explained. The investment decision making supporting apparatus can be realized by an information processing apparatus such as a personal computer, though not shown. That is, the investment decision making supporting apparatus comprises at least a CPU which controls the entire apparatus, a ROM which has stored a basic input/output program, a RAM which is used as a work area for the CPU, a hard disk which stores data according to control of the CPU, a floppy disk which is an attachable/detachable storage medium as one example, a display which displays a cursor, menus, windows, or various data items such as characters, images or the like, a network I/F (interface) which is connected to networks including Internet through communication lines and functions as an interface between the networks and the CPU, a keyboard provided with a plurality of keys for inputting characters, numerals, various instructions and the like, and a mouse which performs selection and execution of various instructions, selection of an object to be processed, movement of the cursor and the like.

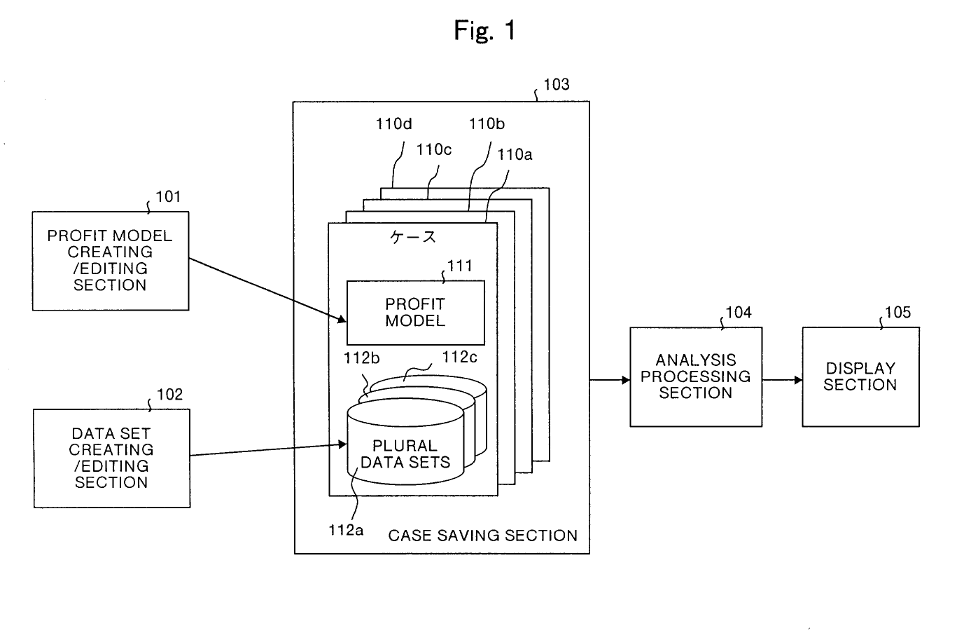

FIG. 1 is a function block diagram which functionally shows a configuration of an investment decision making supporting apparatus according to an embodiment of the present invention. In FIG. 1, an investment decision making supporting apparatus (RadMap) comprises a profit model creating/editing section 101, a data set creating/editing section 102, a case saving section 103, an analysis processing section 104, and a display section 105.

The profit model creating/editing section 101 is provided with the above-described modeler function (described in detail later), and it creates, modifies or deletes a profit model which shows a relationship between any parameter and a cash flow. Also, the data set creating/editing section 102 creates, modifies or deletes a data set including any values. The data set creating/editing section 102 corresponds to a case editor described later. Functions of the profit model creating/editing section 101 and the data set creating/editing section 102 can be realized by the CPU executing programs which have been stored in the RAM, ROM and hardware.

The case saving section 103 saves cases 110 where a profit model 111 which has been created or modified by the profit model creating/editing section 101 is associated with one or plural data sets 112 which have been created or modified by the data set creating/editing section 102. Also, the save cases 110 may be categorized for each project described later. The case saving section 103 corresponds to a RadMap data base. The function of the case saving section 103 is realized by the hard disk. Also, a decentralized databases connected to one another through a network may be employed.

The analysis processing section 104 performs various analysis processings described above or described later utilizing a working case 201 comprising a case profit model 111 which has been saved in the case saving section 103 and one data set 112 or one of plural data sets 112 as the minimum unit for simulation. The function of the analysis processing section 104 is also realized by the CPU executing programs which have been recorded in the RAM, ROM and hard disk. Also, the display section 105 displays the analysis result obtained from analysis processing performed by the analysis processing section 104. The function of the display section 105 is realized by the above display. The display contents and how to display will be described later.

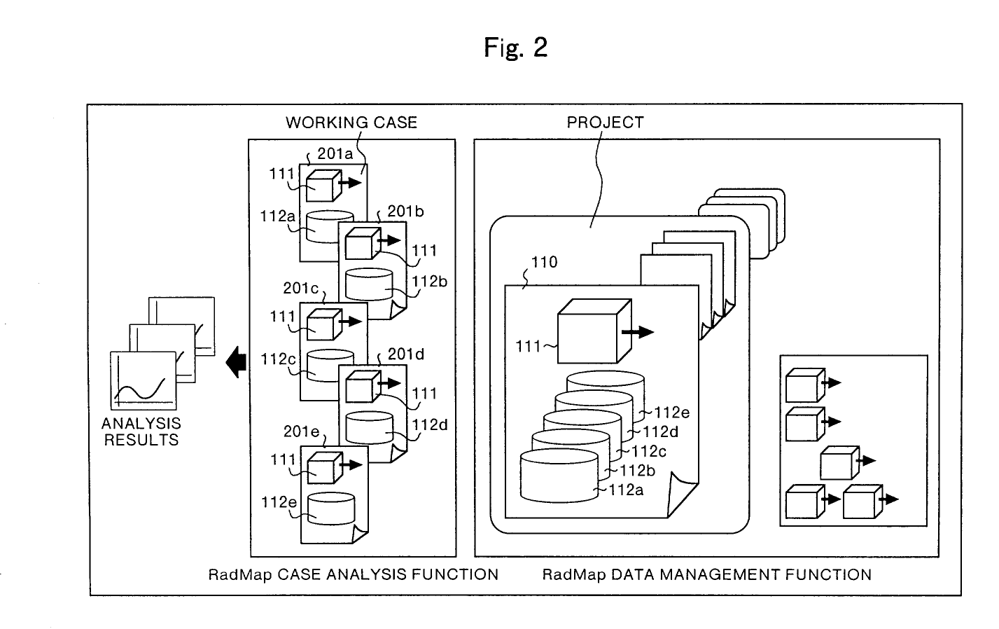

The Data Management Structure of Radmap will now be described. Radmap will preserve and manage the database of data and related information used to calculate cash flow in the Project valuation. FIG. 2 will illustrate the data management structure of the Radmap. The data types and definitions which will be managed at Radmap are described as follows.

(1) Profit Model (or Model) 111:

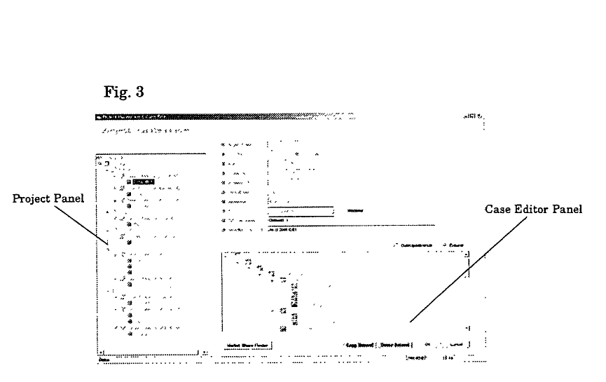

Indicate the economic relationship between cash flow and parameters (such as the macro economic indicators and/or individual price/resource volume) in order to calculate the cash flow during the lifetime of a product from the research & development until the sales finish. A model will indicate the static relationship based on a specific strategy and/or condition. So, various models will exist for the relationships that are based on various assumptions as strategy and business structure changes. Profit Model will be saved in the “Model Pool”, which is one of the Radmap systems, and one Model will be selected when the Case is created. Contents of the Profit Model will be indicated as a Tree structure in the Dataset panel of the Project Maintenance & Case Editor Screen (refer to FIG. 3).

(2) Dataset 112:

It is a set of parameter values (data item) to provide to the Profit Model, such as macro economic indicators and/or individual price/resource volume. When there is uncertainty in the data item, the value of the range and distribution that will indicate the uncertainty will also be included. Cash flow will be calculated by one Dataset and the corresponding Model.

(3) Case 110:

It consist from the Dataset and the corresponding one Model. Each Case is an analyzing object for the Project evaluation system of the Radmap. Case can also hold various version of Dataset. When opening (select) the Case, analysis using a different Dataset within the Case can be done by selecting the version. In the Radmap analysis function, it is possible to open up to 5 Cases simultaneously, and compare the analysis results for each Case (Opened Case is called “Working Case” 201).

(4) Project

Project that is under the Radmap data management (Radmap Project) will usually be created in corresponding to one product development. Generally, the product development Project will create a different economy (cash flow) depending on the various strategy and business assumptions. Radmap Project will possess the various Cases which will correspond to the strategy and business assumptions for that product development Project.

Since Radmap can preserve and manage various Radmap projects, it is possible to evaluate the economy for the various product development Projects. FIG. 3 is the screen for the Project Maintenance & Case Editor. “Project Panel” on the left hand side of the screen indicates the Tree structure for the preserved Project in the Radmap, and the related Case and Dataset on the specific strategy and/or condition.

The function outline for the Radmap Project Evaluation System will now be described. The Radmap Project Evaluation System is organized from three functions.

(1) Case Analysis:

This function contains the main Radmap analysis such as CashFlow, Sensitivity, Probability, What-If, Real Option, and the others. When starting the Case Analysis, Case that will be the analysis object which will be loaded from the Case preserved in the Radmap database. Since this function can load up to 5 Cases simultaneously and analyze, it is possible to switch the analysis result for different Cases instantly and compare them. Also, the comparison of economy between different Projects are possible because the loaded Case can be used for various Projects. Detailed process of the Case Analysis will be explained in the latter chapter.

(2) Project Valuation:

This function will indicate the decision making of a Milestone (phase) practice results for a Project into a Decision Tree. It will then calculate the expected value of a Project which will include the Milestone success probability and the decision making probability. Since various strategy caused by the decision making will create a different cash flow and Net Present Value (NPV), it is necessary to select a NPV that will correspond to the result of the Decision Tree divergence. On the other hand, the analysis result of the Case can be used by corresponding the Case to the value of the divergence result. Detailed process of the Project Valuation will be explained in the latter chapter (Process of the Project Valuation)

(3) Case Management (Definition Input):

This function will manage the corresponding data for the Case Analysis and Project Valuation. The function will include “Case Editor” (create, modify, delete values in a Dataset), “Project Maintenance” (create/modify/delete the Project Dataset, Case,), and “Modeler” (create/modify/delete the Profit Model).

The handling the Uncertainty will be now described. Radmap will divide the uncertainty regarding the economic evaluation of a Project into 2 types. Both will be coped with a different approach.

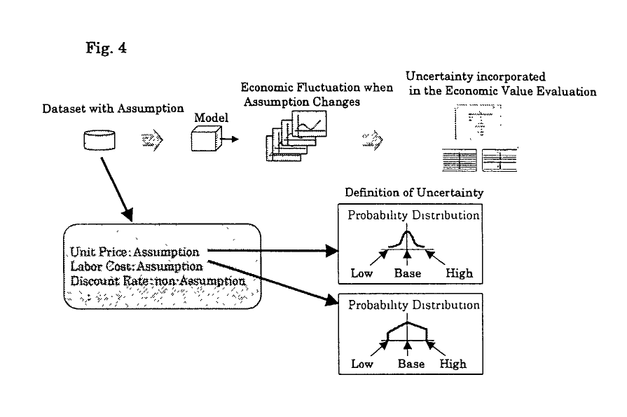

(1) Uncertainty of Data Item, Case Analysis (refer to FIG. 4):

As stated above, Case has the economic relationship (Model) to calculate cash flow, and the input data (Dataset) Dataset will include the value of the data item that is necessary for a Model, but some will be uncertain. Uncertain data item is called “Assumption”. Assumption will have the base value, low value, high value and the appearance probability (probability distribution) of a value, depending on the uncertainty. Case Analysis will mainly analyze the economic (such as cash flow) Case that is incorporated in the Assumption of the Case/Datasets.

(2) Uncertainty Regarding Various Strategy and Assumption Project Valuation (refer to FIG. 5):

Usually a Project will be divided by several Milestones, and be planned and practiced (also called Phases in the pharmaceutical development). After the Milestone practice, decision whether to move to the next Milestone, finish the Project or modify the strategy would be made. An good planning can be done by evaluating the project in various way of strategic alternatives in the future at the beginning. One thing to note here is that the profit structure of a business might differ depending on the various strategy. Project Valuation in the Radmap will correspond to these kind of uncertainty when the profit structure differs depending on the selection of the future strategy. In another words, the Decision Tree will correspond to the different Case that is caused by the future decision making, and the success probability of a Milestone. Thus, the expected economic value that is incorporated in the future decision making will be calculated. It is recommended to proceed to the Project Valuation for further elaboration of the economic value evaluation of a Project (refer to FIG. 5).

The process of the Case Analysis will now be described. Follow the below steps to define a new Project and to start the Case Analysis. To add a new Case to an existing Project, start from Step 2. To add a new Dataset to an existing Case, start from Step 3. To modify an existing Dataset value, start from Step 4. Start from the Project maintenance & Case Edit function from the Radmap between Step 1 to Step 4. For Step 5, start from the Case Analysis function. See the applicable section in this manual for the individual operation.

Step1: Create Project,

Step2: Create Case,

Step3: Create Dataset,

Step4: Input Data,

Step5: Load Working Case,

Step6: Analysis,

Supplement Step-a: Print Report,

Supplement Step-b: Create Model,

Supplement Step-c: Competitive Analysis and Market Share Estimate.

Step1: Create Project:

Define new Project. Select Project Name, comment, Project starting year and the evaluation year.

Step2: Create Case:

To create a new Case. Select a project and click “Create Case” button. The Case definition screen will be indicated, Input the Case Name, comment and a Profit Model selection. Profit Model will be selected from the one that is registered in the Radmap model pool , so it is necessary to know beforehand what the candidate Model is. When the Model is not registered or when creating a Case that will have a different economic relationship from the existing Model, follow the “Supplement Step-b: Create Model” and create a new Model or modify the existing Profit Model and save it as a different name. Use the Modeler function to do this.

Step3: Create Dataset:

Create a new Dataset. Select the Case, and input the Dataset name and comment. It will be created by selecting the Create Dataset button. Created new Dataset will be added as an icon in the Project panel under the applicable Case. Dataset created in this order will not have any contents (value) at first, so the added icon will be indicated in red to show this.

Step4: Input Data:

Select the Dataset and input the data values. The model structure of selected Dataset of the Case will be indicated graphically on the right hand side of the screen (see Dataset panel on FIG. 3 for reference). Click a data item icon in the indicated Model, then input the value when the data input panel for that item appears. When the item value is uncertain, it is possible to set the uncertainty range by selecting that as an “Assumption”. See the Case Edit section in this manual for details.

Step5: Loading Working Case:

Open the Case to be analyzed. Select the Project, Case and the Dataset at the loading screen. Maximum of 5 Cases can be opened simultaneously.

Step6: Analysis:

Select the analysis from the indicated menu when starting the Case Analysis function. Select the Working Case to be analyzed at the individual analysis function. Analysis results can be saved when closing the individual analysis. Thus, the saved analysis results will be indicated again when opening the Case and selecting the same function after finishing the Radmap or when closing the computer where the Radmap is in action. Start the print menu in the individual function in order to print out the analysis results “Supplement Step-a”. Most of the Case Analysis in the Radmap will need to hold a certain amount of uncertain (Assumption) data item included in the Dataset. Supplement Step-c: Competitive Analysis and Market Share Estimate.

Radmap has a supplement function that will indicate a graph regarding the product market ability with competitive parameters of the product. It is helpful to estimate the expected acquired share of the product.

The Process of the Project Valuation will be described.

The Project Valuation will be followed by the below steps. Step1 and Step3 will be the same with the Case Analysis. Step2 and Step4 will use the Radmap Decision Tree function.

Step1: Create Project,

Step2: Extract the Strategy for the Project,

Step3: Create and analyze the Case for a Dynamic Case Node,

Step4: Calculate the Expected Economic Value for the Project.

Step1: Create Project:

Define new Project from the Project Maintenance & Case Edit. Select Project Name, comment, Project start year and evaluation year.

Step2: Extract the Strategy for the Project:

Start the Radmap Decision Tree/Project Design Mode from the Project Maintenance & Case Edit screen. Create a Decision Tree that will indicate the decision making caused by other conditions or from each Milestone of a Project. Node (Case Node) at the tip of the branch of the created Tree will have an individual economic value. Here, it will be decided whether or not to assign the actual Case to the Case Node. Case Node that has been assigned by the actual Case will be called a dynamic Case Node, and the Case not assigned will be called a static Case Node. It is necessary to proceed to Step 3 for all dynamic Case Nodes. Generally, Case Node in the early stage of the Project Milestone, and the Case Node which has a low uncertainty of economic value will be the static Case Node. When the Decision Tree is selected, save it in a name.

Step3: Create and Analyze the Case for a Dynamic Case Node:

Create and analyze the Case that correspond to all dynamic Case Nodes by following from Step 2 to Step 6 in the Case Analysis.

Step4: Calculate the Expected Economic Value for the Project:

Start the Radmap Decision Tree/Project Evaluation Mode from the Main Menu. Open a tree to made previously or newly create one. By the following three operations, it is possible to calculate the total expected economic value, which will include the decision making and the success probability of a Project.

(1) Select the type of decision making point (part where the branch separates), and select the necessary conditions. For example, in the case of the probability gate, select the probability at each of the branch divergence.

(2) Select the economic evaluation value for each Case Node. Select the evaluation value directly for the static Case Node. For the dynamic Case Node, on the other hand, it can also copy the Case Analysis results (expected NPV that absorb the uncertainty of an Assumption) other than to select directly.

(3) Start the Decision Tree calculation and figure out the total expected economic value.

The common Functions will now be described. The common functions used at each functions will be described below.

Function 1 “Dump”:

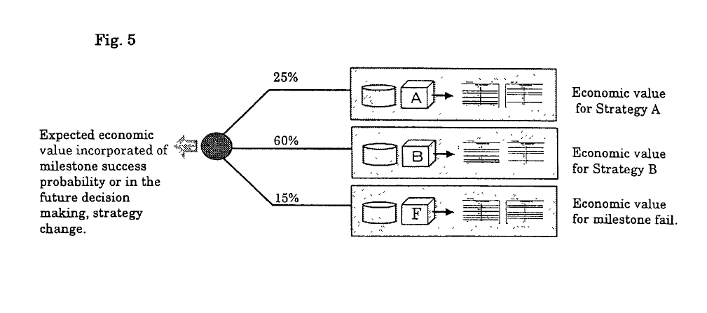

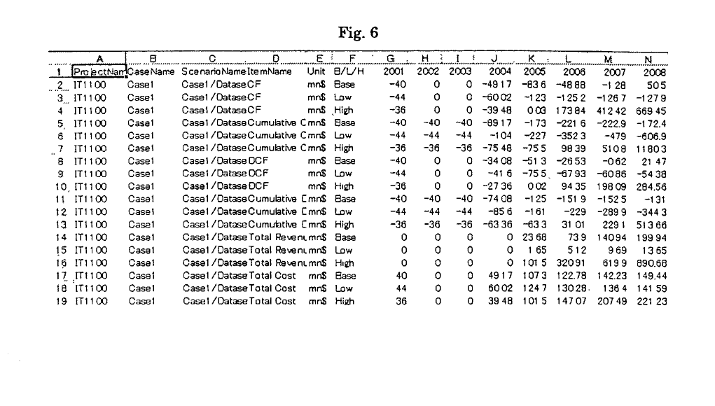

Save the analysis data as a CSV format. Output data can be used in Excel, and in other applications by the Dump function (refer to FIG. 6). Select Dump from the [Usage] Menu Function.

Function 2 “Save Result”:

Save the analysis results for the analysis functions (Sensitivity Analysis, Probability Analysis, What-If Analysis, Real Option Analysis, Market Share Finder) Results that are saved can be indicated repeatedly until it is saved again. For each analysis functions, one analysis result can be saved for every Dataset Select Save Result from the [Usage] Menu Function.

Function 3 “Print (Print Out)”:

(1) Select Print in the [Usage] Menu Function.

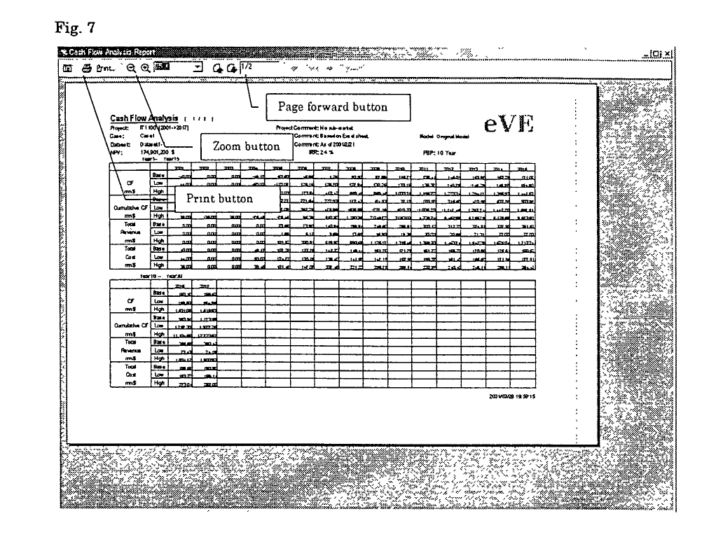

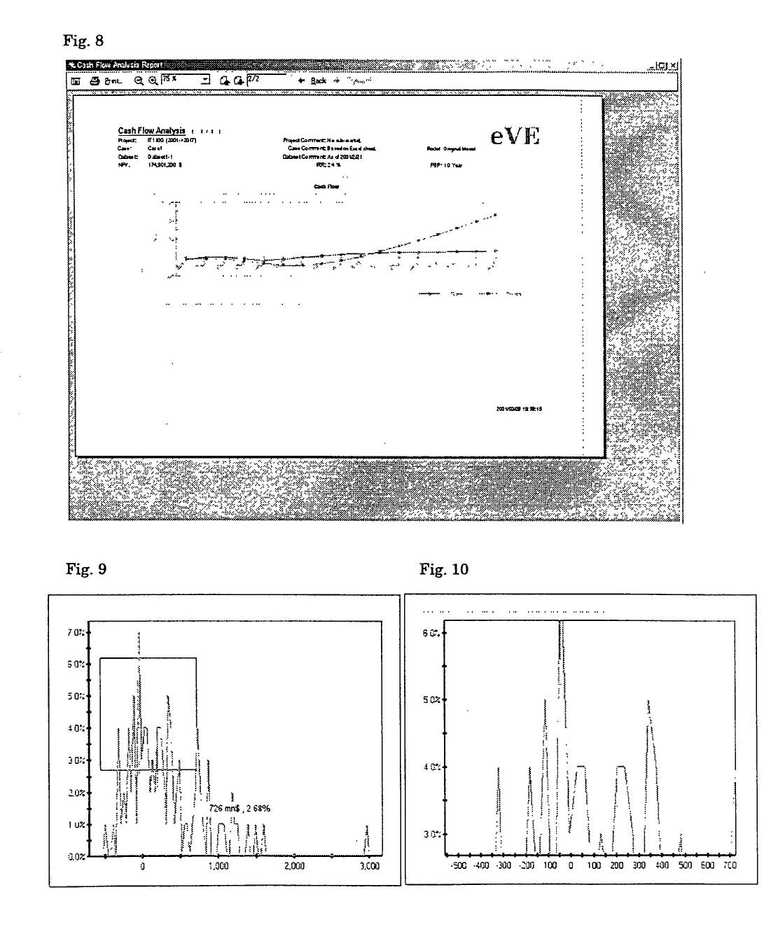

(2) Preview screen will open, and the data and graph will be indicated as a report format (refer to FIG. 7 and FIG. 8).

(3) Select Print, Zoom, Page Forward if necessary.

Funciton 4 “Exit”:

(1) Finish the function and close the screen.

(2) Select Exit in the [Usage] Menu Function.

Function 5 “Graph Zoom”:

Indicate the expansion for one part of the graph.

(1) Select the range in which to be expanded at the [Usage] graph by using the left hand click button (refer to FIG. 9).

(2) Graph will be expanded after the cancellation of the click (refer to FIG. 10).

(3) Use the Undo Zoom/Redo Zoom/Reset Zoom if necessary.

Undo Zoom/Redo Zoom/Reset Zoom at the Chart Menu will also function the same.

Funciton 6 “Copy to Clipboard”:

Copy the graph image to a clipboard. It is possible to use the copied graph image in Word, Excel and at other applications.

(1) Select Copy to Clipboard in the [Usage] Menu Chart, or select the Copy to Clipboard button.

(2) Select the applicable area in the application screen to paste the graph image, and select Paste.

(3) Graph image will be inserted.

The System Profile Maintenance will now be described.

1. What is a System Profile Maintenance:

System Profile Maintenance will set the environment of a system. It will include the value settings regarding the calculation and results indication that is practiced on the system.

(1) Discount Start Year

(2) Sensitivity Class

(3) Probability Certainly Level (System Default)

(4) Probability Graph Type (System Default)

2. Function Description:

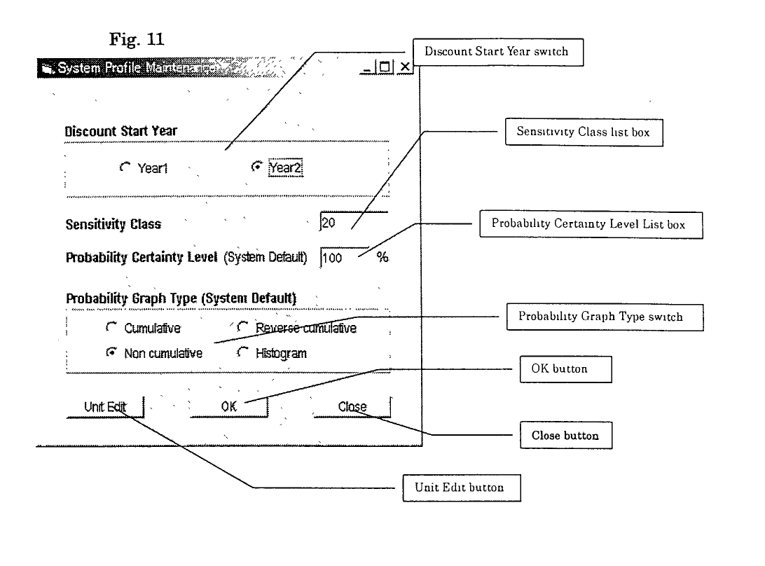

Refer to FIG. 11.

3. Usage of System Profile Maintenance:

3.1 Basic Function:

Modify the value settings for the following.

(1) Discount Start Year: Select the discount starting year either from 1st year or the 2nd year regarding the discount calculation (DIS function).

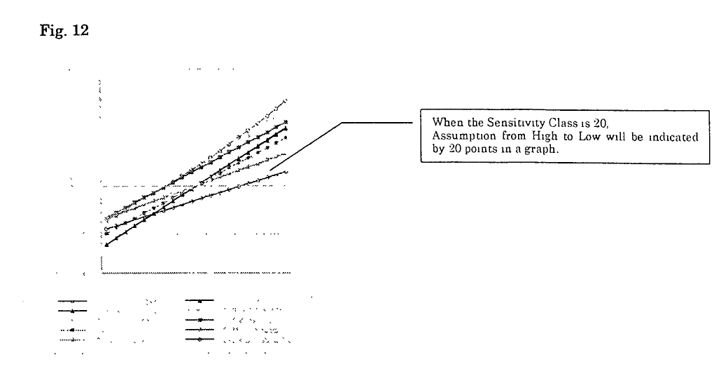

(2) Sensitivity Class: Decide the Class of a Spider Graph (refer to FIG. 12) in the Sensitivity Analysis.

(3) Probability Certainly Level (System Default): Select the starting value of a Certainty Level which is used in the Probability Analysis.

(4) Probability Graph Type (System Default): Select the graph type which will be indicated first after the Probability Analysis.

3.2 Unit Edit:

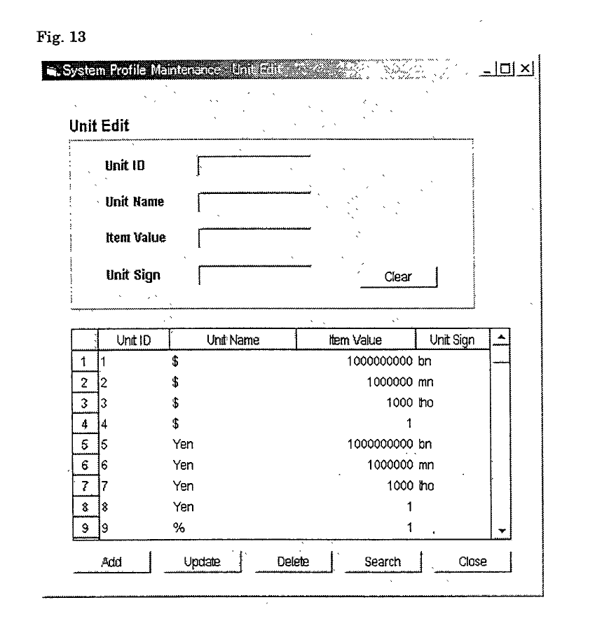

Edit the Unit Table which will be used on the system (refer to FIG. 13).

3.3 Create New Unit:

(1) Input the Unit Name, Item Value and the Unit Sign.

(2) Added by selecting Add.

3.4 Modify:

(1) Select Unit, and input Unit Name, Item Value and Unit Sign.

(2) Modify by the Update button.

Contents of Project Maintenance & Case Edit will now be described.

1. What is Project Maintenance & Case Edit:

Project Maintenance & Case Edit will create and edit the Project, Case and Dataset. Project Maintenance & Case Edit will manage all the Project defined on the Radmap, and will gather the access function that is necessary for the analysis preparation work.

2. Function Description:

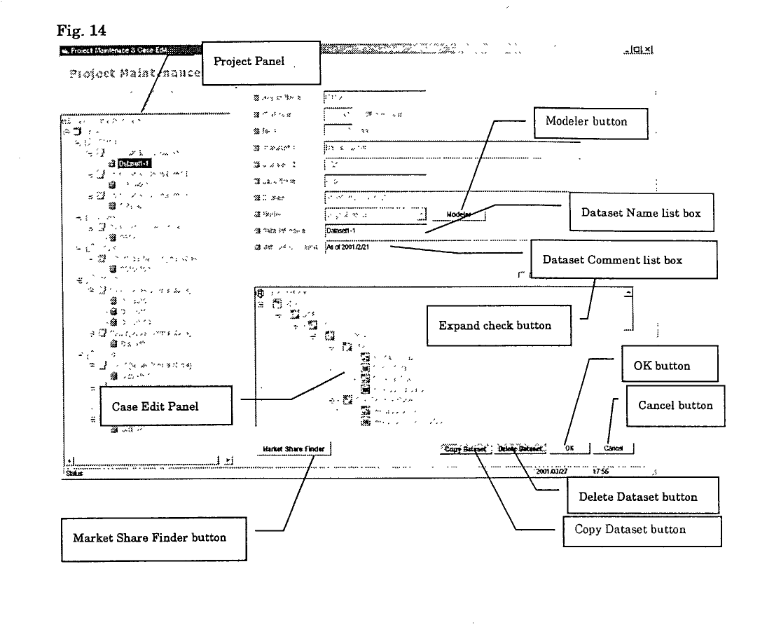

Refer to FIG. 14.

3. Usage of Project Maintenance & Case Edit:

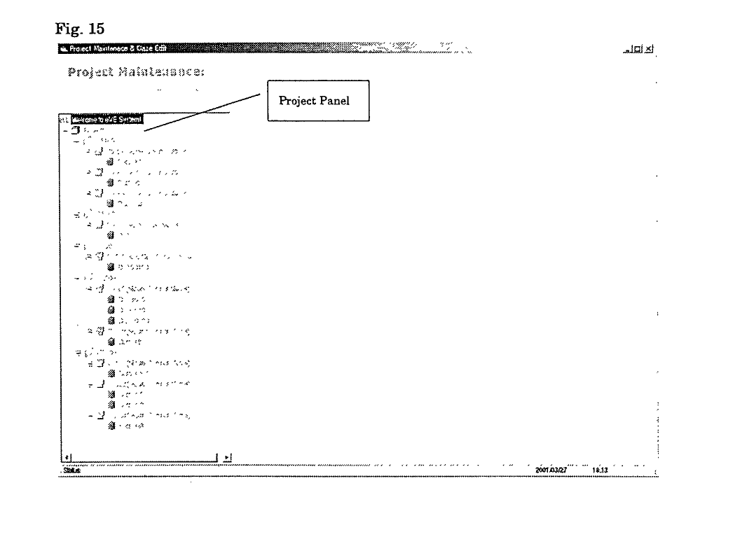

All of the Project, Case and Dataset which is created at the Radmap will be indicated in the Project Panel (refer to FIG. 15).

3.1 Operation Regarding a Project:

3.1.1. Create a New Project:

(1) Select the Project icon in the Project Panel.

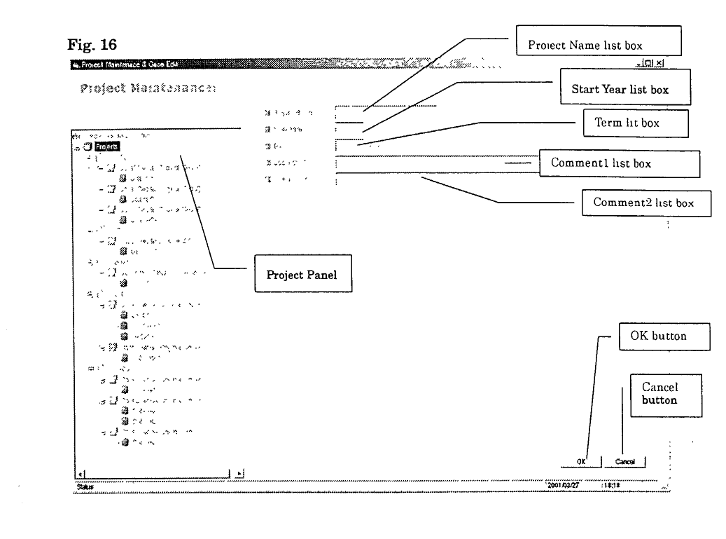

(2) Create Project Screen will be indicated (refer to FIG. 16).

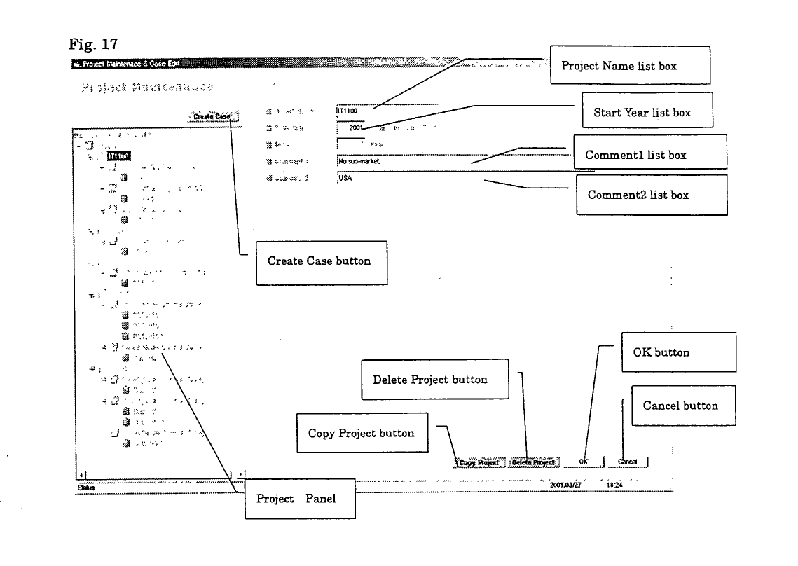

(3) Input Project Name (necessary),Comment (optional) Start Year (necessary), Term (necessary) and press the OK button (refer to FIG. 17).

(4) Created new Project will be added to the Project Panel.

Project Name: Name of a Project. Maximum of 20 letters. (Necessary).

Start Year: Start year of a Project. Can be modified later. (Necessary).

Term: Term of a Project (year. Can be modified later. Range from 2 to 30 years. (Necessary).

Comment: Comment. Maximum of 50 letters. (optional)

3.1.2 Edit Existing Project Properties:

(1) Select a Project in the Project Panel.

(2) Maintain project Screen will be indicated (refer to FIG. 17).

(3) Edit the Project Name, Comment, Start Year (refer to FIG. 17).

(4) Project propeties will be renewed after pressing the OK button.

Project Name: Name of a Project. Maximum of 20 letters. (Necessary).

Start Year: Start year of a Project. Can be modified later. (Necessary).

Comment: Comment. Maximum of 50 letters. (optional)

3.1.3 Copy a Project:

(1) Select a Project in the Project Panel.

(2) Select Copy Project button (refer to FIG. 17).

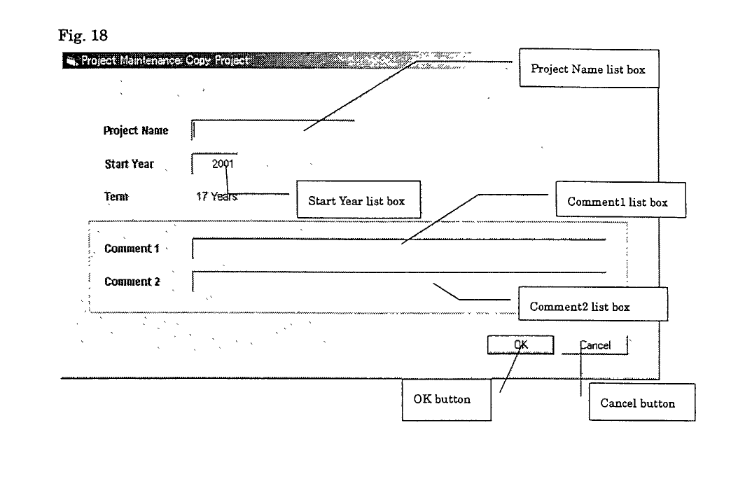

(3) Input Project Name (necessary), Comment (optional), Start Year (necessary) (refer to FIG. 18).

(4) A Project that is copied will be added to the Project Panel after pressing the OK button.

All the Cases and Datasets under the applicable Project will be copied.

3.2. Operation Regarding a Case:

3.2.1 Create a New Case:

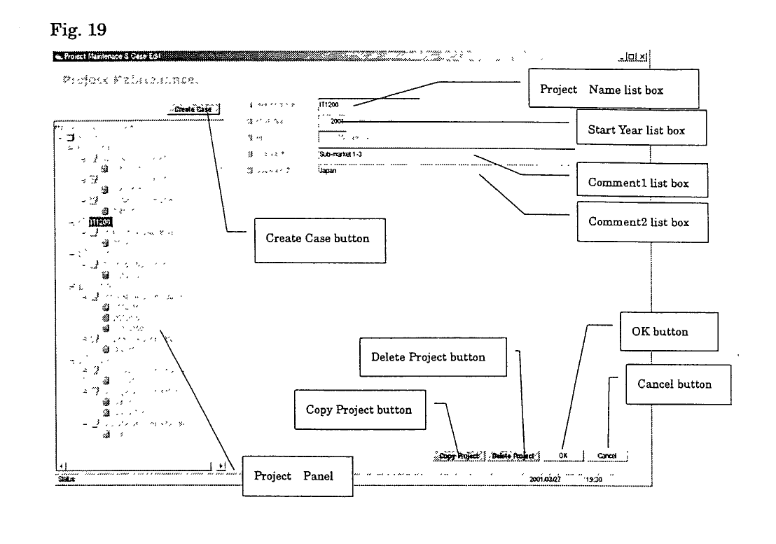

(1) Select a Project in which you want to old a Case will be added (refer to FIG. 19).

(2) Select Create Case butoon.

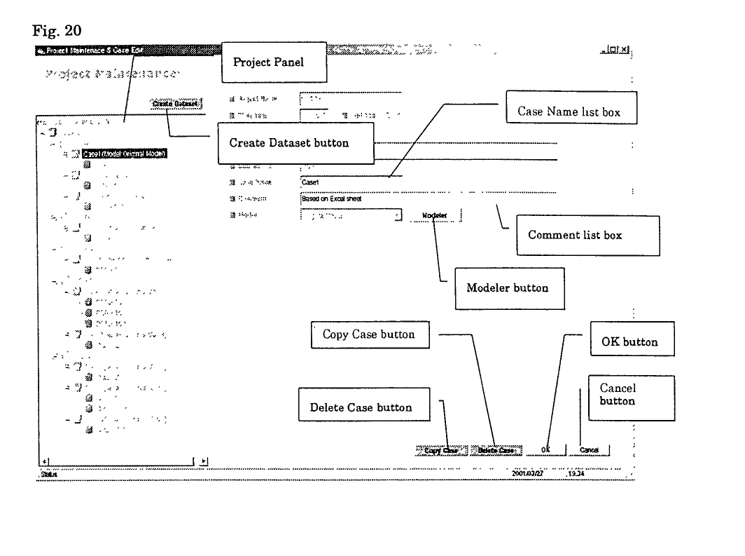

(3) Input Case Name and Comment, and then select a model from the Model list box (refer to FIG. 20).

3.2.2 Edit Existing Project Properties:

(1) Select a Case in the Project Panel.

(2) Maintain Case Screen will be indicated (refer to FIG. 20).

(3) Edit Case Name and Comment (refer to FIG. 20).

Case Name: Name of a Case. Maximum of 20 Letters. (Necessary).

Comment: Comment. Maximum of 20 letters. (optional).

Model: Cannot be modified later.

(4) Case properties will be renewed after pressing the OK button.

3.2.3. Copy a Case:

(1) Select a Case in the Project Panel.

(2) Select Copy Case button (refer to FIG. 20).

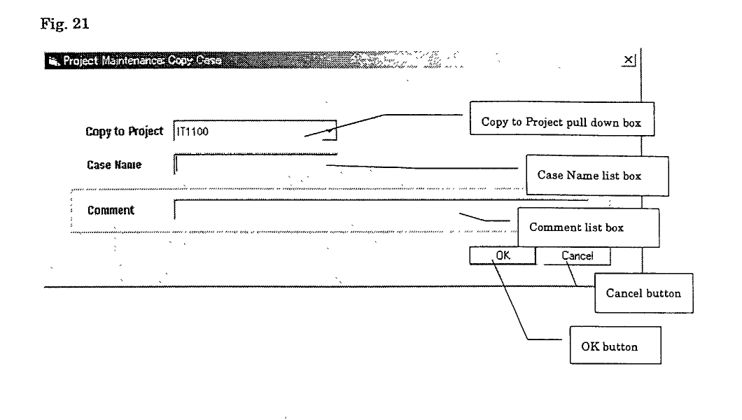

(3) Input Copy To Project (necessary) and the Case Name (necessary) (refer to FIG. 21).

(4) Case that is copied will be added to the Project Panel after selecting the OK button.

All Datasets under the applicable Case will be copied.

3.3 Operation Regarding Dataset:

3.3.1 Create a New Dataset:

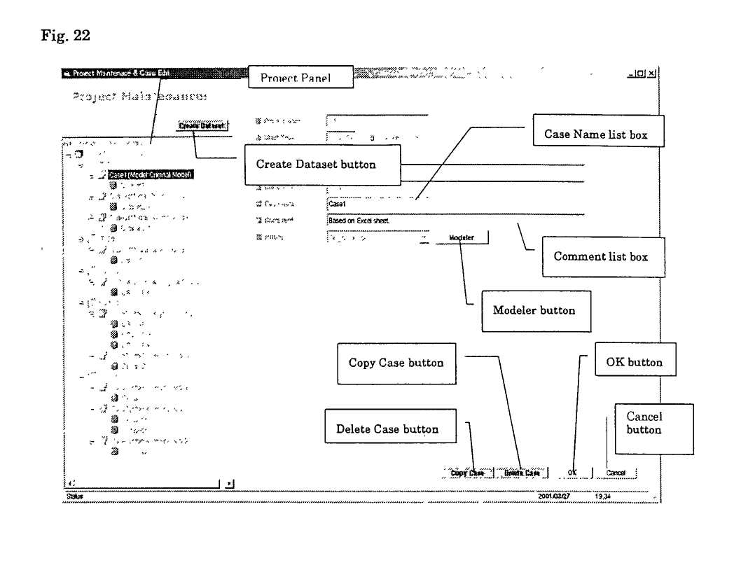

Select a Case in which the Dataset will be added (refer to FIG. 22).

(1) Select Create Dataset.

(2) Input Dataset Name and Comment.

Dataset Name: Name of a Dataset. Maximum of 20 letters. (Necessary).

Comment: Comment. Maximum of 20 letters. (Optional).

3.3.2. Edit Existing Dataset Properties:

(1) Select Dataset in the Project Panel.

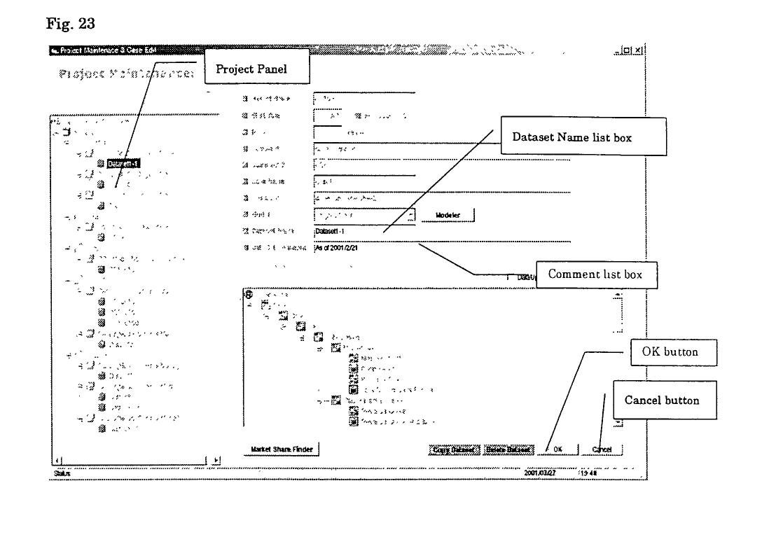

(2) Maintain Dataset Screen will be indicated (refer to FIG. 23).

(3) Edit Dataset Name and Comment.

(4) Dataset properties will be renewed after selecting the OK button.

3.3.3. Copy a Dataset:

(1) Select a Dataset in the Project Panel.

(2) Select Copy Dataset button (refer to FIG. 23).

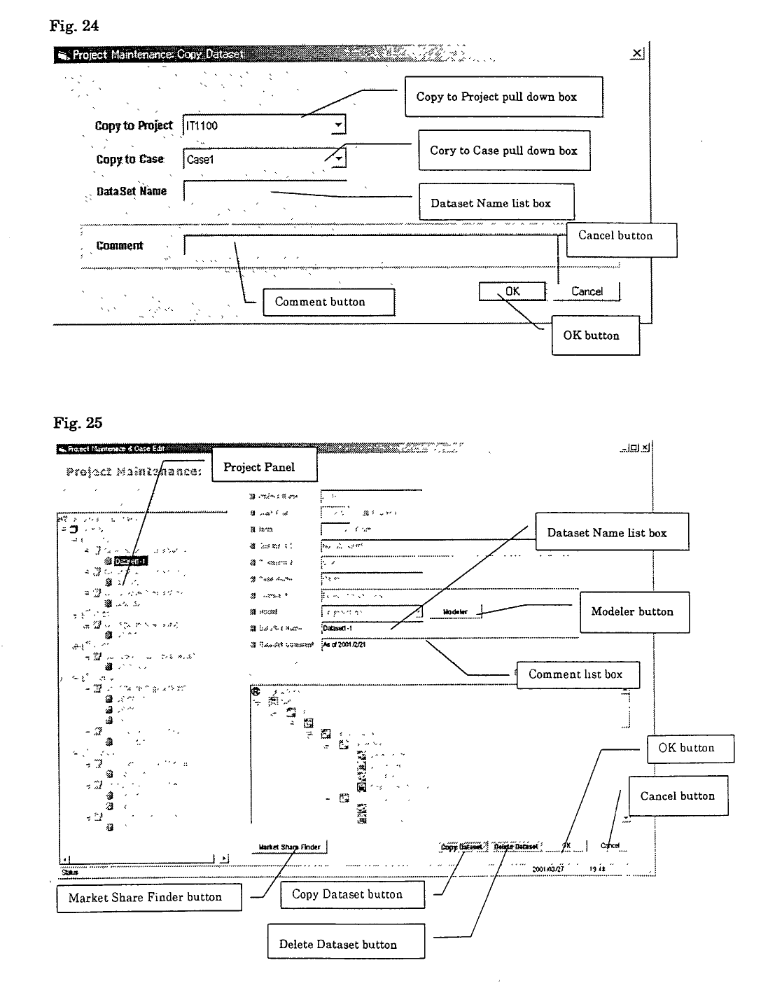

(3) Input Copy To Project (necessary), Copy to Case (necessary) and Dataset Name (necessary) (refer to FIG. 24).

(4) Dataset that is copied will be added to the Project Panel after selecting the OK button.

Dataset copy is possible to a Case that have the same Profit Tree Model with the selected Dataset.

3.4 Edit a Dataset:

(1) Select a Dataset from the Project Panel in which to input and edit data.

(2) Maintain Dataset Screen will be indicated (refer to FIG. 25).

(3) Select the optional Item in the Case Edit Panel.

(4) Case Edit Screen will be opened. Check the content and select.

Select the applicable image in the Profit Tree when checking the data edit of a Data Item, and the calculation data result of a Calculation Item (possible to classify by Scalar Data, Series Data, Complement Data, Calculation Item).

When there is an error in the Dataset data, or when input is not complete, that Dataset icon in the Project Panel will be indicated in red. If the Dataset remains in red, the Case using this Dataset cannot be a Working Case. Dataset indicated in blue will not have any error, and be selected as a Working Case. Select the following in the Case Edit Screen.

(A) Select Series Type (only for Series Type Data Item).

(B) Modify when changing the Unit that is selected at the Profit Tree Model. Unit Type which is selectable here can be added/modified in the Unit Edit.

(C) Modify when changing the Select Assumption that is selected in the Profit Tree Model. Data Item selected as an Assumption will need to select the Base/Low/High value and the Distribution Type.

3.5 Scalar Data Item Edit:

Scalar Data Item will hold one value during the Project term without changing in a yearly bases.

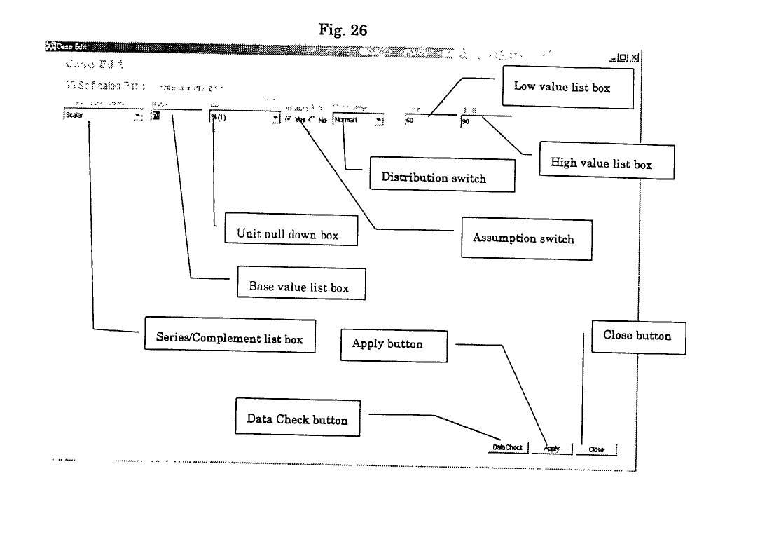

(1) Select Base Value, Unit and Assumption (Yes/No) (refer to FIG. 26).

(2) When Yes is selected for an Assumption, select the Distribution Type, Low Value and the High Value (Option Value (1), Option Value (2), depending on Distribution Type)

(3) Select Apply button for modifying a setting.

Select the Data Check button in order to list the Item Name with an error when Dataset includes an Item with an error or an uncompleted input (indicated in red).

3.6 Series Data Item Edit:

Data will change by time series. Selection method will differ by the selected Series Type.

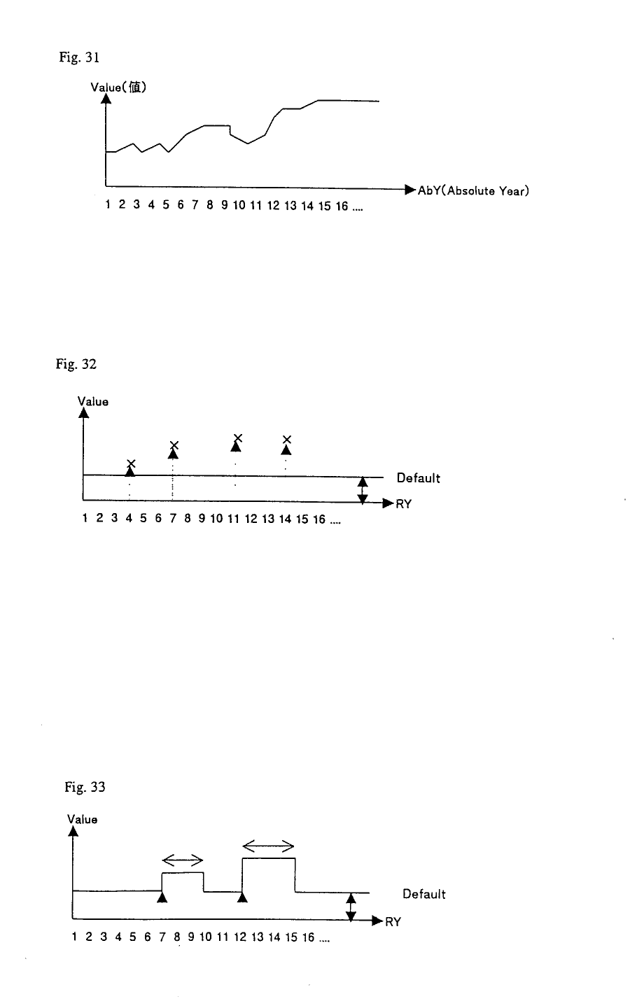

In the case of Series Type AP All (refer to FIG. 31)

(1) Select Series/Complement and Unit.

(2) Input the Assumption Value directly to the Data Table.

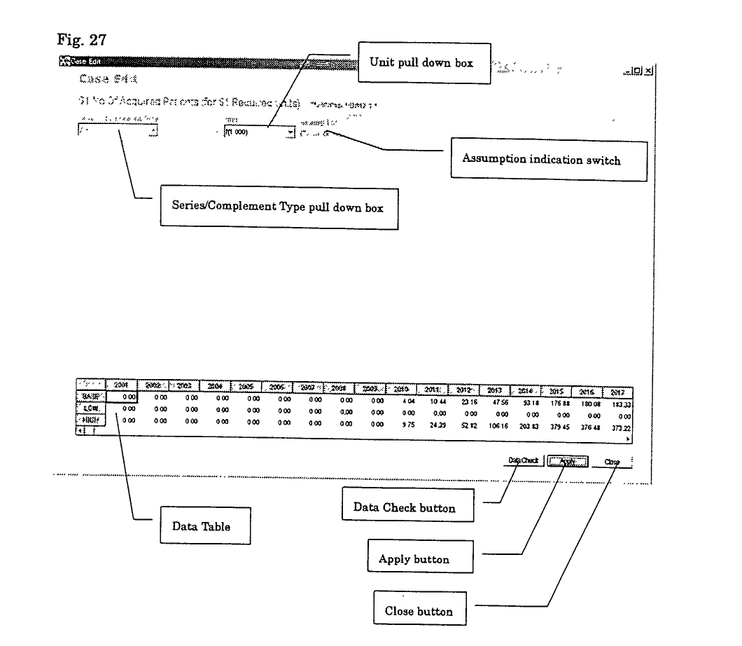

(3) Select Apply button when modifying a setting (refer to FIG. 27).

In the case of Series Type AP Point (refer to FIG. 32), AP Period (refer to FIG. 33):

(1) Select the Series/Complement, Unit and input Base value.

(2) Assumption will be a No.

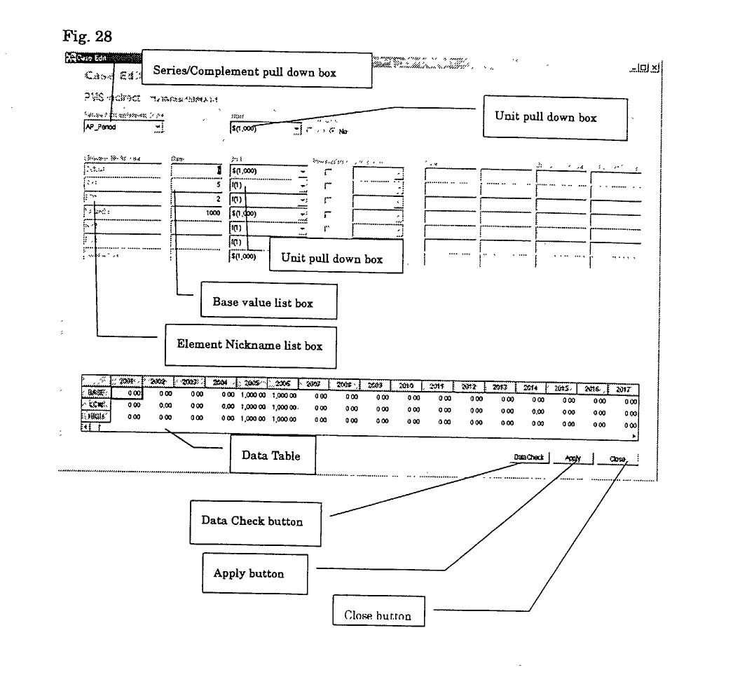

(3) Select Apply button when modifying a setting (refer to FIG. 28).

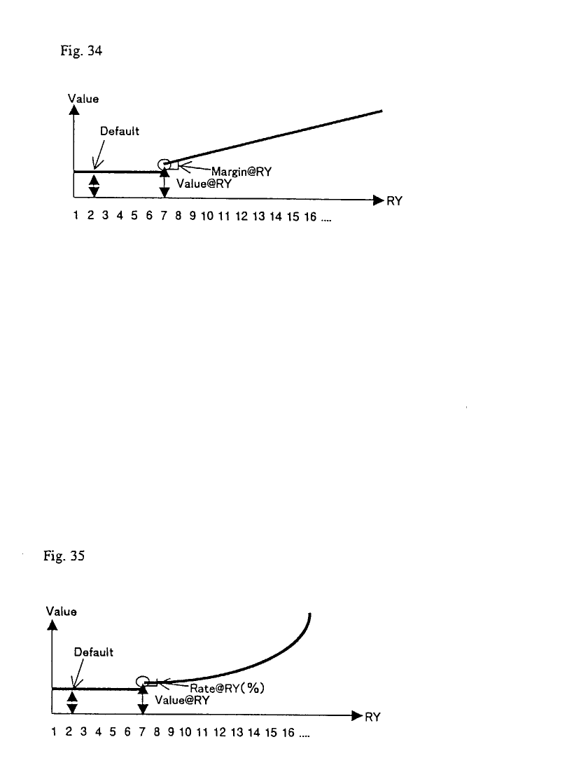

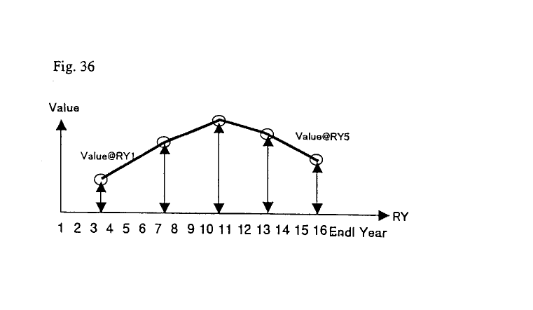

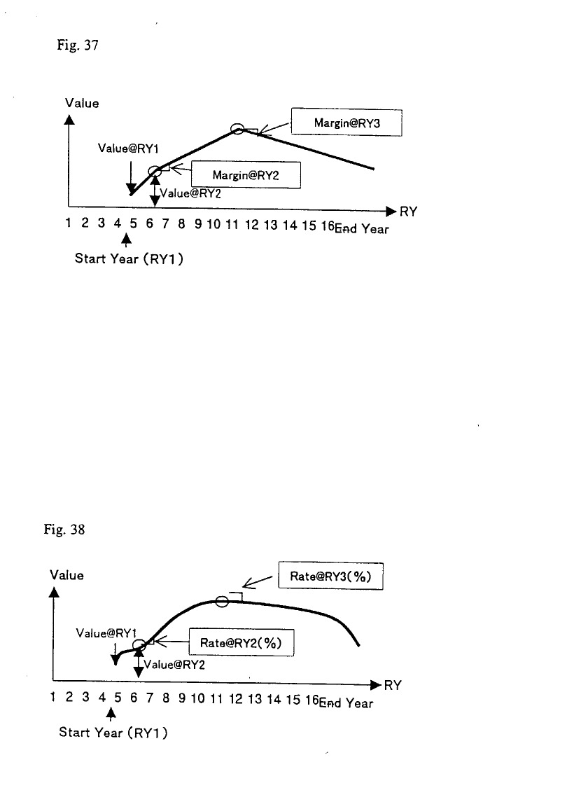

In the case of Series Type CP Increment L (refer to FIG. 34)/E (refer to FIG. 35), CP Value L (refer to FIG. 36), CP Share L (refer to FIG. 37)/E (refer to FIG. 38):

(1) Select the Series/Complement, Unit and Assumption (Yes/No).

(2) Input the individual Base Value, Unit, Assumption by every Element. Individual setting will become the priority regarding an Assumption and Unit.

(3) Select Distribution Type, Low Value, High Value when Assumption is a Yes. (Option Value (1), Option Value (2) depending on the Distribution Type).

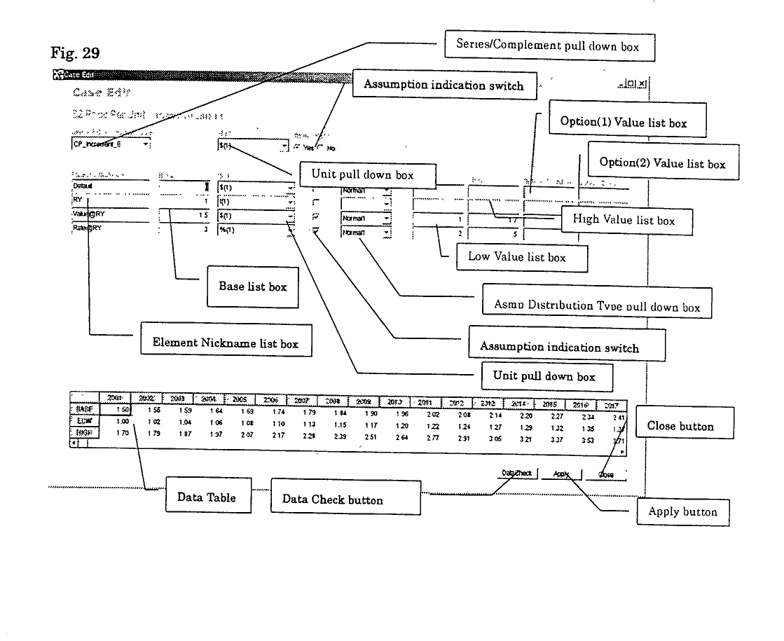

(4) Select Apply button when modifying a setting (refer to FIG. 29).

3.7 Unit Modification and Confirmation for a Calculation Item:

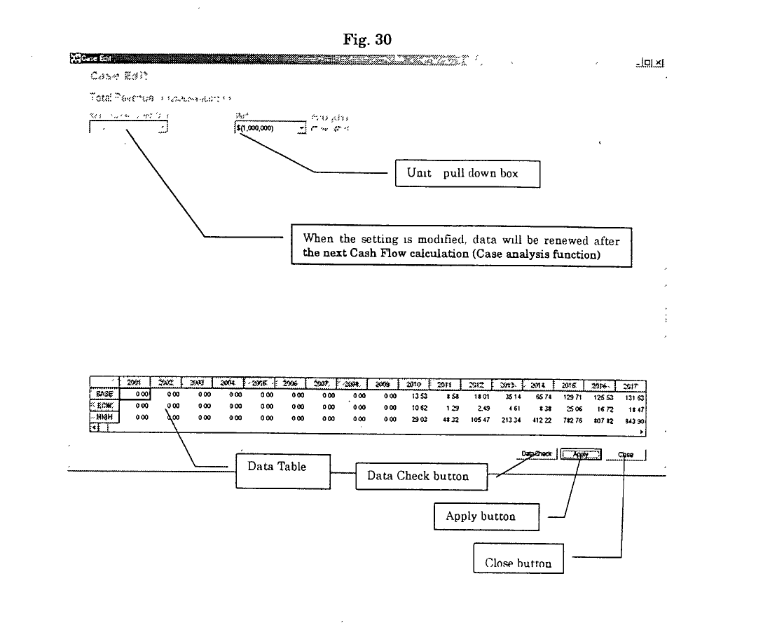

Unit modification is possible for a Calculation Item. Also, the calculation results can be confirmed (refer to FIG. 30). 4. Regarding series type:

The series type is a type where time series fluctuations of Assumption Value are distributed. FIGS. 31 to 38 show contents of respective series types.

(1) AP_All (All Point/Type All), FIG. 31:

Select the Value for each year individually for all the period. Select all the Values from the 1st year to the n year (Project term) in the chart directly.

(2) AP_Point (All Point/Type Point), FIG. 32:

Select the Value which correspond to the appointed year (RY). Non-appointed year will be set as a Default.

Default: Non-appointed Value,

RY1: Relative Year 1,

Value@RY1: Value 1 to the Relative Year 1,

RY2: Relative Year 2,

Value@RY2: Value 2 to the Relative Year 2,

RY3: Relative Year 3,

Value@RY3: Value 3 to the Relative Year 3,

RY4: Relative Year 4,

Value@RY4: Value 4 to the Relative Year 4,

RY5: Relative Year 5,

Value@RY5: Value 5 to the Relative Year 5.

(3) AP_Period (All Point/Type Period), FIG. 33:

Select the Value which correspond to the period (PD: Period) that start from the selected Relative Year (RY). Non-appointed year will be set as a Default.

Default: Non-appointed Value,

RY1: Appointed Relative Year 1,

PD1: Appointed Period 1 (from Relative Year 1)

Value@RY1: Value 1 to the Period 1,

RY2: Appointed Relative Year 2,

PD2: Appointed Period 2 (from Relative Year 2),

Value@RY2: Value 2 to the Period 2,

Period for PD1 and PD2 cannot overlap. PD1, PD2, and the sum of PD1 and PD2 cannot go over the Project period.

(4) CP_Increment_L (Complement/Type Increment_Linear), FIG. 34:

From the Value which correspond to the Relative Year (RY), the Value fluctuates in a linear by following the margin. Years before the selected Relative Year, will be set as a Default.

Default: Non-appointed Value,

RY: Appointed Relative Year,

Value@RY: Value for the appointed Relative Year,

Margin@RY: Margin (from the appointed Relative Year)

Input is necessary for all Elements. Not authorized to select only the Default. Default=Value until the fluctuation rate calculation starts.

(5) CP_Increment_E (Complement/Type Increment Exponential), FIG. 35:

From the Value which correspond to the Relative Year (RY), the Value fluctuates in an exponential by following the fluctuation Rate (Rate). Years before the selected Relative Year, will be set as a Default.

Default: Non-appointed Value,

RY: Appointed Relative Year,

Value@RY: Value for the appointed Relative Year,

Rate@RY: Fluctuation Rate (from the appointed Relative Year.

Input is necessary for all Elements. Not authorized to select only the Default. Default=Value until the fluctuation rate calculation starts.

(6) CP_Value_L (Complement/Type Linear Value_Linear) FIG. 36:

When several Value (Value@RY) of the Relative Year (RY) is selected, the intervals will be complemented by a linear.

RY1: Appointed Relative Year 1,

Value@RY1: Value 1 for the appointed Relative Year

RY2: Appointed Relative Year 2,

Value@RY2: Value 2 for the appointed Relative Year

RY3: Appointed Relative Year 3,

Value@RY3: Value 3 for the appointed Relative Year

RY4: Appointed Relative Year 4,

Value@RY4: Value 4 for the Appointed Relative Year

RY5: Appointed Relative Year 5,

Value@RY5: Value 5 for the appointed Relative Year.

Input of some Elements are optional. Value selection is possible from 1 to 5. When a certain Relative Year (RYx) is selected, the corresponding Value (Value@RYx) must have the input. Select as RY1<RY2<RY3<RY4<RY5.

(7) CP_Sharee_L (Complement/Type Share_Linear), FIG. 37:

Complement by the linear as Relative Year 1 (RY1) becomes Value 1 (Value@RY1), and Relative Year 2 becomes Value 2 (Value@RY2). Fluctuate the following year of Relative Year 2 (RY2) by Margin 2 (Margin@RY2), and fluctuate the

Relative Year 3 (RY3) by Margin 3 (Margin@RY3). Select 0 when the value is below zero.

RY1: Appointed Relative Year 1,

Value@RY1: Value 1 for the Relative Year 1,

RY2: Appointed Relative Year 2,

Value@RY2: Value 2 for the Relative Year 2,

Margin@RY2: Margin 2 (from Relative Year 2),

RY3: Appointed Relative Year 3,

Margin@RY3: Margin 3 (from Relative Year 3).

Input is necessary for all Elements. Select as Relative Year 1 (RY1)<Relative Year 2 (RY2).

(8) CP_Sharee_E (Complement/type Share_Exponential), FIG. 38:

Complement by the exponential as Relative Year 1 (RY1) becomes Value 1 (Value@RY1), and Relative Year 2 becomes Value 2 (Value@RY2). Fluctuate the following year of Relative Year (RY2) by Fluctuation Rate 2 (Margin@RY2), and

fluctuate the Relative Year 3 (RY3) by Fluctuation Rate 3 (Margin@RY3). Select 0 when the value is below zero.

RY1: Appointed Relative Year 1,

Value@RY1: Value 1 for the Relative Year 1,

RY2: Appointed Relative Year 2 Value@RY2: Value 2 for the Relative Year 2,

Rate@RY2: Fluctuation Rate 2 (from Relative Year 2),

RY3: Appointed Relative Year 3,

Rate@RY3: Fluctuation Rate 3 (from Relative Year 3).

5. Regarding Distribution Type:

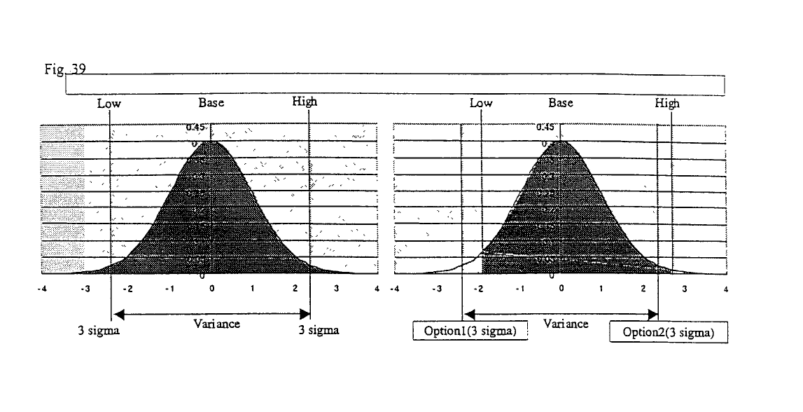

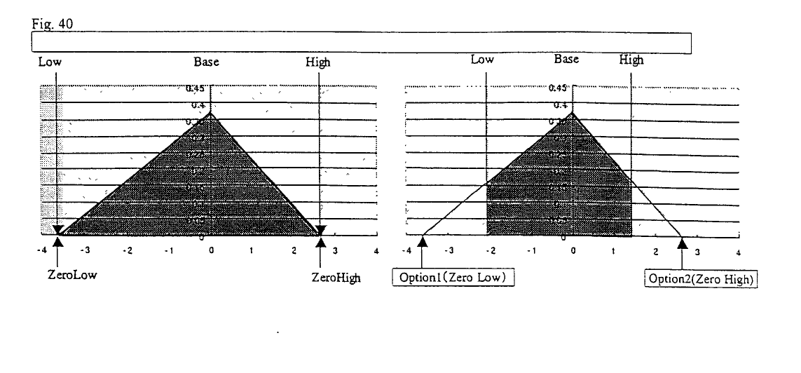

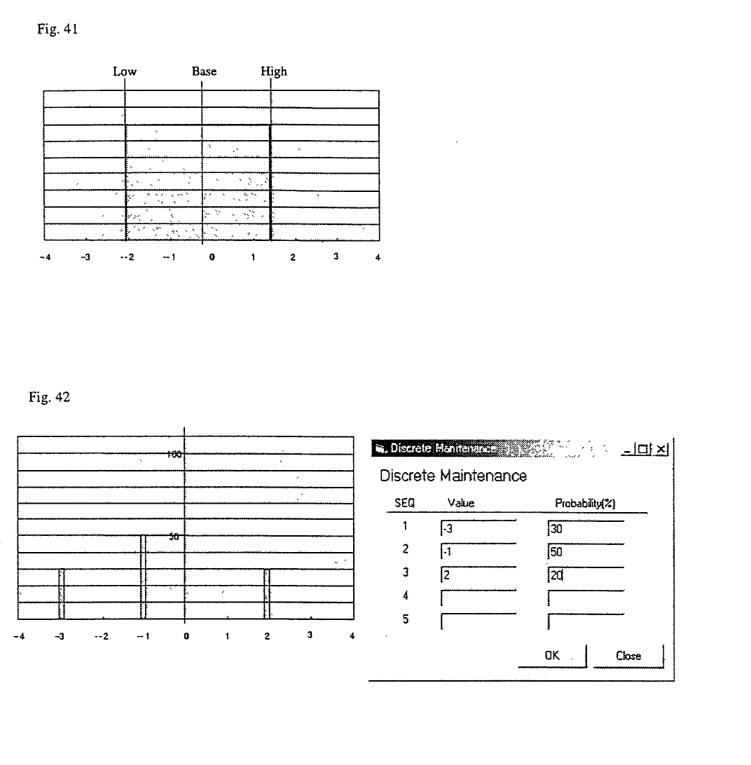

The distribution type is a type where a distribution within a range from Low Value to High Value obtained when Assumption Value is fluctuated is classified. FIG. 39 shows a normal distribution, and FIG. 40 shows a triangular distribution. Also, FIG. 41 shows an equal distribution, and FIG. 42 shows a discrete distribution.

It classifies the distribution between the Low Value and the High Value when the Assumption Value is changed.

5.1 Normal Distribution (refer to FIG. 39):

5.1.1 Characteristic of Normal Distribution 1 (FIG. 39 Left):

Generate the random numbers unconditionally without any relationship to the Low Value or the High Value.

Low=small 3 sigma value,

High=large 3 sigma value.

The generated random number will have 99.73% chance to be in the range created by the 3 sigma value. Therefore, the chance of the number being outside the 3 sigma range is about 3/1000.

5.1.2 Characteristic of Normal Distribution 2 (FIG. 39 Right):

Generate the random numbers between the selected Low and the High Value.

Low=selected Low Value,

High=selected High Value,

Option1=small 3 sigma value,

Option2=large 3 sigma value.

Low and High will be the limit for the selected Value when generating the random numbers. Relationship of size does not matter for Low (High) and Option1 (Option2).

5.2 Triangular Distribution (refer to FIG. 40):

5.2.1 Characteristic of Triangular Distribution 1 (FIG. 40 Left):

Generate the random number between the range of Low Value=High Value=zero point.

Low=Zero Low (small zero point),

High=Zero High (large zero point),

Zero point of Low and High value is a point where the probability of generating the random number is 0. Value will not be generated over this range. Generate the random number within the triangle where Low and High match with the zero point.

5.2.2 Characteristic of Triangular Distribution 2 (FIG. 40 Right):

Generate the random numbers between the selected Low and High value.

Low=selected Low Value,

High=selected High Value,

Option1=Zero Low (small zero point),

Option2=Zero High (large zero point).

Low and High will be the limit for the selected Value when generating the random numbers. Generate the random number for the Triangular Distribution which is created by the Zero Point of Option 1 and Option 2, when the selected Low and High Value is the limit.

5.3 Equal Distribution (refer to FIG. 41):

5.3.1 Characteristic of Equal Distribution:

Generate the random number equally between the selected Low and High Value.

Low=selected Low Value,

High=selected High Value.

Low and High will be the limit for the selected Value when generating the random numbers.

5.4 Discrete Distribution (refer to FIG. 42):

5.4.1 Characteristic of Discrete Distribution:

Generate the random number in the selected discrete Value.

Value=selected Discrete Value,

Probability=generation frequency (total needs to be 100%).

Contents of the Modeler will now be described.

1. What is a Modeler:

It is a function to create and edit the Profit Tree. In the Modeler, the Profit Tree will be graphically expressed, and it is unnecessary to input a confusing calculation figure. It is also possible to create and edit the profit structure model by the easy operation.

2. Function Description:

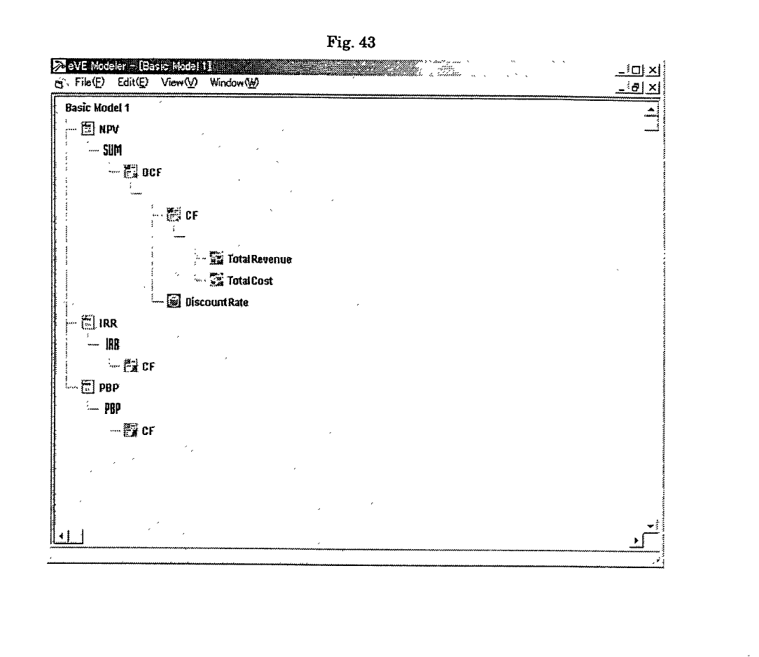

Refer to FIG. 43.

An Initial Tree is the most simplest Profit Tree, and will include the Items and Connections that are indispensable to the profit calculation practice. Initial Tree will be indicated when creating a new Profit Tree. Item and Connection in the new Tree cannot be deleted.

A Root Item exists only in a Model, and the Profit Tree Name will be indicated. Cannot be deleted.

An Item is an element that can hold a value in the Profit Tree. Below are the 4 Item types.

(1) Data Item: Item that holds a data value. Cannot hold a child.

(2) Calculation Item: Item when a child holds one Function or an Operation Sign.

(3) Constant Item: Item that holds a Constant. Cannot hold a child.

(4) Reference Item: Imaginary Item that refer to other Item contents (value and Property). Cannot hold a child.

Adult Item: When a certain Item is linked with a different Item on the right hand side (lower layer).

Child Item: When a certain Item is linked with a different Item on the left hand side (upper layer).

Connection has an Operation Sign and a Function, and is an object that will link the Items.

3. Usage of a Modeler:

3.1 Start:

Select the Modeler button in the Project Maintenance & Case Edit. Main screen will open (refer to FIG. 43).

3.2 Opening an Existing Model, Create New Opening an Existing Model

(1) Select File from the Menu.

(2) Select Open.

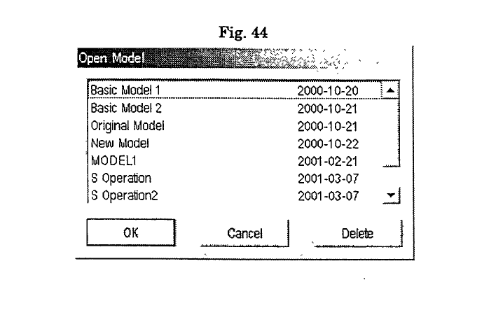

(3) Open Model Screen (refer to FIG. 44) will be opened.

(4) Select Model and open.

Select New from the Menu when creating a new Model.

3.3. Edit:

Edit operation of a Modeler can be done by selecting the Edit in the Menu Bar, or from the pop up menu (indicated through the right hand click when Item or Connection is selected).

Edit 1 (Adding an Item):

(1) Select the Item on a Tree where the Item needs to be added, or select the Connection and right click (upper graph).

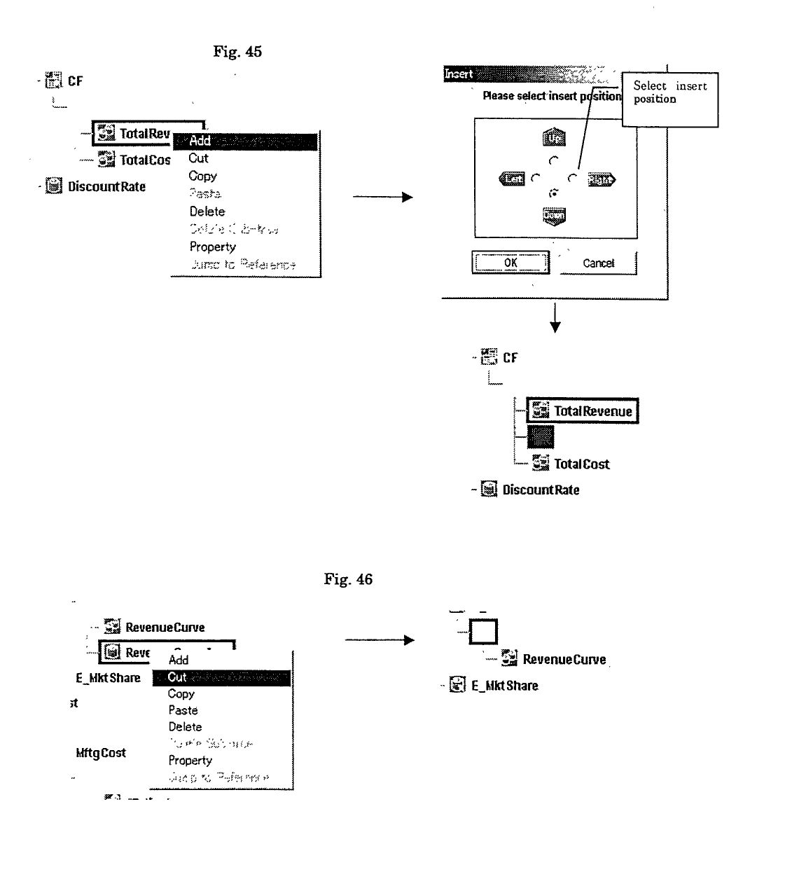

(2) Select Add from the pop up Menu (refer to FIG. 45).

(3) (When the object of the Add operation is an Item) select the position to add from the Insert dialog (upper left hand graph) (refer to FIG. 45).

Up: Item will be added above the Item object for Add operation.

Left: Connection or an Item will be added at the left hand side (upper layer) of the Item object for Add operation.

Right: Connection or an Item will be added at the right hand side (lower layer) of the object Item for Add operation (it is not possible to add to the right hand side when Item Type is a data).

Down: Item will be added below the object Item for Add operation.

(4) Item will be added as a blank Item (refer to FIG. 45).

(5) Select Property from the pop up Menu.

(6) Select the Item Type, Item Name from the Property select dialog (see “Edit 6” for Select Property).

Edit 2 (Item Delete/Cut):

Use Cut for Cut & Paste.

(1) Select the Item to be deleted (cut), and right click.

(2) Select Delete (Cut) from the pop up menu (refer to FIG. 46).

(3) Item or the unnecessary Connection of a parent will be deleted (refer to FIG. 46).

Edit 3 (Undo):

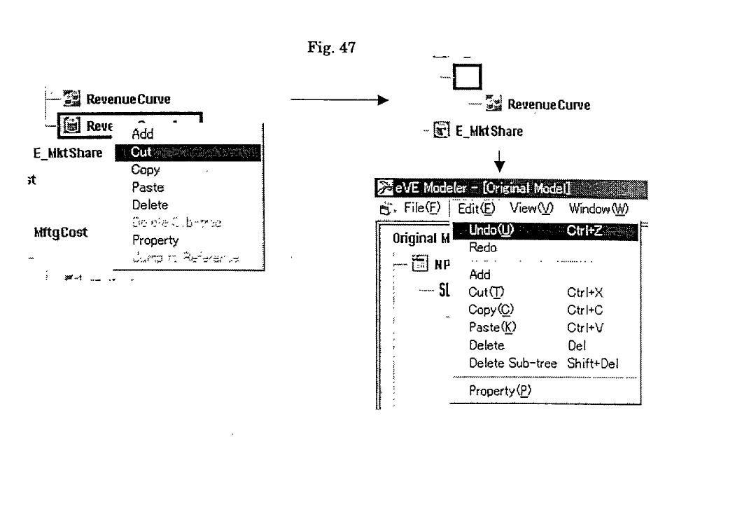

For all edit functions, Undo will cancel the most recent operation. Select Undo from the Edit in the Menu (refer to FIG. 47). Bar, such as the right hand graph.

Edit 4 (Delete Sub-Tree):

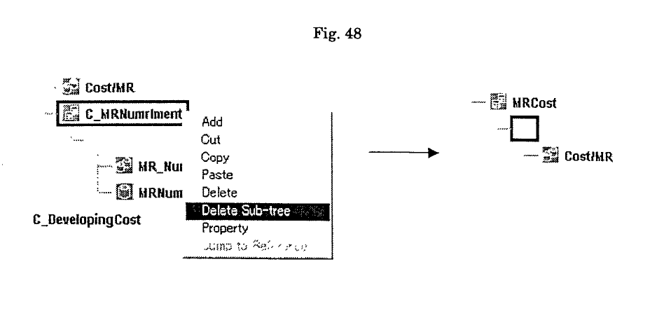

A Sub Tree is a set of an Item or a Connection which is linked by a child and a grandchild. Select the parent Item (Item which is linked with a different Item on the right hand side (lower layer)) that needs to be deleted together with a child Item (Item which is linked with a different Item on the left hand side (upper layer)), and right click. Select Delete Sub-tree from the pop up Menu. All of the child Item or Connection under the selected Item will be deleted (refer to FIG. 48).

Edit 5 (Copy & Paste (similar for Cut & Paste)):

(1) Select the Item to Copy&Paste (Cut&Paste), and right click.

(2) Select Copy from the pop up menu.

(3) Select Item to Paste, and right click.

(4) Select Paste from pop up menu.

(5) Select the Pa set position at the dialog.

Up: Pasted above the object Item for Paste operation.

Replace: Object Item for Paste operation will be copied (cut), and be replaced.

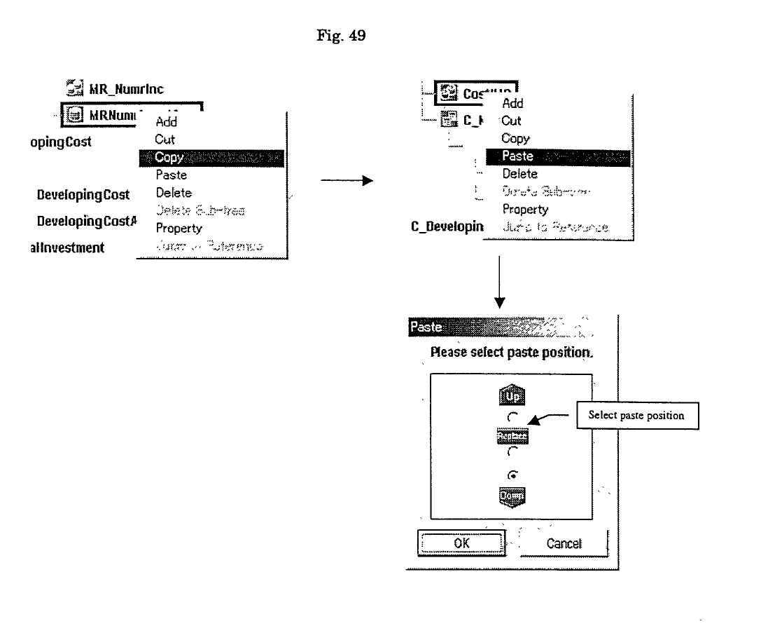

Down: Pasted below the object Item for Paste operation (refer to FIG. 49).

Edit 6 (Property):

(1) Select the Item to be modified or select Property.

(2) Select Property from the pop up menu.

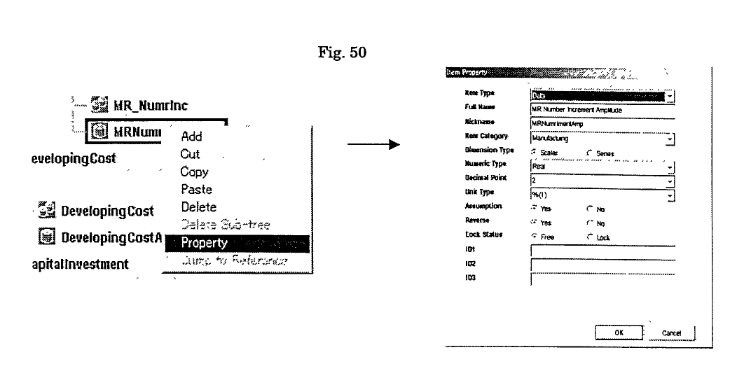

(3) Select Property after Select Property dialog appears (refer to FIG. 50) (similar operation for Connection).

Edit 7 (Jump to Reference):

Reference function will refer to the non-reference value (Item already defined). It is used when copying to the Item (imaginary Item).

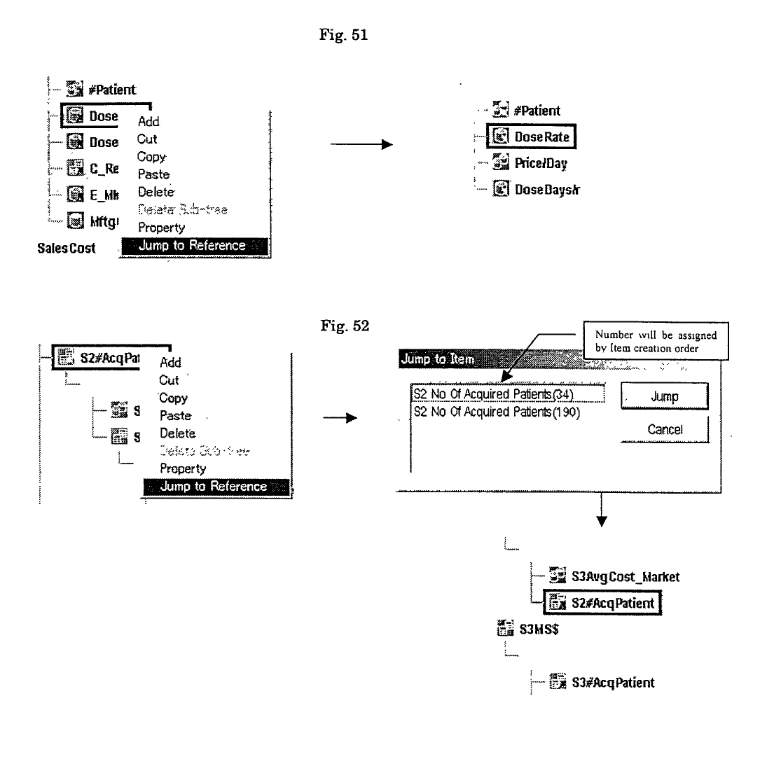

In FIG. 51,

(1) Select Reference Item.

(2) Select Jump to Reference by the right click.

(3) Non-reference Item will be selected.

In FIG. 52,

(1) Select Non-reference Item.

(2) Dialog will appear, and all Reference Item will be indicated.

(3) Select Reference to Jump.

(4) Selected Reference Item after Jump will be selected.

Edit 8 (Property Edit (Select Property for Various Item Selection)):

(1) Select various Item by Ctrl+ left click.

(2) Delete, will only delete Sub Tree.

Property modification is possible regarding various Item.

(1) Select various Item by Ctrl+ left click.

(2) Select Edit from the Menu.

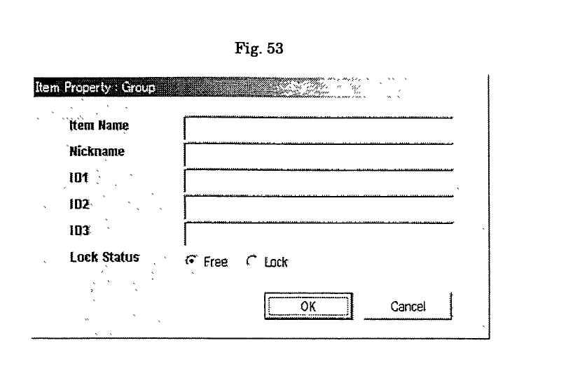

(3) FIG. 53 will appear when selecting Property.

Group Modifying dialog will change the Property of a various Item altogether. Format of modification will be explained below.

Item Name: Receive the character string, and insert it in front of the existing name of each Item. Delete characters that are full.

Nick Name: Receive the character string, and insert it in front of the existing name of each Item. Delete characters that are full.

ID1-3: Receive the new ID. Apply the same modification for all ID.

ID1 is used for the discrimination of Sub-market data (example: SM1: Sub-market 1).

Lock Flag: Select Item to be Lock (not possible to delete) or not.

3.4 Save the Model and Save in a Different Name:

Save Model:

(1) Select File from the Menu.

(2) Select Save.

Save in a Different Name:

(1) Select File from the Menu.

(2) Select Save as.

(3) Model Name screen will open.

(4) Input Model Name and save.

Cannot be saved when there is an error (red indication) in the Profit Tree.

3.5 Property:

Make an entry of the Property contents which appear from the Edit 6 operation. Select Property can classify the 4 Items (Data Type, Calculation Type, Reference Type, Constant Type) and the Connection. Each setting will be explained below.

3.5.1 Item Property:

It will describe the Item Property regarding the Data Item, Calculation Item, Reference Item, Constant Item, Connection.

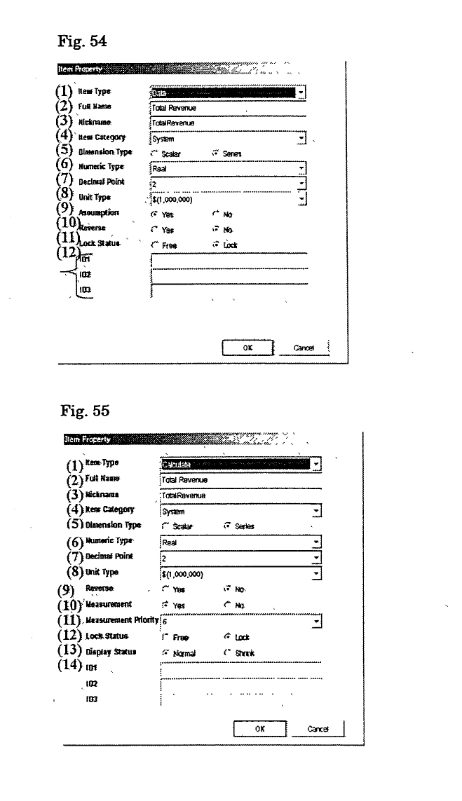

Data Item Type (refer to FIG. 54):

(1) Item Type: Select Item typed.

Data: Data Item (assumption),

Calculate: Calculation Item,

Reference: Reference Item (copy and use the value of the defined Item),

Constant: Constant Item (constant value during the calculation).

(2) Full Name: Full Name Item (maximum of 32 words)

(3) Nick Name: Nickname Item (maximum of 20 words) Name frequently used in the Radmap.

(4) Item Category: Item classification. Used to classify the Item data.

System: System Definition Item,

Common: Common Item,

Market: Item regarding sales and market,

R&D: Item for research and development cost,

Production: Item regarding production cost,

Sales & Marketing: Item regarding sales and marketing cost,

Other: Item which does not belong to the above.

(5) Dimension Type: Select if Item is a Time Series value or not.

Scalar: Scalar Item, constant during Project period and has one value,

Series: Series Item, value differs every year and can hold various values.

(6) Numeric Type: Select Numeric Type.

Integer: Integer Value,

Real: Real Value.

(7) Decimal Point: Select Decimal Point. Range from 0 to 2.

(8) Unit Type: Select Unit Type. Other than the system definition Unit, user can select the Unit on their own.

(9) Assumption: Select if it is an Assumption or not. If No is selected, it cannot be an Assumption.

(10) Reverse: Select whether or not a Reverse Item. Reverse Item: Item that is inversely proportional to Cash Flow (cost, discount rate).

(11) Lock Status: Select whether or not a Lock Item (not possible to delete).

(12) ID1-3: Used optionally. ID1 is used when classifying the Sub-market data (example: SM1: Sub-market 1).

Calculation Item Type (refer to FIG. 55):

(1) to (8), (9), (12) will be similar to Data Item. (10) Measurement: Select whether or not the Item is a Measurement value.

(11) Measurement Priority: Priority for Measurement value. 1 is the highest. List for Measurement value will be arranged by the priority order.

(13) Display Status: Select whether to shrink (hide the child) the Display Status or not.

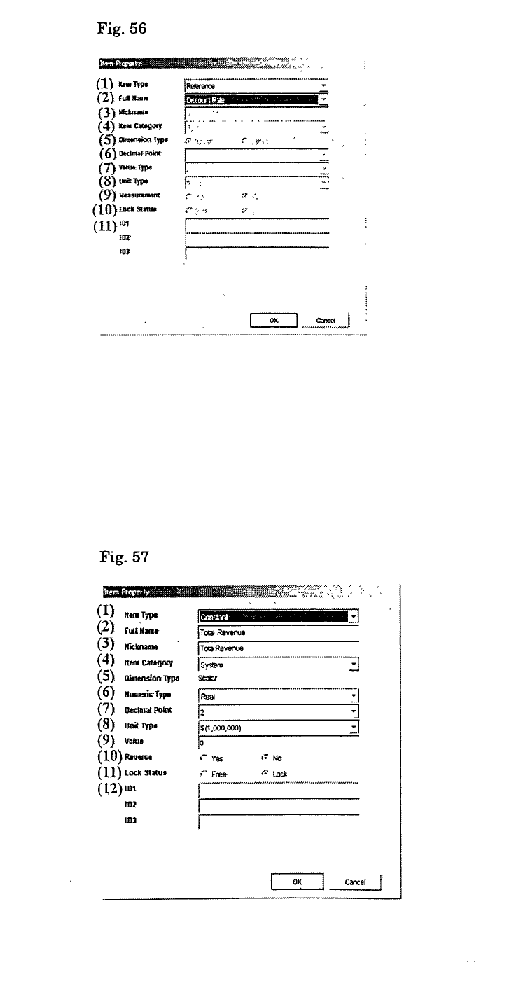

Reference Item Type (refer to FIG. 56):

(1) and (3) will be similar to Data Item.

(2) Full Name: Select the Item of reference origin (value of copy origin that will be copied). Pull down will list all Items that are defined.

(4) to (11) will be similar to the Property of reference origin Item.

Constant Item Type (refer to FIG. 57):

(1) to (8),(10),(12) will be similar to Data Item.

(9) Value: Select the value of Constant Item. Constant Item value can only be selected and modified in the Modeler.

3.5.2 Connection Property:

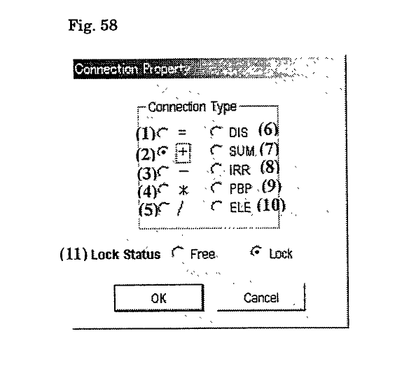

Connection (refer to FIG. 58):

(1) =: Used when Item is added. Does not have a meaning of an Operator.

(2) +: Add. Item order not inquired.

(3) −: Subtract. Subtracted from the top Item by the following Item.

(4) *: Multiply. Item order not inquired.

(5) /: Divide. Divided from the top Item by the following Item.

(6) DIS: Discount Function. Discount the Series value by the Scalar value. Output the Series value for child 1 value which is discounted by the discount rate defined from the child 2.

(7) SUM: Total Function. Total of the Series value from the 1st year to the end year.

(8) IRR: Internal Rate of Return Function. Calculate the Internal Rate of Return from the Series value.

(9) PBP: Recovery Year Function. Calculate the period until the cumulative value of the Series Value will become a plus.

(10) ELE: Element Function. Pull out the year selected by the Scalar value from the Series Value. Element of a number defined in child 2 within the element of child 1.

(11) will be similar to Data Item.

4. Error in the Modeler:

Error will occur for the following case. Model cannot be saved when the Item or the Connection has an error.

(1) Data Item has a child.

(2) Constant Item has a child.

(3) Reference Item has a child.

(4) Blank Item.

(5) Calculation Item does not have a child.

(6) Output of a child's Function and the Operation sign contradicts with the attribute of your own Property. Output of a child is a Series when you are a Scalar.

(7) A child's Property (Scalar, Series) contradicts With the Function.

Left Item of SUM, IRR, PBP is a “calculate”, right Item is a Series by itself (does not have brothers).

Left Item of +−*/ is a “calculate”, right Item is a Series by itself (does not have brothers).

DIS (child 1: Series, child 2: Scalar, output: Series)

ELE (child 1: Series, child 2: Scalar, output: Scalar)

(8) Define the same Nick Name.

(9) Occurrence of Circulation Reference.

Contents of Market Share Finder will now be described.

1. What is a Market Share Finder:

This function supports to estimate and select the market share value included in the Cash Flow Model. It will grade the company's Project Case and also the profile contents of the competitor with every Scoring Item (user can select optionally), and estimate the market share value with the overall score.

2. Function Description:

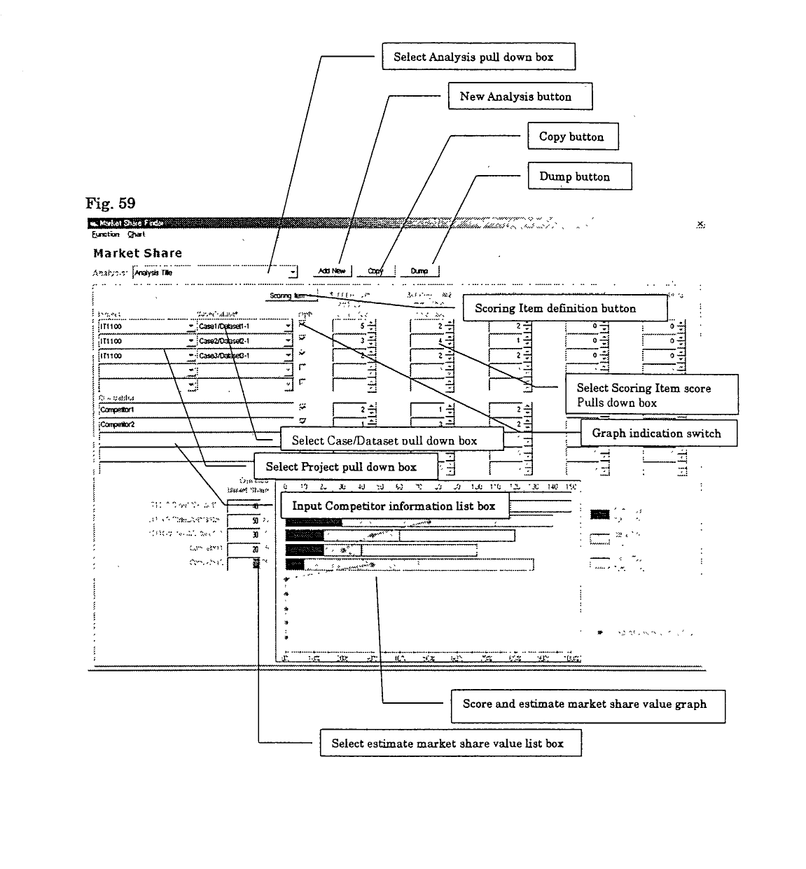

Refer to FIG. 59.

3. Usage of Market Share Finder:

3.1 Basic Operation:

(1) Definition of Analysis Title.

(2) Select analysis object.

(3) Select Scoring Item.

(4) Input Scoring Item value and estimate market share value.

(5) Indicate analysis result.

3.2 Definition of Analysis Title:

Select [Add New] button and input the Analysis Title (essential). Input any comment if necessary (optional) Select Analysis Object METHOD OF PROCESSING DIGITAL DATA.

(1) Select the Project or Case Datasets from the list box.

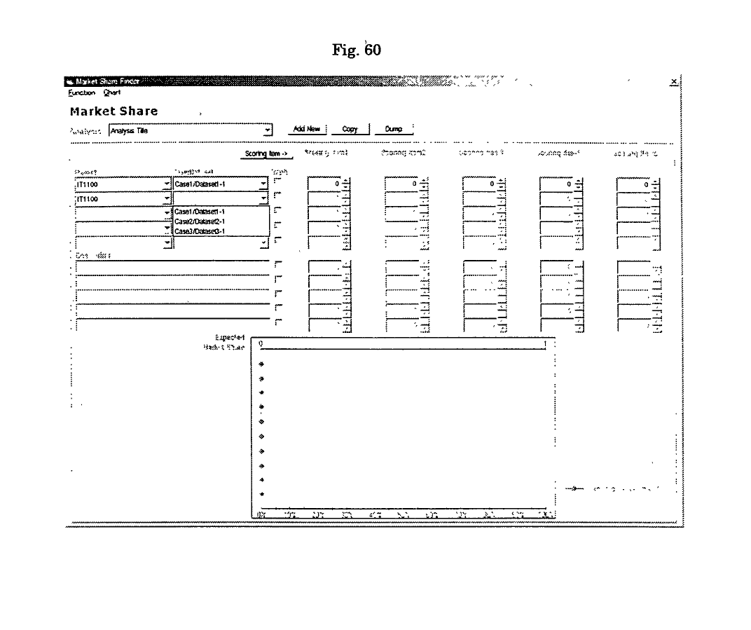

(2) Input the company and product name in the Competitor Information column (refer to FIG. 60).

3.3 Select Scoring Item:

(1) Select [Scoring Item] button.

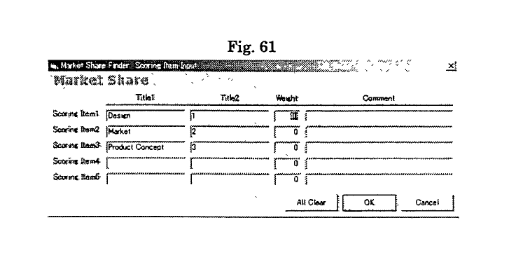

(2) Input the Title1 (essential), Title2 (optional) Weight (essential), Comment (optional) for each scoring item. Maximum of 5 Scoring Items can be selected (refer to FIG. 61).

3.4 Input Scoring Item Value and Estimate Market Share Value:

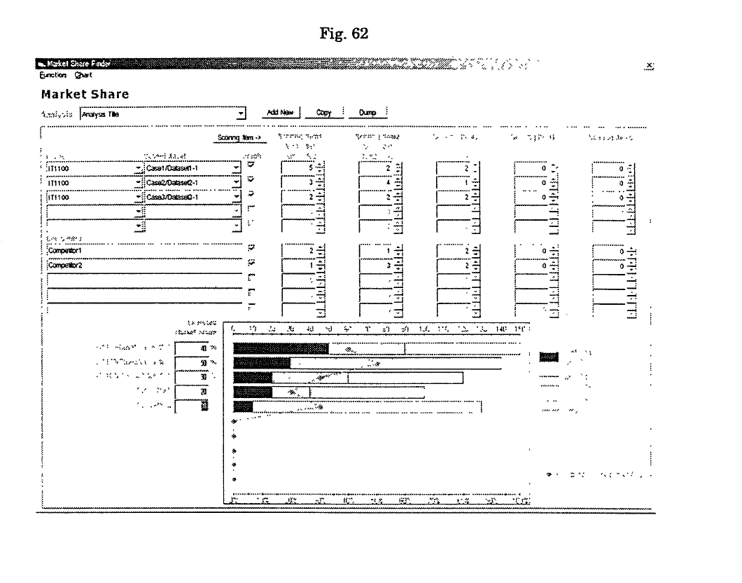

Select the score for the Scoring Item for each analysis object in the Scoring Item field. (Possible to select from 1 to 999). Selected score will be indicated as a bar graph by selecting the Graph indication switch check box (refer to FIG. 62). A line graph will be indicated after the input of estimate market share value (possible to select from 1 to 100%) in the estimate market share value setting field.

3.5 Other Operation:

Indication and non-indication of a graph can be selected at the Graph indication switching check box. Analysis results can be saved in a different name by selecting the [Copy] button.

Contents of Case Analysis will now be described.

1. What is a Case Analysis:

Case Analysis is a diversified analysis in which the object is to maximize the Case value, and to understand the influence of uncertainty. The function included in the Case Analysis are classified into “Analysis” and “Data Browse”. Analysis function belonging to “Analysis”, possess an analysis purpose which is special to each function (see individual analysis function page in this manual for reference). On the other hand, function belonging to “Data Browse” enables the user to select the input data and calculation data, and compare them. Each function of the Case Analysis targets the Case that is selected as a Working Case. It is necessary to select the Case at the Working Case Loader beforehand.

2. Function Description:

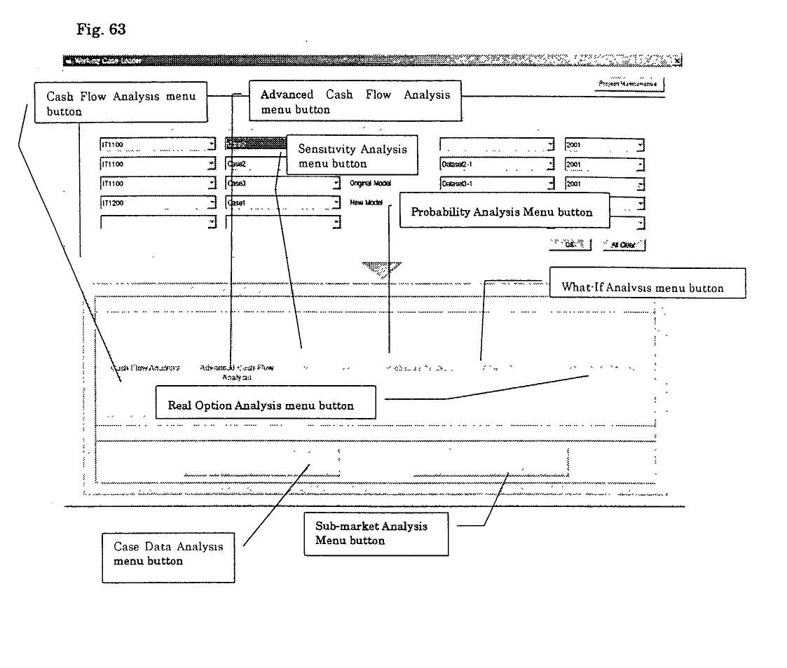

Refer to FIG. 63.

3. Usage of Case Analysis:

Select the main button of an analysis to indicate the analysis screen.

4. What is a Working Case Loader:

Select a Case in which to be analyzed by the Case Analysis function, and set it as a Working Case. Maximum of 5 Cases created in the Project Maintenance & Case Editor can be selected. Non-data input or error Cases cannot be selected. Also, identical Dataset cannot be selected as a different Working Case.

5. Function Description:

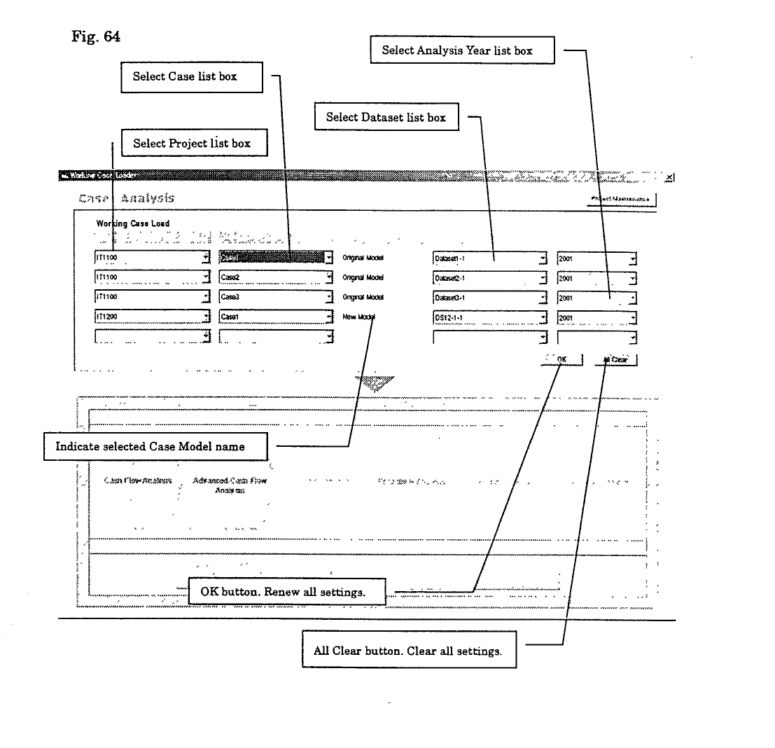

Refer to FIG. 64.

6. Usage of Working Case Loader:

Select in the order of:

(1) Project,

(2) Case,

(3) Dataset,

(4) Analysis Year.

Select the OK button when saving the settings.

Analysis Year is the year when the cash flow calculation for the analysis object starts. Default value is the project starting year, and the project period (excluding the project end year) can be selected optionally.

Contents of Cash Flow Analysis will now be described.

1. What is Cash Flow Analysis:

Cash Flow Analysis will automatically calculate the Measurement (NPV, IRR, PBP, CF, DCF, Total Revenue, Total Cost) of system definition beginning with Cash Flow, by using the profit calculation logic set at the Cash Flow Model, and the Dataset set at the data. It will also indicate the results on a table and a graph. Cash Flow Analysis will also provide with a list of Assumption Value for the case of Base, Low and High. Therefore, it is possible to analyze and evaluate the uncertainty with consideration.

2. Function Description:

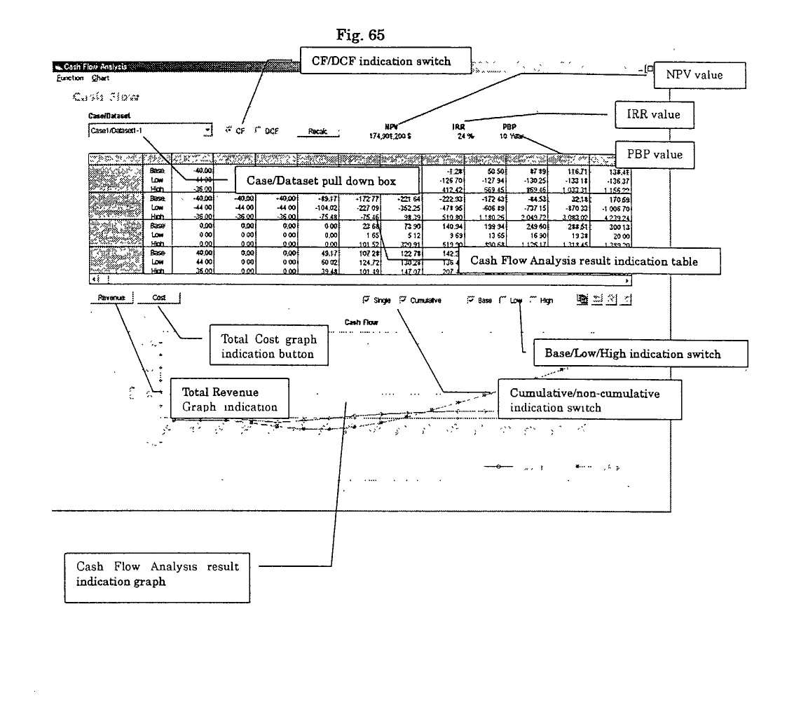

Refer to FIG. 65.

3. Usage of Cash Flow Analysis Function:

3.1 Basic Operation:

(1) Select Case/Dataset.

(2) Indicate analysis results.

3.2 Select Case/Dataset:

(1) Select the Case/Dataset to be analyzed from the Case/Dataset pull down button.

(2) Analysis results will be indicated.

3.3 Other Operations:

Use the functions below for graph switching and multiple indication.

Single Year Cash Flow, Cumulative Cash Flow indication switch: Only indicate the graph selected at the “Single”, “Cumulative” check box. Multiple indication possible.

Base, Low, High Indication Switch: Only indicate the graph selected at the “Base”, “Low”, “High” check box. Multiple indication possible.

Indication of Total Revenue and Total Cost: Indicate the Total Revenue, Total Cost graph by selecting the “Revenue” button and the “Cost” button (Note: not possible to indicate both graphs at once).

Contents of Advanced Cash Flow Analysis will now be described.

1. What is Advanced Cash Flow Analysis:

Advanced Cash Flow Analysis has a comparative analysis function. Various Case/Dataset and the selected Measurement value can be compared in the same chart and graph. Analysis of various combination can be done regarding the Case/Dataset, (selected at the Working Case Loader) by selecting one of the Measurement in the Series Type.

2. Function Description:

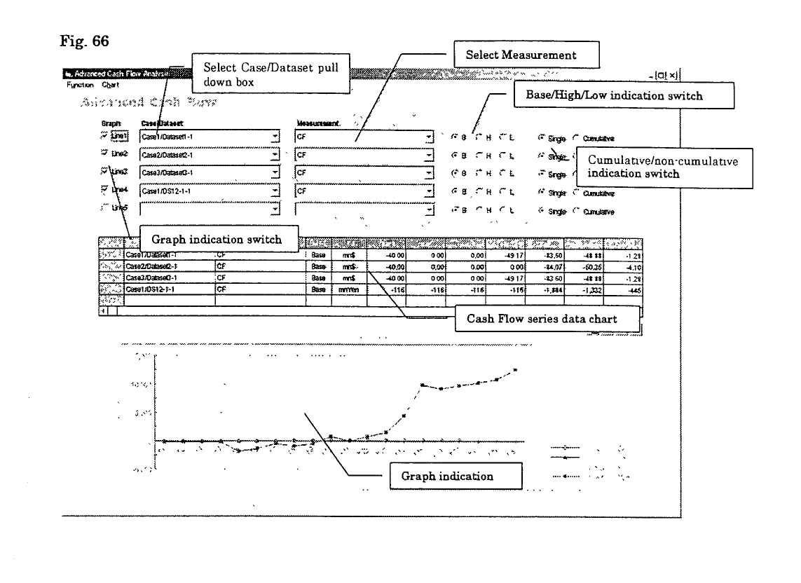

Refer to FIG. 66.

3. Usage of Advanced Cash Flow Analysis:

When starting the Advanced Cash Flow Analysis, Cash Flow value (a kind of Measurement) selected at the Case/Dataset (maximum of 5), will be indicated as a chart or on a graph. It is possible to indicate various graphs by combining the Case/Dataset and Measurement, depending on which contents to compare. Below example will show the combination of Case/Dataset and Measurement.

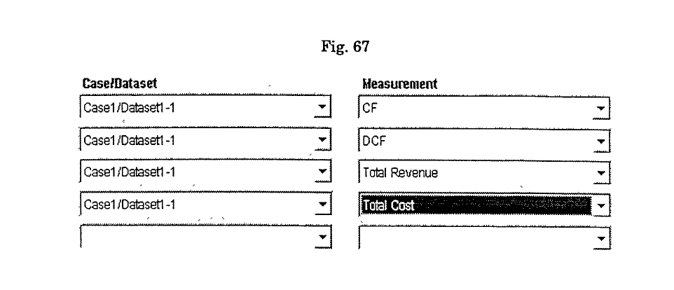

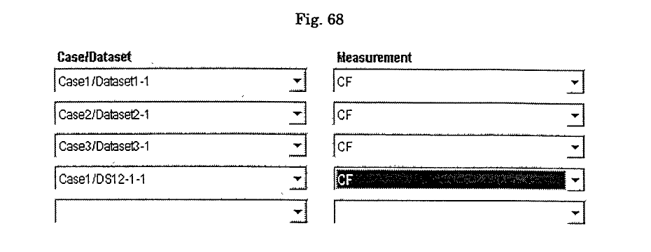

Comparative analysis between various types of Measurement value and one Case/Dataset. As in FIG. 67, select a different Measurement for the identical Case/Dataset. Comparative analysis between one Measurement value and various types of Case/Dataset. As in FIG. 68, select a different Case/Dataset for the identical Measurement. Indicating a graph that freely combines the Case/Dataset and Measurement. Create the combination from the pull-down arrow of Case/Dataset and Measurement, and indicate the analysis result in a graph.

Contents of Sensitivity Analysis will now be described.

1. What is Sensitivity Analysis:

Sensitivity Analysis will visualize the influence on the business value when the Assumption data, such as costs and sales force number, included in the Cash Flow Model changes. It will research the influence (sensitivity) on the Measurement when each Assumption value is changed one at a time from Low to High. The results from the Sensitivity Analysis will clarify which assumption should the resource be focused on and which to consider a risk avert method in order to maximize the business value.

2. Function Description:

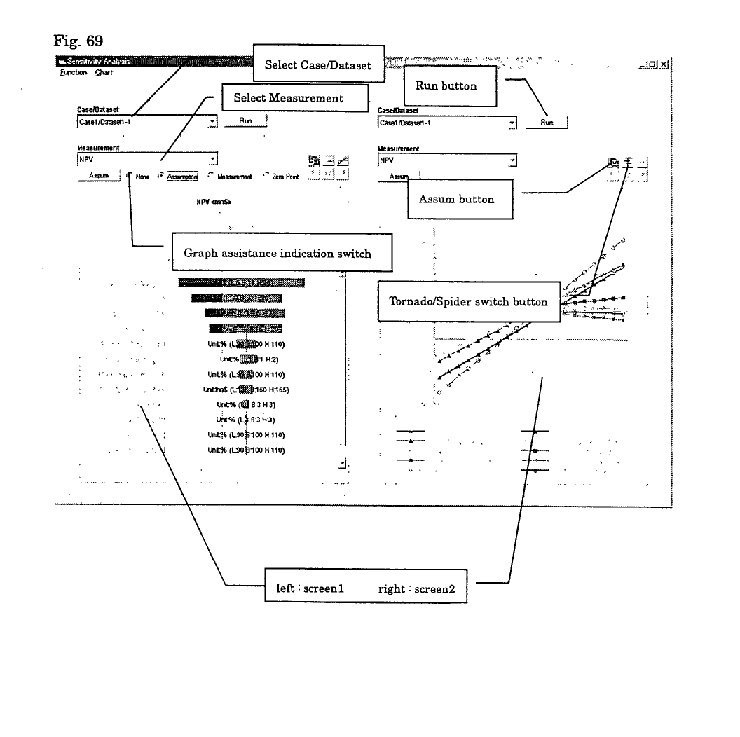

Refer to FIG. 69.

3. Usage of Sensitivity Analysis:

3.1 Basic Operation:

(1) Select the Case/Dataset in which to be analyzed from select Case/Dataset column.

(2) Select Run button.

(3) Select the Measurement in which to be analyzed from Run Parameter 1 screen (Measurement selected in the Cash Flow Model will be the only selection).

(4) Select the Assumption to be analyzed in FIG. 71 (Assumption selected in the Case Editor will be the only selection). Change the selected Assumption value from Low to High. Graph will indicate the influence (sensitivity) it has on the Measurement.

Measurement graph indication can be changed from the select Measurement column on FIG. 69.

3.2 Priority Function:

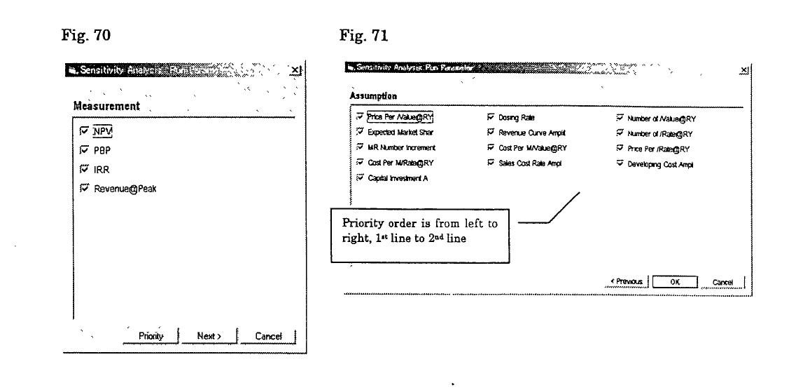

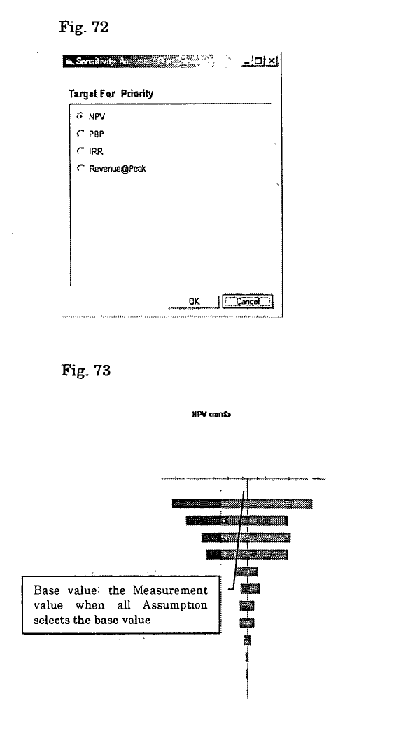

Select the “Priority” button in FIG. 70 to move to FIG. 72. Here, it will select which Assumption Priority should be distributed depending on the Measurement analysis results. The most highest Measurement Priority is selected when the setting is omitted.

What is an Assumption Priority: All Assumptions that are selected from the Sensitivity Analysis execution results, are ranked in order. High sensitivity Assumption has a higher Priority.

3.3 Graph Types:

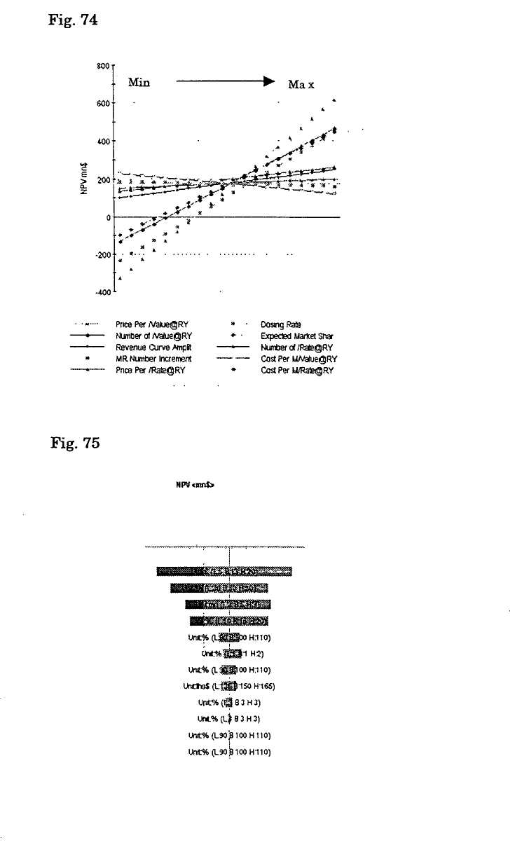

Sensitivity Analysis will indicate 2 types of charts (FIG. 73): Tornado Chart and Spider Chart (FIG. 74). This bar graph indicates the change in Measurement value when each Assumption Value vary from Low to High. Minus Measurement value is indicated in red. Assumption with longer width (high sensitivity to Measurement) is ranked from the top. Assumption value and Measurement value can be indicated by selecting the graph assistance switch.

This line graph indicates the change in Measurement when each Assumption value vary from Low to High. The slope size shows the sensitivity of each Assumption to the Measurement. It is possible to confirm how the Measurement changes (either linear/non-linear, or proportional/inversely proportional) when each Assumption varies. Number of points in the Spider Graph can be changed at the System Profile Maintenance, “Sensitivity Class” parameter.

3.4 Indication of Graph Assistance:

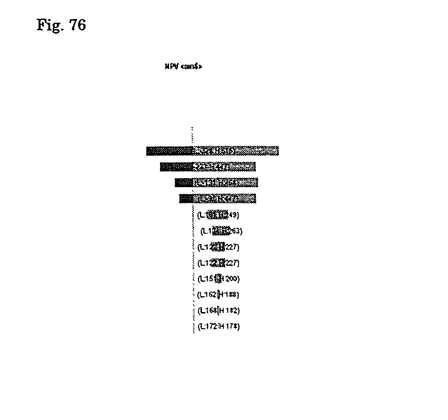

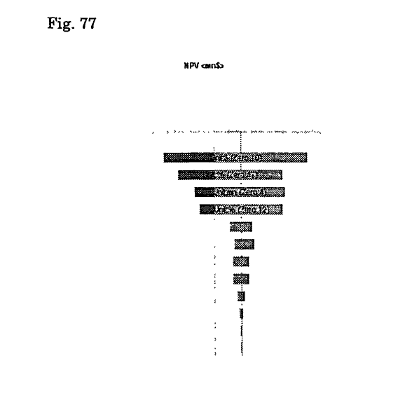

Indication of graph assistance can be switched from below: “None”, “Assumption” (refer to FIG. 75), “Measurement” (refer to FIG. 76), “Zero point” (refer to FIG. 77).

3.5 Indication of Assumption List:

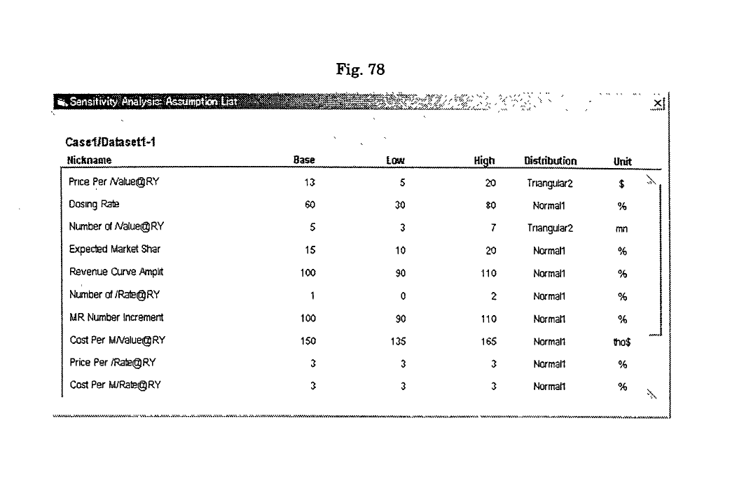

FIG. 78 will be indicated from the Assum button in FIG. 69. Base, Low, High value , Distribution Type and Unit regarding the Assumption (selected at the Case Editor) will, be indicated.

Contents of Probability Analysis will now be described.

1. What is Probability Analysis:

Probability Analysis a function which adopts the Monte Carlo Simulation. It will indicate the probability distribution on a graph, and the risk and success probability of a project. It creates a maximum of 10,000 combination of assumptions, and will calculate each cash flow. Using this result, it will indicate a graph of the probability distribution of a measurement value such as NPV and IRR.

2. Function Description:

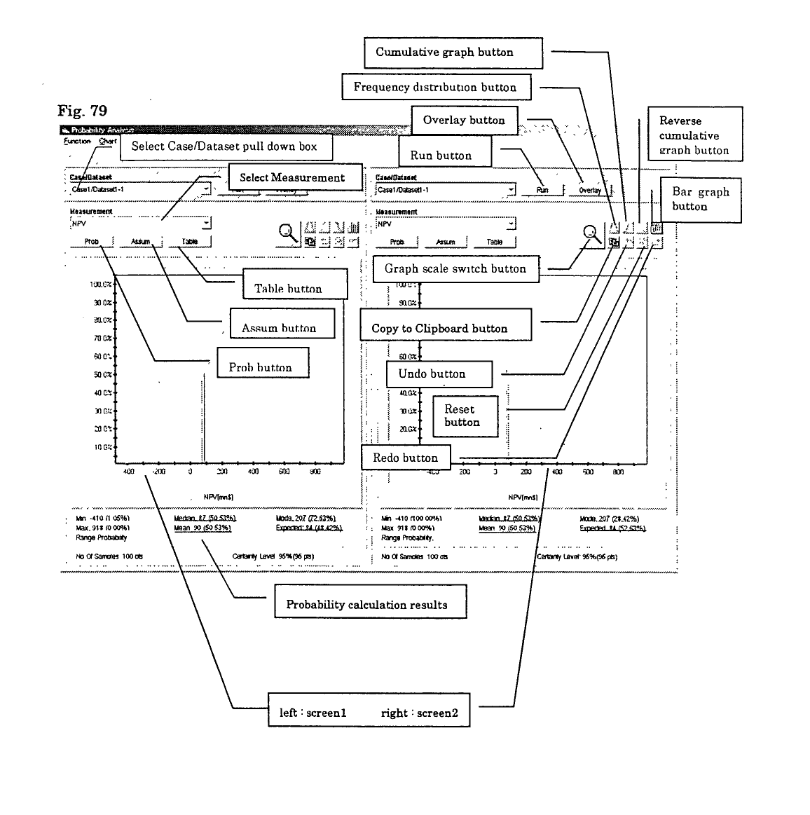

Refer to FIG. 79.

3. Usage of Probability Analysis:

3.1 Basic Operation:

(1) Select the Case/Dataset in which to be analyzed from the select Case/Dataset column.

(2) Select Run button.

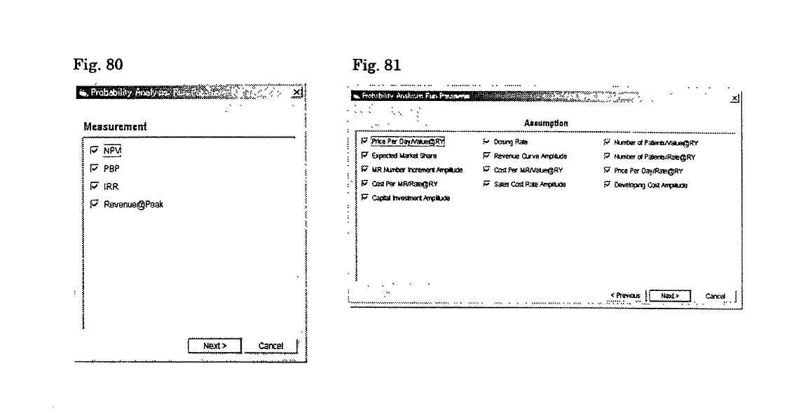

(3) Select Measurement in which to be analyzed from FIG. 80. Measurement selected in the Cash Flow Model will be the only selection.

(4) Select Assumption to be analyzed from FIG. 81. Assumption selected in the Case Editor will be the only selection). All selected Assumptions will be the object of the development of random numbers from the Monte Carlo Simulation.

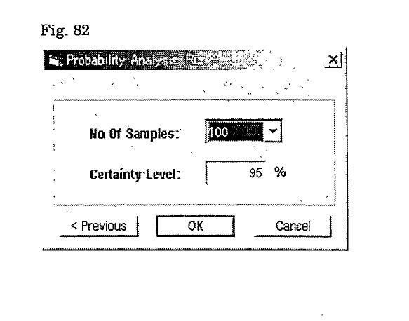

(5) Select No of Samples (50-10,000) and Certainty Level (0-100) from FIG. 82.

Certainty Level is a means to set an effective data range from the Monte Carlo Simulation data results. When the Certainty Level is set at 95%, analysis results will be indicated by the arranged Measurement value of the data results, excluding the Low to 2.5% and High to 2.5% value.

3.2 Indication of Graph Type:

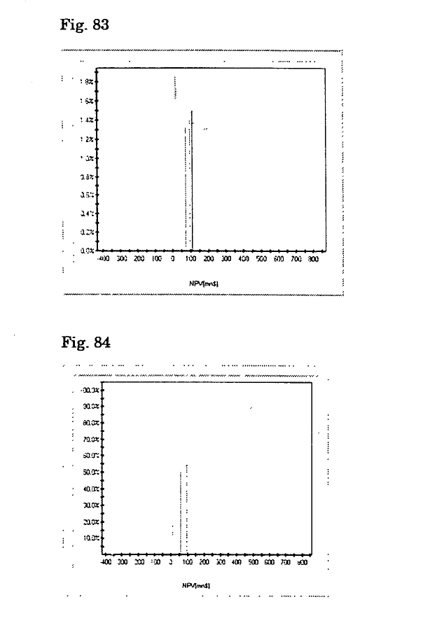

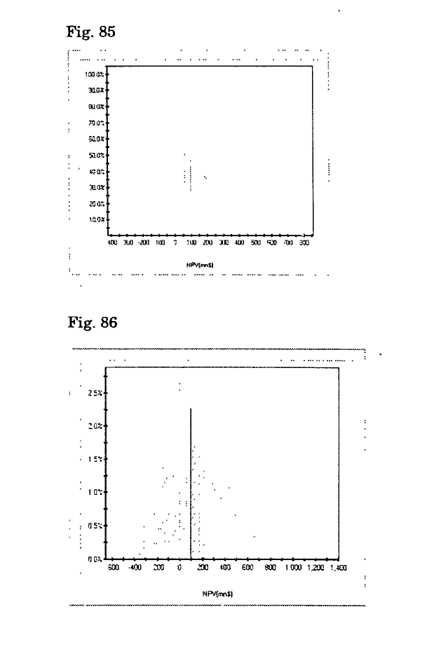

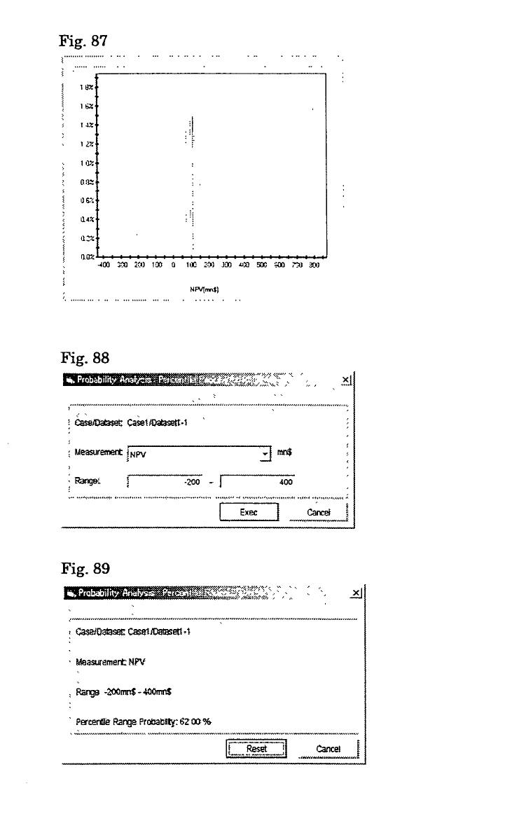

Switch to Non cumulative (refer to FIG. 83), Cumulative (refer to FIG. 84), Reverse cumulative (refer to FIG. 85), Histogram graphs (refer to FIG. 86) by using the buttons.

3.3 Calculation of Percentile Range Probability:

Percentile Range Probability will calculate the probability of the selected range of Measurement value. For Example, Percentile Range Probability between −200 to 400 in FIG. 83 is the square measure within that range. Below is the calculation order.

(1) Select Prob button in FIG. 79.

(2) Select Measurement, Range in FIG. 88. Select Exec button.

(3) Indicate results (FIG. 89).

3.4 Indication of Assumption List:

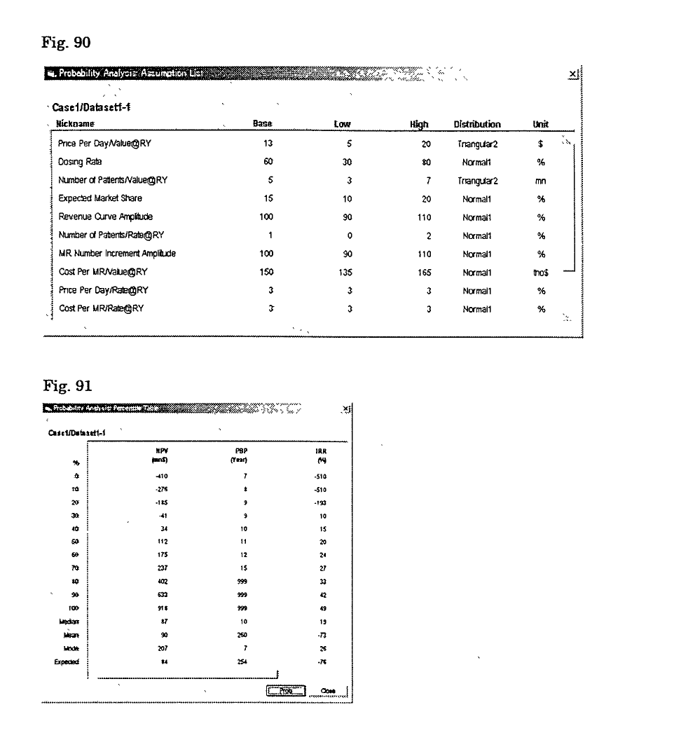

FIG. 90 will be indicated by the Assum button in FIG. 79. Base, Low, High value, Distribution and Unit (selected at the Case Editor) of the Assumption will be indicated.

3.5 Indication of Percentile Table:

Percentile Table will show the below criteria on a chart. Maximum 10% achievement ratio for each Measurement Value (respond to Cumulative graph). Median, Mean, Mode, Expected, for each Measurement. From the Table button in FIG. 79, the Percentile Table for all Measurement selected at FIG. 80 will be indicated.

3.6 Graph Range:

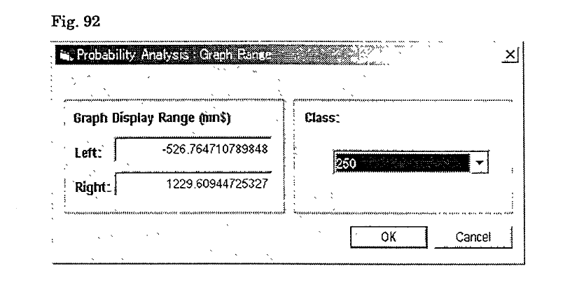

FIG. 92 will be indicated by the above graph scale switch button. Graph indication range and horizontal axis (Class) can be changed. To change the horizontal axis graduation, divide evenly by the Class that is within the selected Graph Display Range.

What is the Class: It is the number of graduation in an axis, and also the range when creating the frequency distribution chart. Graduation range of the axis will differ depending on the Class number. The less the number of Class, the larger the graduation becomes, thus a rough graph.

3.7 Indication of Overlay Chart:

Overlay Chart function will indicate a probability distribution graph for various Cases, and can compare the results. Yet, in order to use the Overlay Chart function, the Probability Analysis results for Case/Dataset should be saved, or the Probability Analysis should be inactivity.

(1) Select Overlay button in FIG. 79.

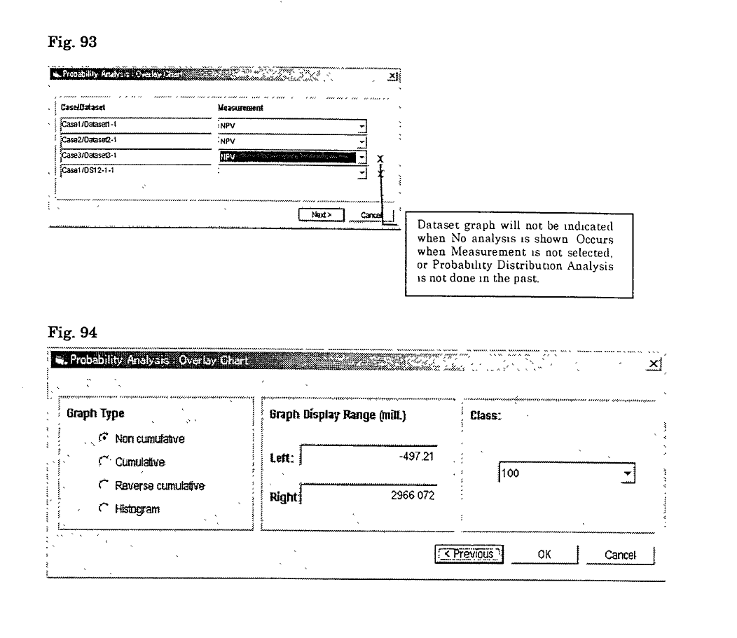

(2) Select measurement for each Dataset in FIG. 93.

(3) Select Graph Type, Graph Display Range, Class (10-500) in FIG. 94. Select OK button.

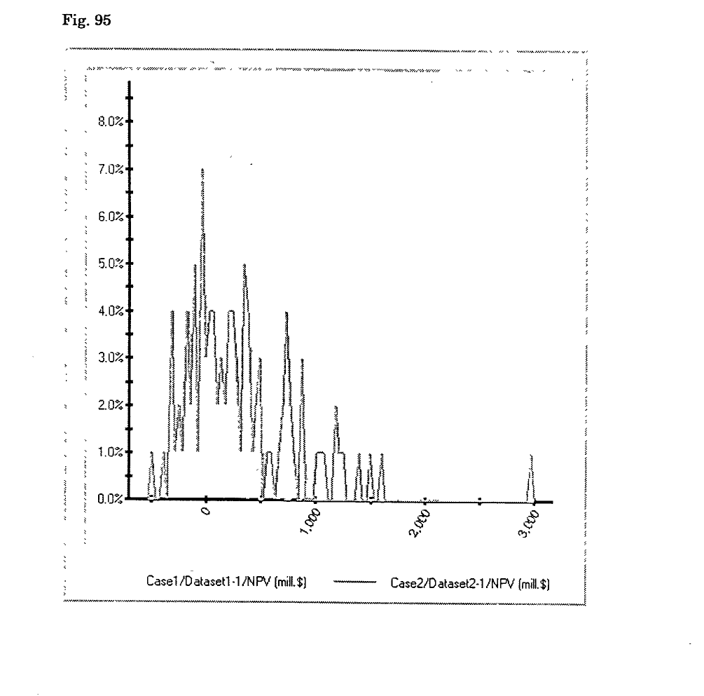

(4) FIG. 95 Indicate results.

Contents of What-If Analysis will now be described.

1. What is What-If Analysis:

What-If Analysis is a function to simulate how the Measurement Value changes when the Assumption Value (maximum of 10) modifies from the Low Value to the High Value. In the What-If Analysis, the combination of Assumption data can be saved as a Strategy substitution plan, and be used for comparative evaluation.

2. Function Description:

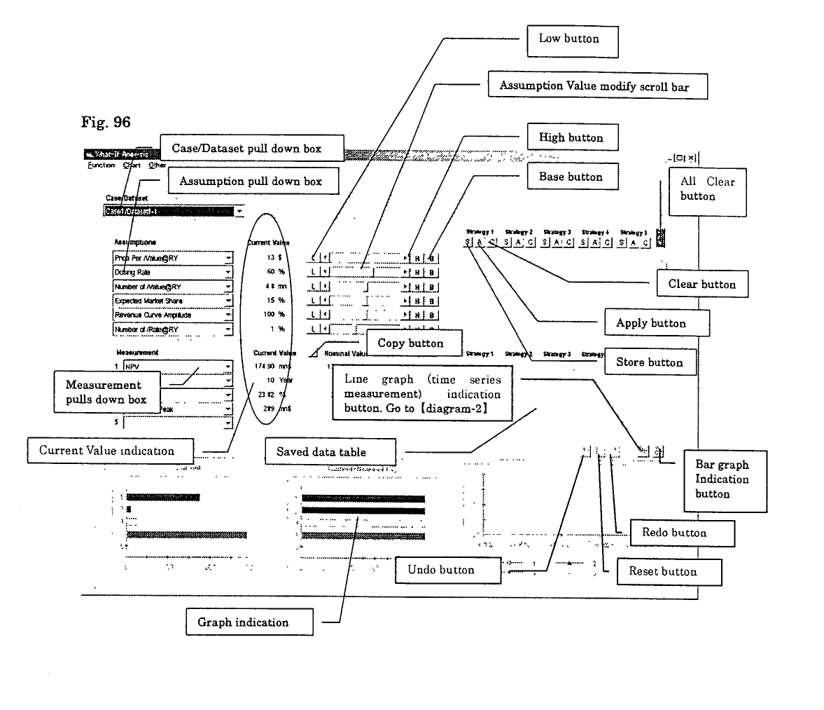

Refer to FIG. 96.

3. Usage of What-If Analysis Function:

3.1 Basic Operation:

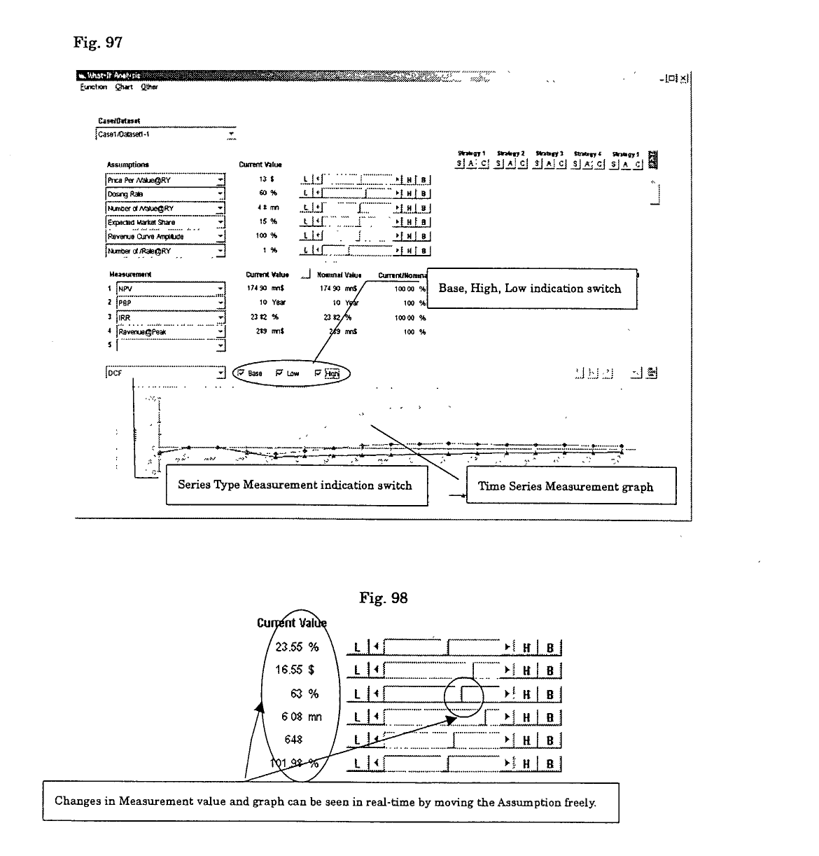

(1) Select Case/Dataset to be analyzed from Case/Dataset pull down box (Refer to FIG. 97). Then, the default analysis data will be indicated.

(2) Default analysis data will be indicated.

(3) When analyzing other than the default Measurement or Assumption, select from the pull down box in Measurement and Assumption.

(4) Start Analysis: Change the Assumption Value by using the Assumption Value Modify Scroll Bar (refer to FIG. 98), or the Low/High/Base button. The Measurement Value will be indicated in the Current Value box when Assumption is a Current Value.

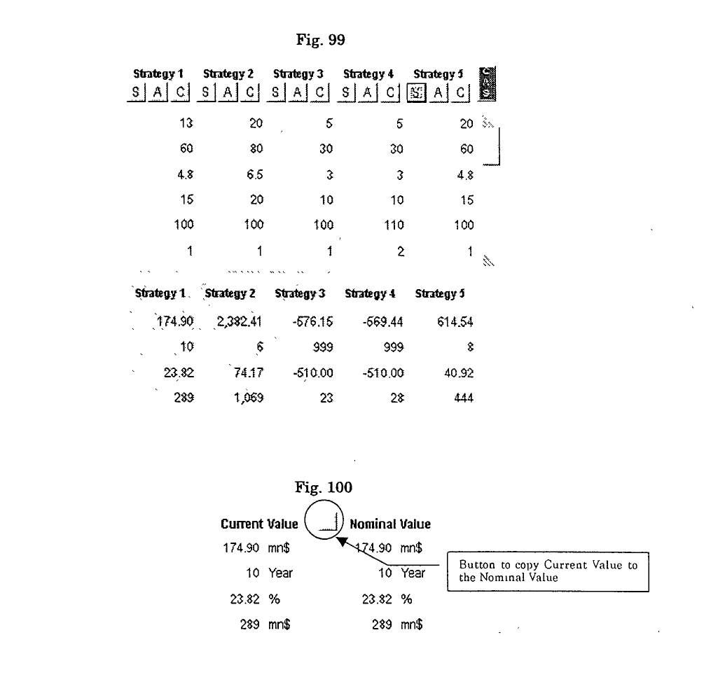

(5) Capture analysis result to Strategy (refer to FIG. 99): Capture the Current Value of Assumption and Measurement as a Strategy (maximum of 5).

“S”: (Store) Save the combination of Current Value of Assumption as a Strategy.

“A”: (Apply) Use the Value captured as a Strategy for the Current Value Analysis.

“C”: (Clear) Clear the Values captured as a Strategy.

“CAS”: Clear all Strategy.

What is Indication of Default Analysis Data: In the Default Analysis Data, Measurement value will be indicated when the Assumption for the selected Case/ Dataset has the Base value. Measurement and Assumption which is selected in the Default Analysis Data will be the following.

Measurement:

Measurement Priority selected at the Modeler will be indicated in order from the larger value (maximum of 5).

Assumption:

In the case of Case/Dataset which Sensitivity Analysis is done beforehand, the Assumption Priority will be indicated in order from the larger value (maximum of 10).

What is Current Value, Nominal Value:

Following is the description of Current Value and Nominal Value.

Current Value:

Measurement Value which correspond to the Assumption Value in the present time. Current Value will change by moving the Assumption Value Modify Scroll bar.

Nominal Value:

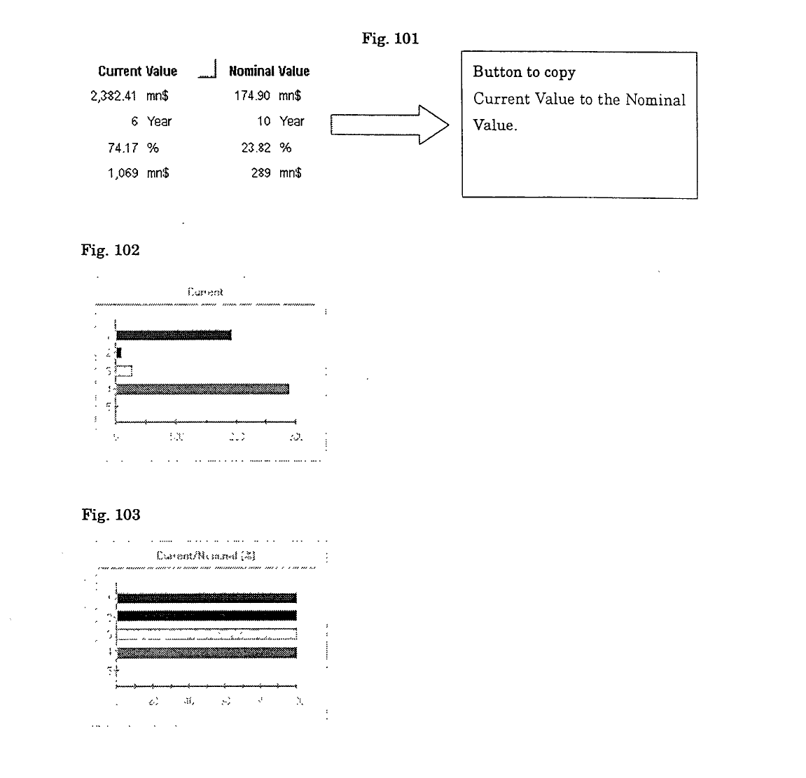

At the starting point of What-If Analysis, Measurement Value using the Assumption Base Value will become the Nominal Value, and will compare against the changing Current Value (refer to FIG. 100). Copy the Nominal Value to the Current Value to be changed, and select the (Copy)button. Then, that value will be saved as the Nominal Value (refer to FIG. 101).

What is Current/Nominal: Current/Nominal is calculated by dividing the changing Current Value by Nominal Value when the Assumption fluctuates. Thus, the fluctuation rate from the Nominal Value can be examined.

3.2 Description of Graph Indication:

The graph on FIG. 102 will indicate the Current Value of a Measurement by each Measurement in a bar graph. It will also compare the size of the Current Value of a Measurement in real-time.

Vertical axis: Measurement Number,

Horizontal axis: Measurement Value.

The graph on FIG. 103 will indicate the fluctuation rate of a Current Value seen from the Nominal Value on Measurement in a bar graph. Changes in fluctuation rate of Current Value from the Measurement of Nominal Value can be seen during the analysis.

Vertical axis: Measurement Number,

Horizontal axis: percentage (%).

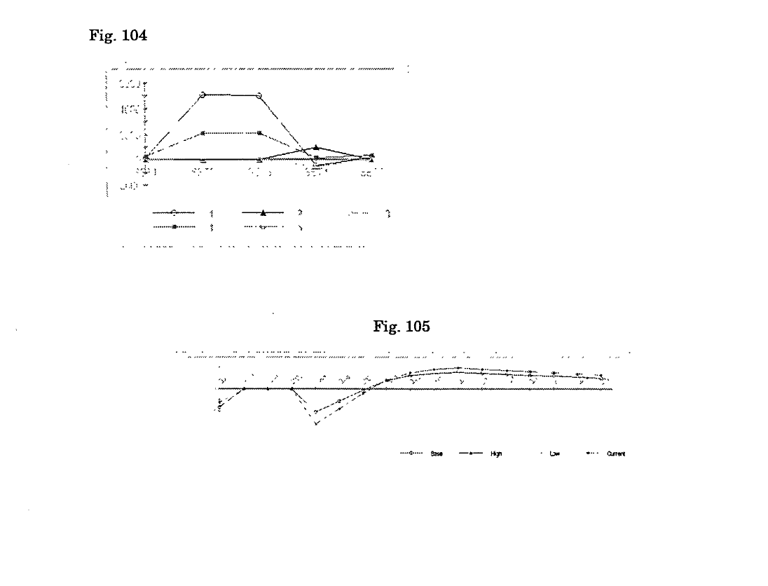

The graph on FIG. 104 will indicate the movement and size of a Measurement in Strategy1 to Strategy5. Measurement movement and size for every Strategy can be compared.

Vertical axis: Measurement value,

Horizontal axis: Strategy Number.

The graph on FIG. 105 will indicate the Current Value for the selected Series Type of Measurement in a line graph. Line graph for Base/High/Low can also be indicated. Fluctuation of Current Value can be seen in real-time when Assumption is changed during the Analysis.

Horizontal axis: Measurement (Series Type) Value,

Vertical axis: Time Series (Absolute Year).

Contents of Real Option Analysis will now be described.

1. What is Real Option Analysis:

Real Option Analysis will calculate the business value by considering the uncertainty of the future. Taking the value of the Cash Flow Analysis and Probability Analysis results as a reference, calculate the Option Value by selecting 5 Option Calculation Parameters and 2 Types of Option Calculation Engine. It will carry the Black-Sholes calculation Model and the Binominal Calculation Model s as an Option Calculation Engine.

2. Function Description:

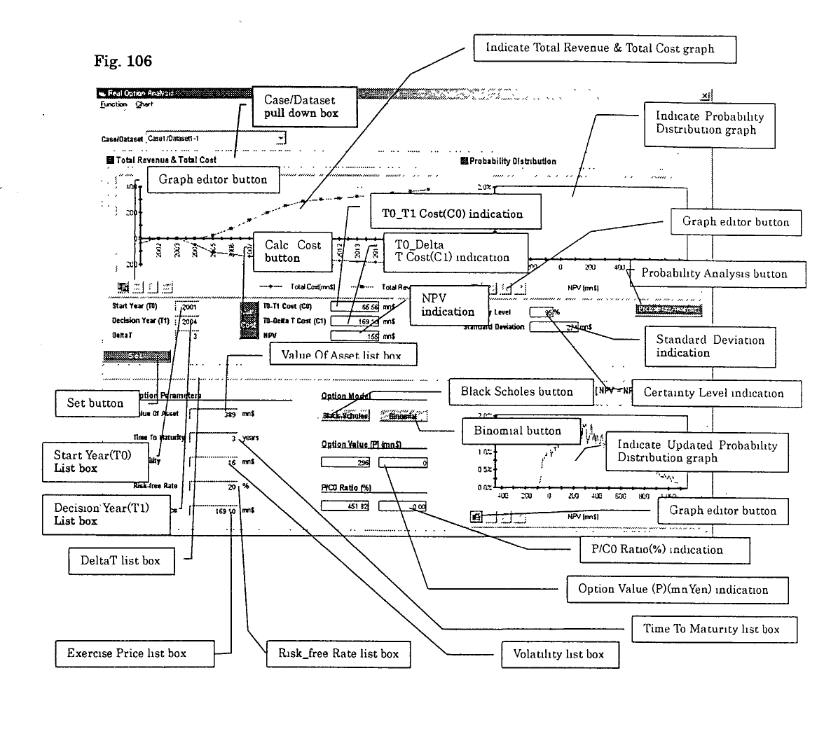

Refer to FIG. 106

What is an Option Value: Value acquired by reserving the decision making of the future investment (investment between Decision Year to T year). Investment will be judged as profitable if the necessary investment amount (CO) at the present time (Start Year) is lower than the Option Value.

3. Usage of Real Option Analysis:

Real Option Analysis will be practiced from the following steps. 1) Calculation of NPV and investment amount, 2) Calculation of Standard Deviation (Probability Analysis), 3) Calculation of Option Value. Probability Analysis can be omitted.

3.1 Calculation of NPV and Investment Amount:

(1) Select Case/Dataset.

(2) Input Start Year (T0), Decision Year (T1) and DeltaT.

(3) T0 T1 Cost, T1 DeltaT Cost, NPV will be calculated when selecting Calc Cost 1button.

Start Year (T0): Year of the Option Value calculation. Option Value will be calculated for this period.

Decision Year (T1): Year when the future investment start.

DeltaT: Investment period when the future investment continues for a couple of years. (select number over 1).

T0−>T1 Cost (C0): Total amount of the Cost from T0 to T1.

T1−>T1+DeltaT Cost (C1): Total amount of Cost from T1 to T1+DeltaT−1.

NPV: NPV Cash Flow at TO point.

Words inside the ( ) is an abbreviation.

3.2 Calculation of Standard Deviation (Probability Analysis):

(1) Select Probability Analysis button.

(2) Select Assumption that will be an object for the Probability Analysis.

(3) Select No. of Sample (50-10,000) and the Certainty Level (0-100).

(4) Probability Analysis will start by selecting the OK button. Probability Distribution Graph, Certainty Level and Standard Deviation will be calculated.

3.3 Option Valuation:

Option Parameters will be set by the Select Set button. Starting value will be calculated by the formula below.

Value Of Asset: NPV+C0+C1

Time To Maturity: T1-T0

Volatility: Standard Deviation/Project Term (year)

Exercise Price: C1

(1) Select Risk-free Rate in the 0-100(%) range.

(2) Modify the Value Of Asset, Time To Maturity, Volatility and Exercise Price, from the starting value if necessary. (Time to Maturity and Exercise Price needs to be a positive number)

(3) Select Black-Scholes or the Binominal button. Option will be calculated, and the Option Value, Option Value/C0 Ratio will be figured out. Updated Probability Distribution Graph will be indicated simultaneously with the Black-Scholes in red, and Bionominal in green.

Contents of Case Data Analysis will now be described. There are 3 Analysis Types in the Case Data Analysis.

A: Case/Data Matrix,

B: Series Data,

C: Case.

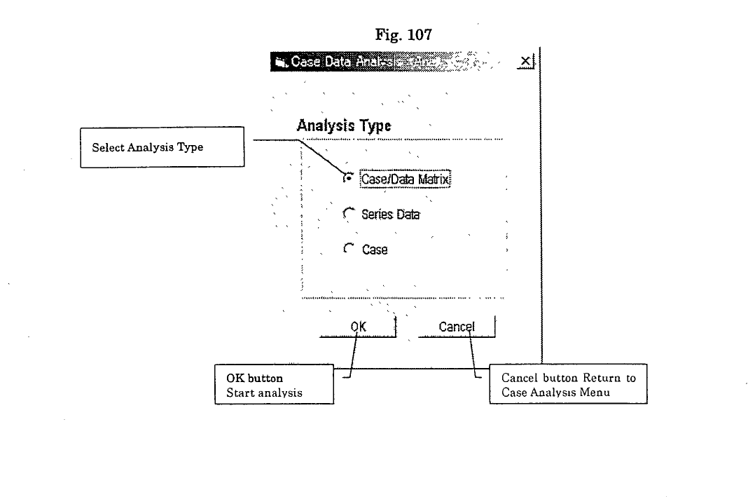

Select Analysis Type (refer to FIG. 107) when starting the Case/Dataset Analysis.

A. Case Data Analysis (Case/Data Matrix):

A.1. What is an Analysis Type-Case/Data Matrix:

Analysis Type: Case/Data Matrix is a function to indicate the comparative data regarding the Item (maximum of 5) selected for each Case/Datasets. (maximum of 5, selected at the Working Case Loader).

A.2. Function Description:

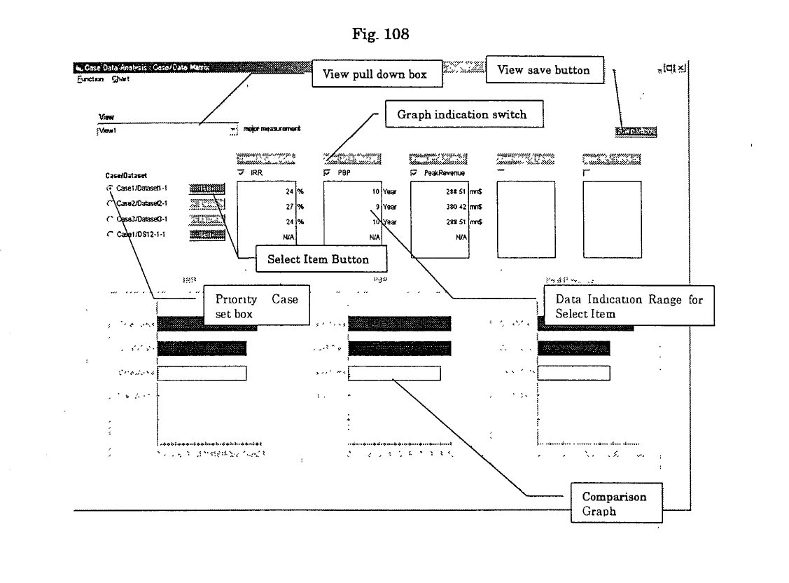

Refer to FIG. 108.

A.3. Usage of Analysis Type-Case/Data Matrix:

A.3.1 Basic Operation:

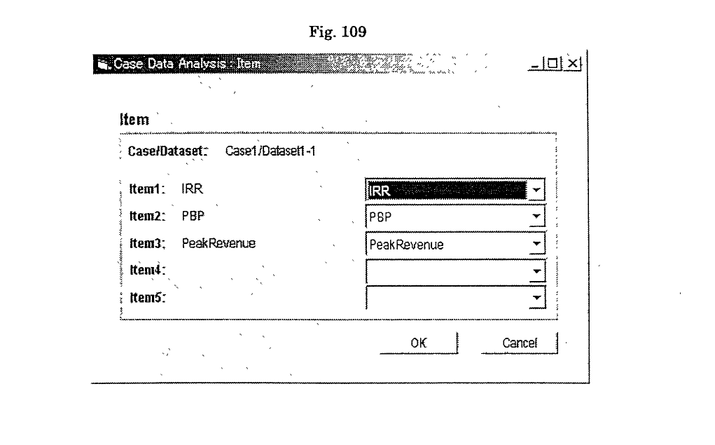

(1) Select the [Item] button in the Case/Dataset. Select the Item (Scalar Type Data, maximum of 5) to be viewed individually (refer to FIG. 109).

(2) Select the Item to be indicated as a graph (simultaneous indication is maximum of 3) at the Graph switch box.

Item button can be used for a Case which uses a Profit Tree that differs from the priority Case.

What is a Priority Case: From the Priority Case, Profit Tree, which will be the base when selecting an Item will be decided. Item nickname selected at the Priority Case will be indicated as an Item title. Furthermore, Case which uses the same Profit Tree as the Priority Case will automatically be indicated by that value. On the other hand, data will only be indicated by selecting the Item button when Case uses a different Profit Tree from the Priority Case.

A.3.2 Save View:

It is possible to save the Item combination as a View (maximum of 3). Select save view button, and set View No. and comment, and save.

A.3.3 Opening View:

Case data which uses the same Profit Tree from the Priority Case, will be indicated when selecting View No. at Select View for reference), in order to open the saved Item combination. (Item selection will be necessary for Case/Dataset which uses a different Profit Tree from the Priority Case).

A.3.4 Description of Graph Indication:

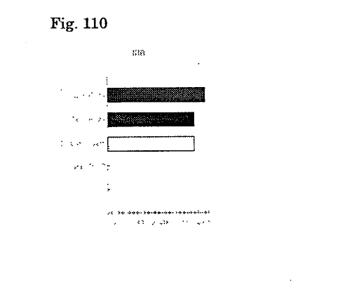

The graph on FIG. 110 will indicate the data for one Item between various Case/Dataset (maximum of 5). Graph will be indicated in the order checked at the Graph indication switch, and from the right hand side. Simultaneous indication possible up to 3 graphs. Vertical axis: Case/Dataset Name Horizontal axis: Value of Item (Scalar Data) When there is multiple selection of Case/Dataset in the Graph indication switch, the largest data value will be indicate from the top.

B. Case Data Analysis: Series Data:

B.1. What is an Analysis Type-Series Data:

Analysis Type:

Series Data is a function to indicate the comparative data regarding one selected Item of Series data to be listed for the various Case/Dataset (maximum of 5).

B.2 Function Description:

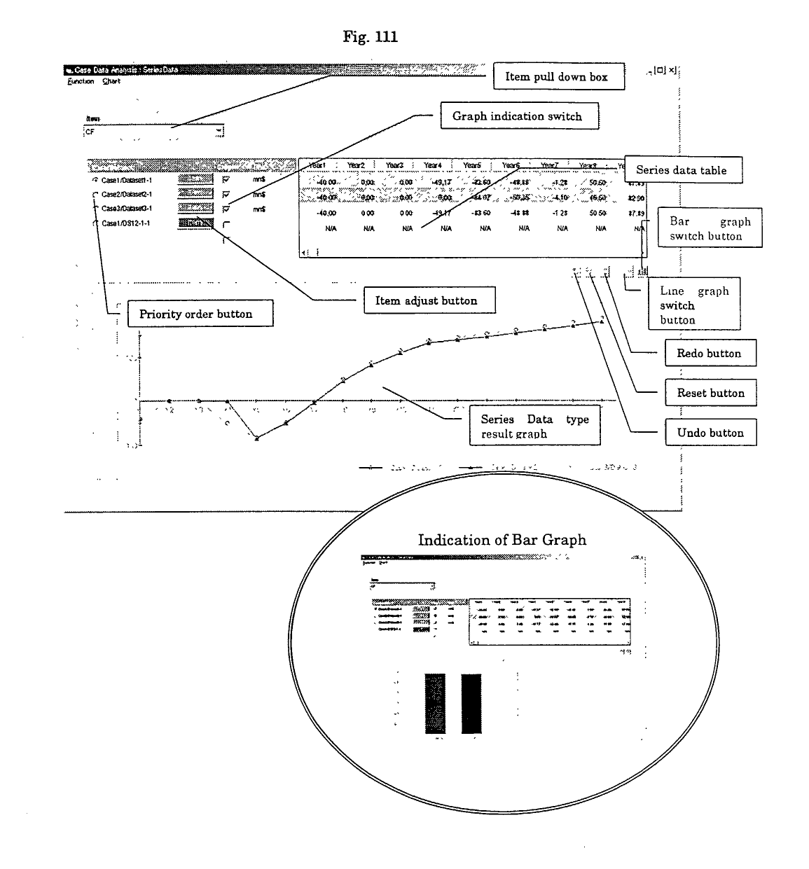

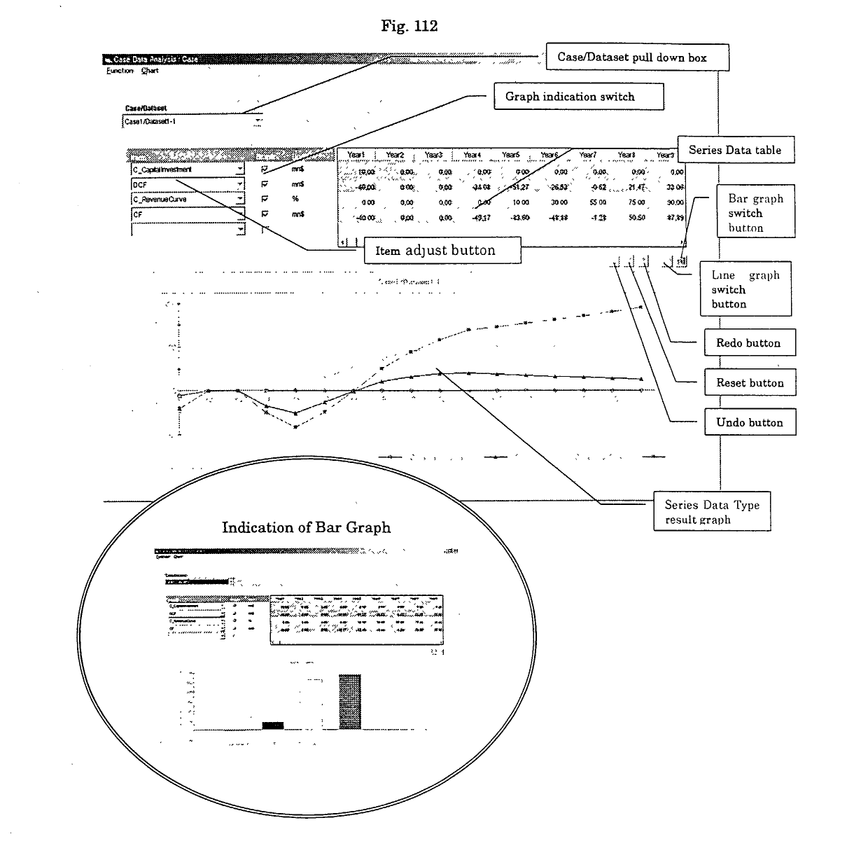

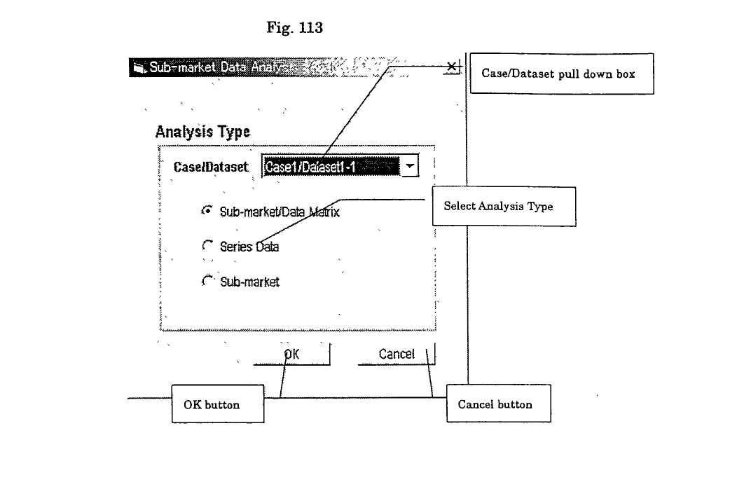

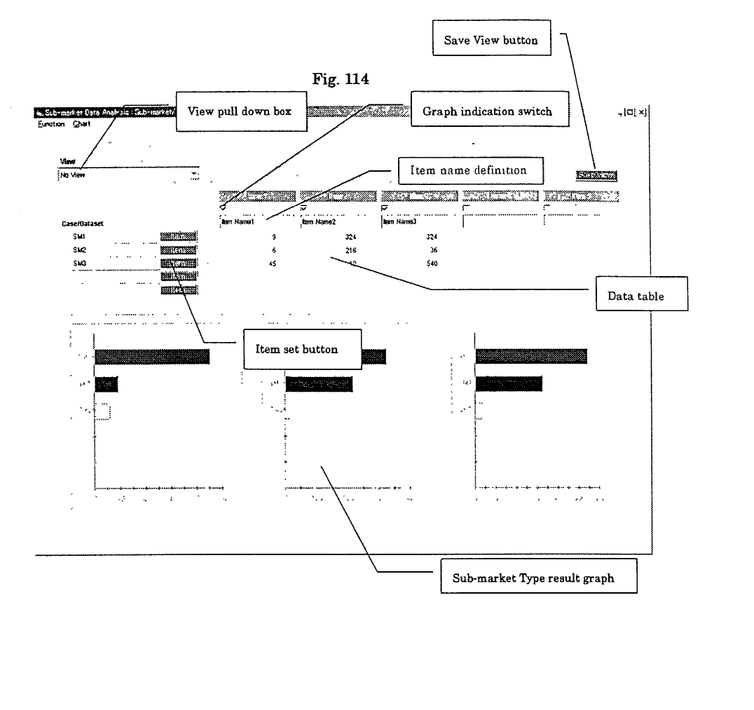

Refer to FIG. 111.

B.3 Usage of Analysis Type-Series Data:

B.3.1 Basic Operation:

(1) Select Item from the Item pull down box. Here, the Item Nickname of a Profit Tree used in the Priority Case will be indicated as a list in the list box. (See “Usage of A-3. Analysis Type-Case/Data Matrix” description page for Priority Case).

(2) Select the [Item] button for each Case/Dataset and set the Item to be listed for each Case/Dataset. Item button can only be used for a Case that uses a different Profit Tree from the Priority Case.

(3) Select the Graph switch for the Case/Dataset to be indicated as a graph. It will indicate the Series Type data for every Case/Dataset on a line graph. It will show the fluctuation of the Series Type data for every Case/Dataset.

Vertical axis: Value of Series Type data,

Horizontal axis: Relative Year.

It will indicate the total value of the Series Type data for every Case/Dataset on a Bar graph. It will compare the total value of the Series Type data for each Case/Dataset.

Vertical axis: Total value of Series Type data,

Horizontal axis: Case/Dataset Name.

C. Case Data Analysis: Case:

C.1. What is an Analysis Type-Case:

Analysis Type:

Case is a function to indicate the data regarding the selected Item (maximum of 5) to be listed. It will be chosen from the Item (Series Type) which the selected Case/Dataset possess.

C.2. Function Description:

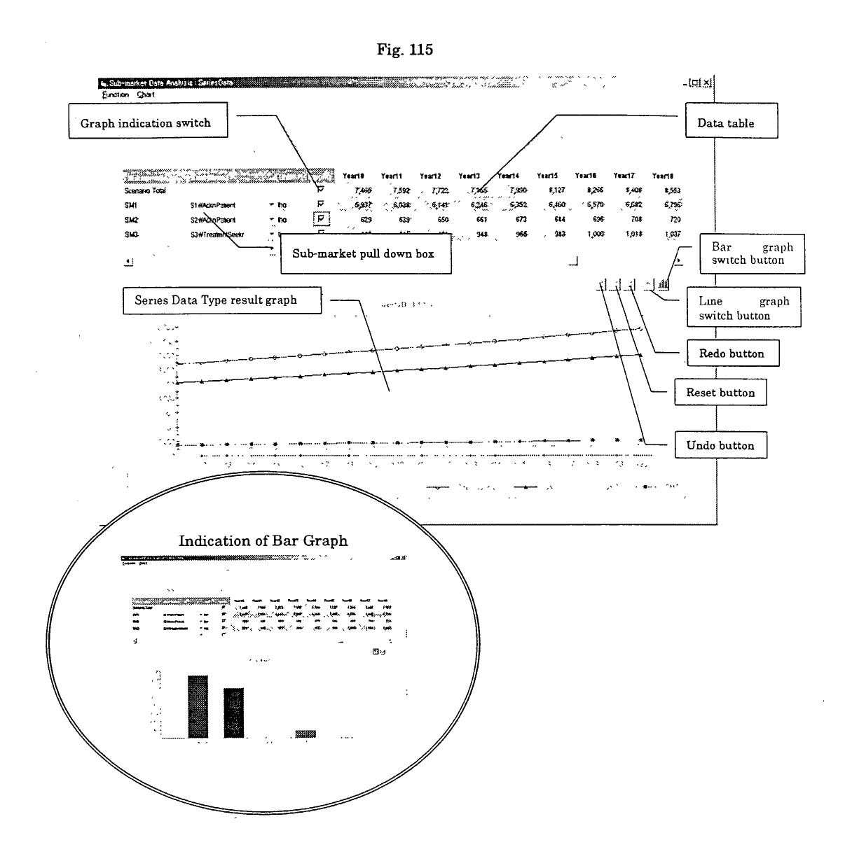

Refer to FIG. 112.

C.3. Usage of Analysis Type-Case:

C.3.1 Basic Operation:

(1) Select Case/Dataset from the Case/Dataset pull down box.

(2) Select the Item to be listed from the Select Item list.

(3) Select the Graph switch for the Item to be indicated as a graph.

It will indicate the Series Type data within a Case/Dataset for every Item in a Line graph. It will show the fluctuation of the Series Type data for every Item.

Vertical axis: Value of Series Type data,

Horizontal axis: Relative Year.

It will indicate the Series Type data within a Case/Dataset for every Item in a bar graph. It will show the total value of the Series Type data for each Item.

Vertical axis: Total value of Series Type data,

Horizontal axis: Case/Dataset Name.

Contents of Sub-market Data Analysis will now be described. There are 3 Analysis Types in the Sub-market Analysis.

A. Sub-market/Dataset Matrix,

B. Series Data,

C. Sub-market.

Since functions differ by Analysis Type, description of each Analysis Type will be explained. When starting the Sub-market Analysis, a screen to select Analysis Type will be indicated (refer to FIG. 113). “Sub-market is nothing!” error message will be indicated when Sub-market does not exist. Sub-market definition can be set at Select Item “ID”. Regarding Sub-market, it can be set at the Item Property in Modeler. See Modeler description page for selecting method.

Sub-market is a market that is subdivided by area and patient (adult/child, serious illness/mild illness, tablet type). By taking one market as a various sub-market, and use a different assumption value for market size, dosage amount and market share for each sub-markets, it will be possible to estimate the accurate market size.

A. Analysis Type (Sub-market/Data Matrix):

A.1. What is an Analysis Type (Sub-market/Data Matrix):

Analysis Type:

Sub-market/Data Analysis is a function to indicate a Scalar Type data into a matrix regarding the selected Item (maximum of 5) for each Sub-market/Dataset (maximum of 5) to be listed and compared.

A.2 Function Description:

Refer to FIG. 114.

A.3. Usage of Analysis Type (Sub-market/Data Matrix):

A.3.1 Basic Operation:

(1) Input Item Name to be listed in the Item Name Definition list box.

(2) Select the [Item] button on each of the Sub-market. (SM) Select the Item (Maximum of 5) for each Sub-market.

(3) Select the data to be indicated as a graph (simultaneous indication up to 3).

(4) In order to save, select [View] button and define. It will indicate the Scalar Type data for one Item between various Sub-market. Graph will be indicated in the order checked at the Graph indication switch, and from the right hand side of FIG. 114. Simultaneous indication possible up to 3 graphs.

Vertical axis: Case/Dataset Name,

Horizontal axis: Value of Item (Scalar data).

B. Analysis-Type (Series Data):

B.1. What is an Analysis-Type (Series Data):

Analysis Type:

Series Data is a function to indicate the Series data regarding a selected Item to be listed for the various Sub-market.

B.2 Function Description:

Refer to FIG. 115.

B.3 Usage of Analysis Type: Series Data

B.3.1 Basic Operation:

(1) Select the “Item” button on each of the Sub-market. Select the Series Item (Series Type) to be listed for each Case/Dataset.

(2) Select the Series data to be indicate as a graph at the Graph switch.

It will indicate the Series Type data for each Case/Dataset in a Line graph. It will show the fluctuation of the Series Type data for every Case/Dataset.

Vertical axis: Value of Series Type data,

Horizontal axis: Relative Year.

It will indicate the total value of the Series Type data for each Sub-market in a Bar graph. It will compare the total value of Series Type data for each Sub-market.

Vertical axis: Total value of Series Type data,

Horizontal axis: Sub-market Name.

C. Analysis Type: Sub-market:

C.1. What is an Analysis Type (Sub-market):

Analysis Type:

Sub-market is a function to indicate the data regarding the selected Item to be listed and compared (maximum of 5). It will be chosen from the Item (Series Type) which the selected Sub-market possess.

C.2. Function Description:

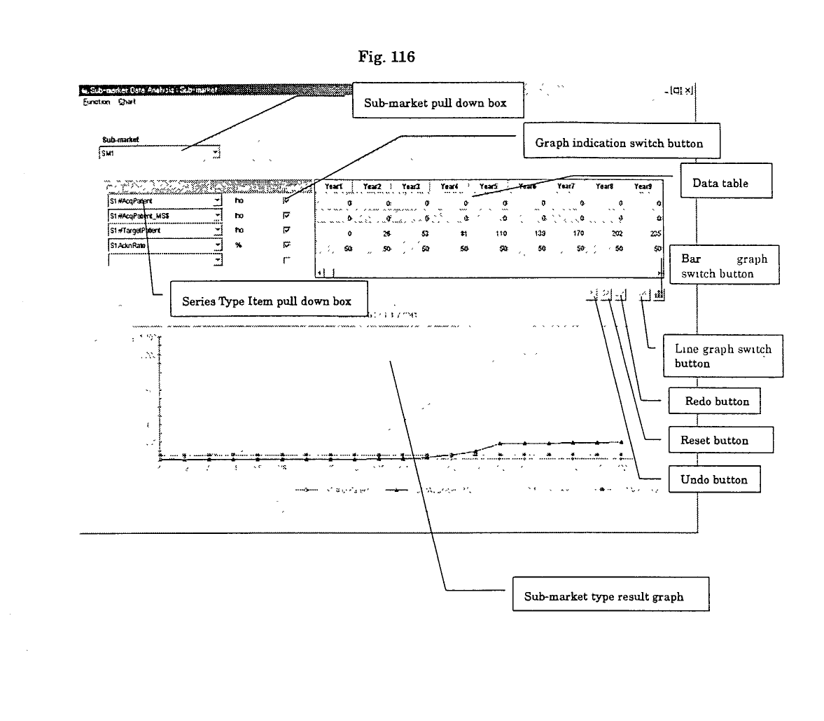

Refer to FIG. 116.

C.3. Usage of Analysis Type: Sub-market

C.3.1 Basic Operation:

(1) Select the Sub-market to be listed from the Sub-market pull down box. Select Sub-market from the Sub-market pull down box.

(2) Select the Item (maximum of 5) which has the Series data to be listed from the Item bull down box.

(3) Select the Graph switch for the Series data to be indicated as a graph.

A line graph (Sub-market) will indicate the Series Type data within the Sub-market for every Item in a Line graph. It will show the fluctuation of the Series Type data for every Item.

Vertical axis: value of Series Type data,

Horizontal axis: Relative Year.

A bar graph (Sub-market) will indicate the Series Type data within the Sub-market for every Item in a Bar graph. It will show the total value of the Series Type data for each Item.

Vertical axis: total value of Series Type data,

Horizontal axis: Sub-market Name.

Contents of Project Valuation will now be described. By using the Profit Tree, the Project Valuation will calculate the Payoff Value of the overall Project based on the Payoff Value of a Case which is included in the Project. Here, the Project Valuation will be practiced from the following 3 steps.

(1) Create Project Tree.

(2) Select Payoff Value.

(3) Start Calculation.

To calculate the Payoff Value of the overall Project by using the Decision Tree method. Project will have various Decision Points during the process of the practice, and for each Decision Point, the course of the Project will diverge into various Scenario. The final result (Case, final point of each divergence) for each Scenario will have their own Payoff Value. The Project Tree will graphically express this, and will have various Decision Point, Scenario Node and Case Node. By selecting the Chance Rate for each Decision Point of a Profit Tree, and setting the Payoff Value for each Case Node, the Payoff Value of the overall Project will be calculated.

1. Function Description:

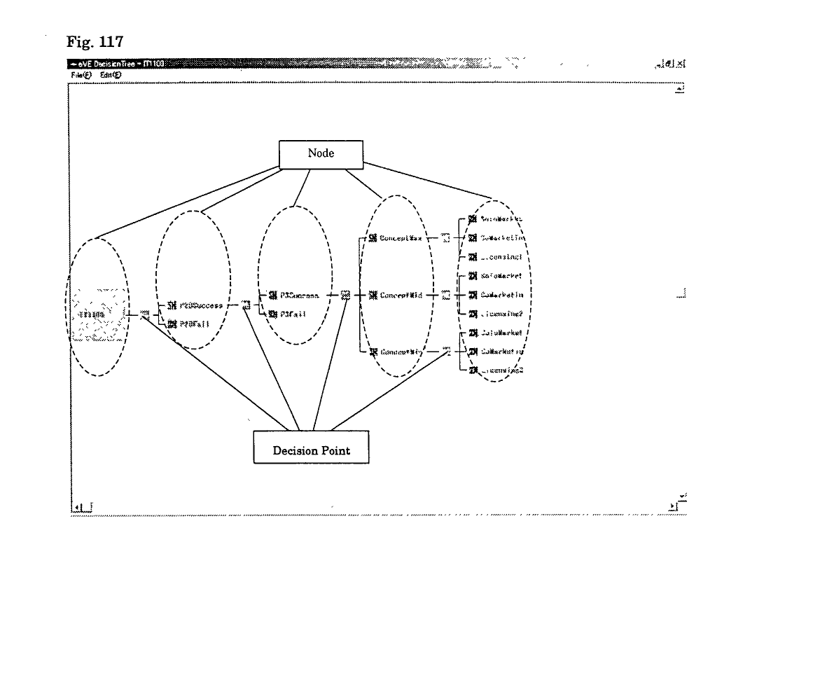

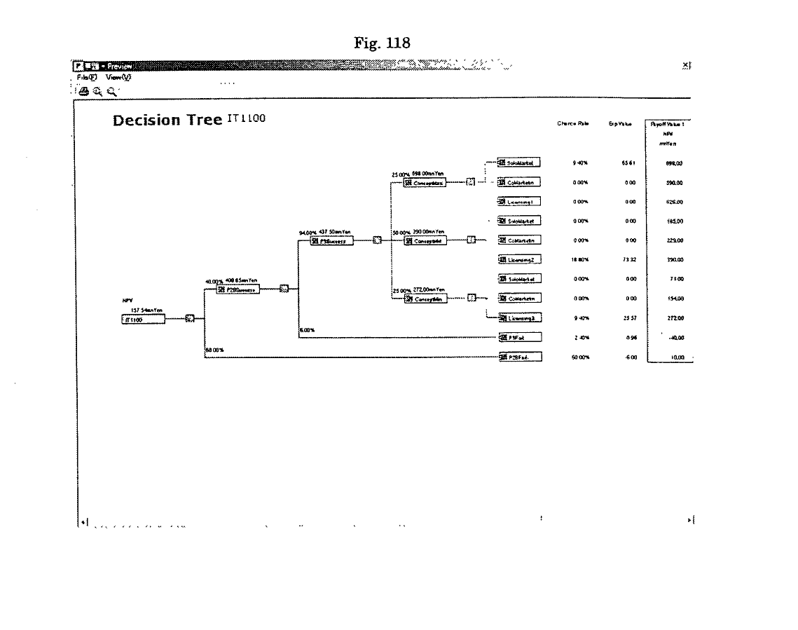

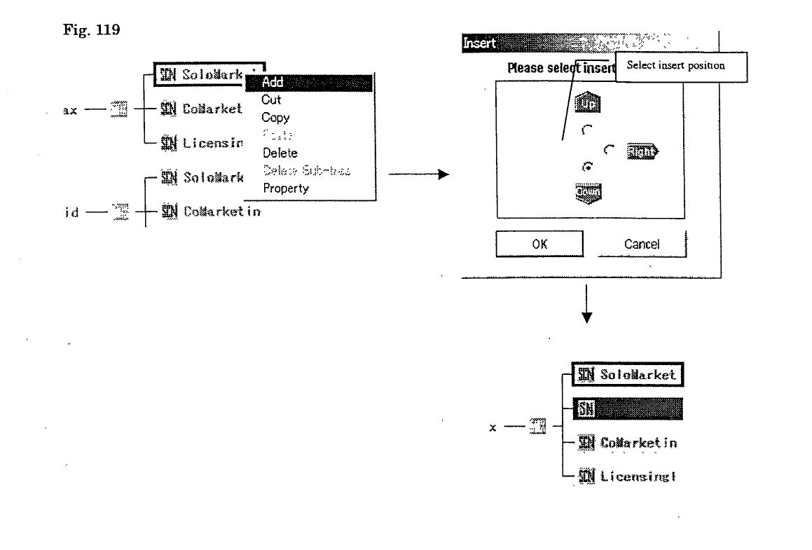

Refer to FIG. 117. Project Tree is constructed from 2 factors: Node and Decision Point.

2.1 What is a Node:

Below are the 3 Node Types.

(1) Root Node:

It is the head of a Project Tree and only one will exist in a Tree. It will be created by a default when the Tree is newly created, and cannot be deleted. Root Node name will be the Project Tree name.

(2) Scenario Node:

Node that will have a child (Decision Point+Scenario or Case Node). This itself does not have the Payoff Value, but the output from a child will automatically be the Payoff Value.

(3) Case Node:

Does not hold a child. Node that will be the endpoint of each divergence of a Project Tree. Payoff Value will be selected for this itself.

Case Node will further be divided into 2 Types.

a. Static Case Node: Payoff Value will be selected manually.

b. Dynamic Case Node: Case (and Dataset) will be assigned as a Property information. The Measurement Value (calculation result based on each Assumption Base) of an assigned Case and the analysis result will be referred to the Payoff Value.

2.2 What is a Decision Point:

Will hold 2 or more Node (Scenario Node or Case Node) for a child. By using the Payoff Value of the child Node directly under, start the calculation and selection which correspond to the Decision Point of oneself, and output the result to the adult Node. Below are the 4 Types of the Decision Point.

a. CHA-Exp: Chance Decision Point:

Select the Chance Rate for each child Node. Calculate the expected Value from the total multiplied by the Payoff Value of a child Node and it's each Chance Rate, then output that to the adult Node.

b. SEL-Max: Max Decision Point:

Test the Payoff Value of the child Node and select the Node which has the maximum value. Output the selected Payoff Value of the Node to the adult Node.

c. SEL-Min: Minimum Value (Min DP):

Test the Payoff Value of the child Node and select the Node which has the minimum value. Output the selected Payoff Value of the Node to the adult Node.

d. SEL-Man: Select Manual (Manual DP):

Select the child Node which is optionally chosen by the user. Output the Payoff Value of the selected Node to the adult Node.

2.3 What is a Payoff Value:

A Payoff Value which each Node holds. Each Node can hold 5 numerical value as a Payoff Value. Regarding the Case Node, the value selected manually (in the case of Static Case Node), or the assigned Case Data and the value copied from the analysis result (in the case of Static Case Node) will be the Payoff Value. In the case of Scenario Node, the output of a Decision Point right under you will become the Payoff Value.

3. Usage of Project Valuation:

3.1. Start:

Select the Project Valuation button from the Main Menu.

3.2. Opening the Existing Project Tree (the Tree) and Create New:

Open the exiting Tree.

(1) Select the File from the Menu. Select Open. Open Tree Screen will appear.

(2) Select Tree, and press the OK button.

When creating New, select New from the Menu.

3.3. Edit:

Project Tree editing can be done by the Edit Menu in the Menu Bar, or from the pop up menu. (Indicated by the right click when selecting a Node or the Decision Point.) Edit 1 (Add Node (refer to FIG. 119)):

(1) Select the Node on a Tree where the Node needs to be added, or the Decision Point, and right click (upper Diagram).

(2) Select Add from the pop up menu.

(3) Select the insert position in the Insert Dialog (when the object of the Add operation is a Node) (upper right Diagram).

Up: Node will be added above the object Node for Add operation.

Right: Decision Point or the Node will be added at the right hand side (lower layer) of the object Node for Add operation. (Not possible to add to the right hand side when Node Type is a Data.)

Down: Node will be added below of the object Node for Add operation.

(4) Node will be added as a blank Node. (Upper Diagram).

(5) Select Property from the pop up menu.

(6) Select the Node Type, Node Name from the Property Select Dialog. (See Edit 6 for Select Property.)

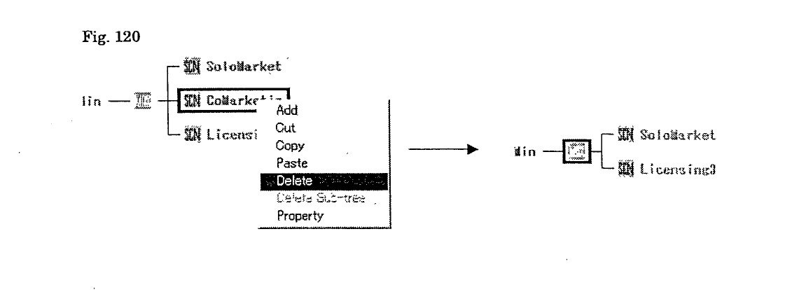

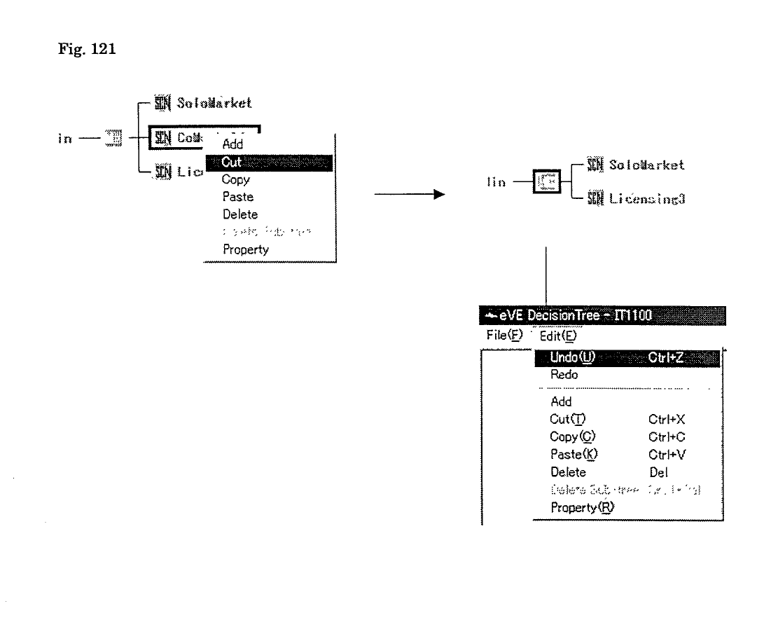

Edit 2 (Node Delete/Cut (refer to FIG. 120)):

(1) Select the Node to be deleted (cut), and right click.

(2) Select Delete (Cut) from the pop up menu.

(3) Node will be deleted.

Edit 3 (Undo (refer to FIG. 121)):

For all edit functions, Undo will cancel the most recent operation. Select Undo from the Edit in the Menu Bar, such as the right hand graph.

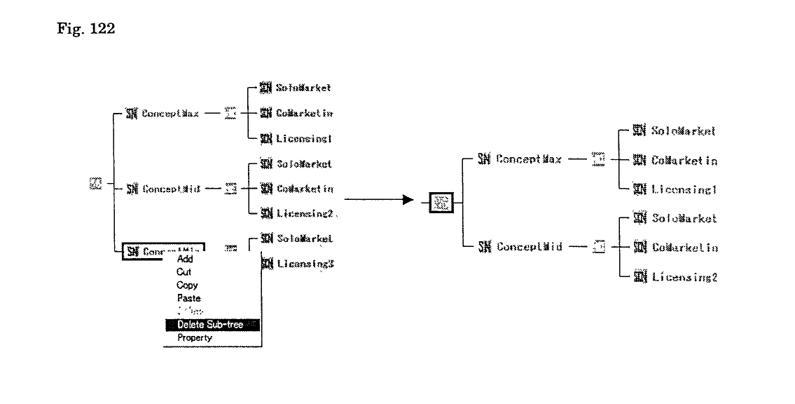

Edit 4 (Delete Sub-tree (refer to FIG. 122)):

(1) Select the parent Node that needs to be deleted together with a child Node, and right click.

(2) Select Delete Sub-tree from the pop up Menu.

(3) All of the child Node or Decision Point under the selected Node will be deleted.

What is a Sub Tree: A set of a Node or a Decision Point which is linked by a child and a grandchild.

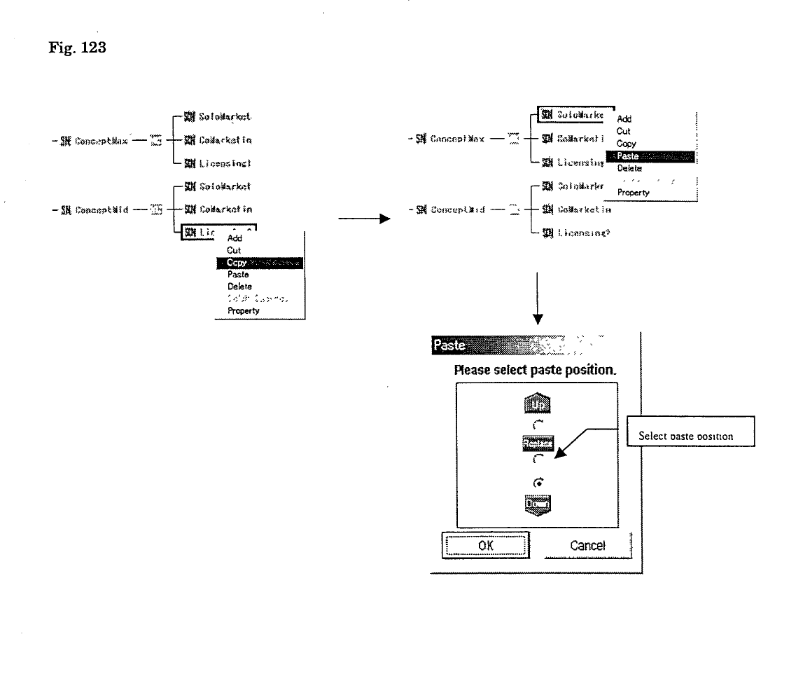

Edit 5 (Copy & Paste (similar for Cut & Paste) (refer to FIG. 123)):

(1) Select the Node to Copy&Paste (Cut&Paste), and right click.

(2) Select Copy from the pop up menu.

(3) Select Node to Paste, and right click.

(4) Select Paste from pop up menu.

(5) Select the Paset position at the dialog.

Up: Pasted above the object Node for Paste operation.

Replace: Object Node for Paste operation will be copied (cut), and be replaced.

Down: Pasted below the object Node for Paste operation.

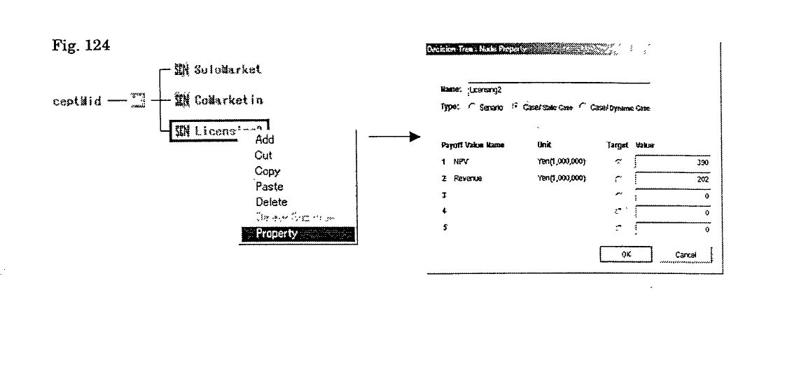

Edit 6 (Property (refer to FIG. 124)):

(1) Select the Node to be modified or select Property.

(2) Select Property from the pop up menu.

(3) Select Property after Select Property dialog appears (similar operation for Decision Point).

3.4. Save the Tree, Save in a Different Name:

3.4.1 Save:

(1) Select File from the Menu.

(2) Select Save.

3.4.2 Save in a Different Name:

(1) Select File from the Menu.

(2) Select Save as.

(3) Model Name screen will open.

(4) Input Tree Name and save.

It will become an error if the existing Tree Name is used. Not possible to create the same Tree Name.

3.5 Property:

Property of each Node Type will be described.

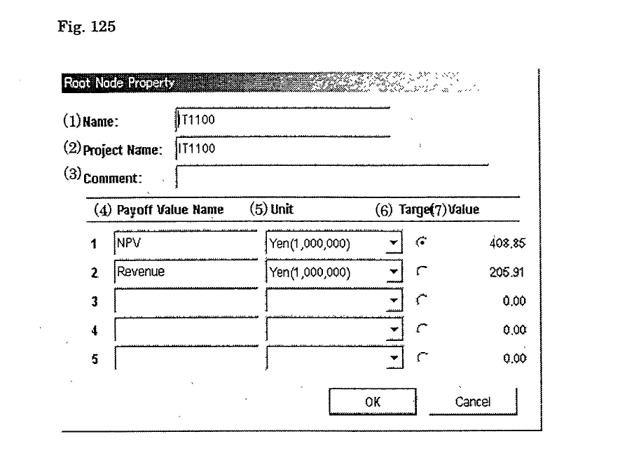

3.5.1 Root Node (Tree) Property (refer to FIG. 125):

Property defined in the Root Node can also be used as a Property for the overall Project Tree.

(1) Name: Name indicated in the Root Node. It can also be the name of a Tree. Maximum of 20 words (necessary).

(2) Project Name: Used as a Project Name when starting the “Project” formation function. Same as the Node Name when omitted (optional).

(3) Comment: Maximum of 50 words (optional).

(4) Payoff Value Name1-5: Name of the Payoff Value. Can be an optional naming. Maximum of 20 words (optional)

(5) Unit1-5: Select from List Box (optional).

(6) Target: Object (number) of the expected value calculation among the Payoff Value. Default is Payoff Value 1.

(7) Value: Input is not necessary. Value of each Payoff Value will be figured out after the calculation.

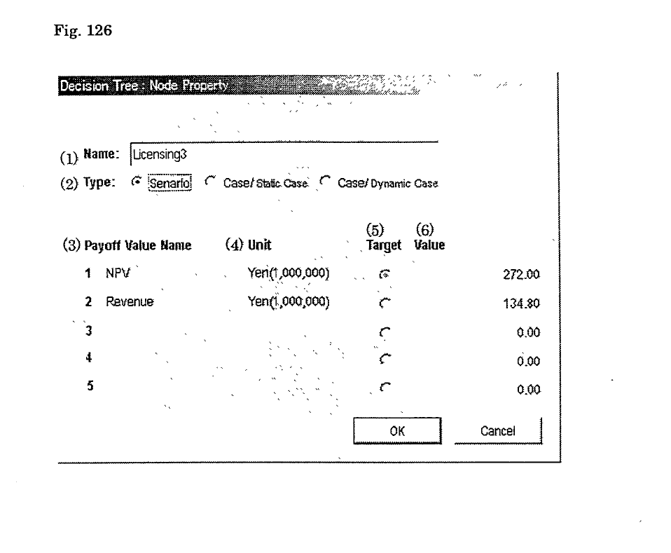

3.5.2 Scenario Node Property (refer to FIG. 126):

(1) Name: Name indicated in the Scenario Node. Maximum of 20 words (necessary).

(2) Type: Select from Scenario, Static Case and Dynamic Case. Default of New Node addition is Scenario.

(3) Payoff Value Name1-5: Select Root Node Property will appear.

(4) Unit1-5: Select Root Node Property will appear.

(5) Target (No): Select Root Node Property will appear.

(6) Value1-5: Value of each Payoff Value will be figured out after the calculation function starts.

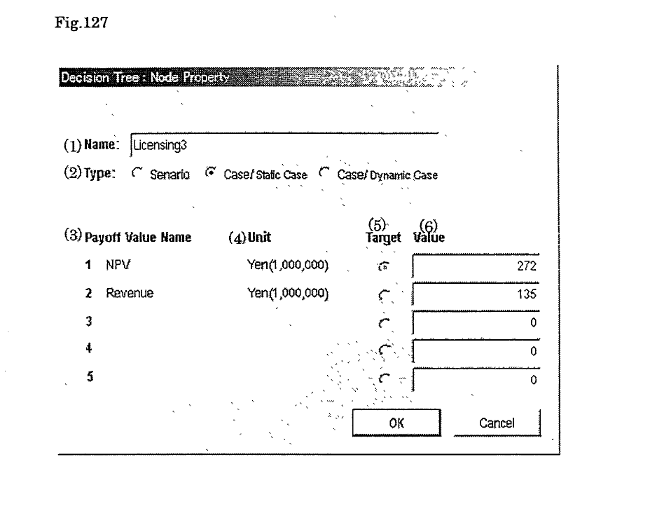

3.5.3 Static Case Node Property (refer to FIG. 127):

(1) Name: Name indicated in the Node. Maximum of 20 words (necessary).

(2) Type: Select from Scenario, Static Case, Dynamic Case. Default of New Node addition is Scenario.

(3) Payoff Value Name1-5: Select Root Node Property will appear.

(4) Unit1-5: Select Root Node Property will appear.

(5) Target (No): Select Root Node Property will appear.

(6) Value1-5: Select the value manually. Possible to input the actual numerical value from −999,999.99 to 999,999.99 (valid decimal point is 2 figures). When the Payoff Value Name is set, it is necessary to input the Payoff Value for that number.

3.5.4 DynamicCase Node Property (refer to FIG. 128):

(1) Name: Name indicated in the Node. Maximum of 20 words (necessary).

(2) Type: Situation where Static Case is selected (select from Scenario, Static Case, Dynamic Case. Default is Scenario).

(3) Project: Project Name in the eVE will be listed in name order. Default is a blank (necessary).

(4) Case: Case which belong to the selected Project will be listed in name order. Default is a blank (necessary).

(5) Model: Indicate a Tree Name which the selected Case is using (output only).

(6) Dataset: Dataset which belong to the selected Case will be listed in name order. Default is a blank.

(7) Payoff Value Name1-5: Select Root Node Property will appear.

(8) Unit1-5: Select Root Node Property will appear.

(9) Target (No): Select Root Node Property will appear.

(10) Value1-5: Indicate the Value copied from the reference which is selected in the Source. It will become an input field only when the Manual is selected in the Source Type. Possible to input the actual numerical value from −999,999.99 to 999,999.99 (valid decimal point is 2 figures)

(11) Source Type: Select the Source Type for a Value. When the Payoff Value Name is set, it is necessary to input the Payoff Value for that number. Below is the Option selection.

(a) Base: Measurement Value of a Cash Flow Analysis which uses the Base Value (Default).

(b) Probability Value: Measurement Value calculated in the Probability Distribution Analysis, or the range probability.

(c) Real Option Value: Option Value calculated in the Real Option Analysis.

(d) Manual: Manually input.

(12) Source Measurement: Select the Measurement Value which will be a reference for a Value, when the Source Type is either a Base or a Probability. NPV will automatically be set (cannot be selected) when the Real Option is the Source Type. Measurement Value of the Scalar Type will be listed in a priority. Default is the Measurement Value which has the highest priority order (usually the NPV).

(13) Source Value: Select the Value which to be copied from the analysis result. Valid only when the Source Type is either a Probability Value or a Real Option Value.

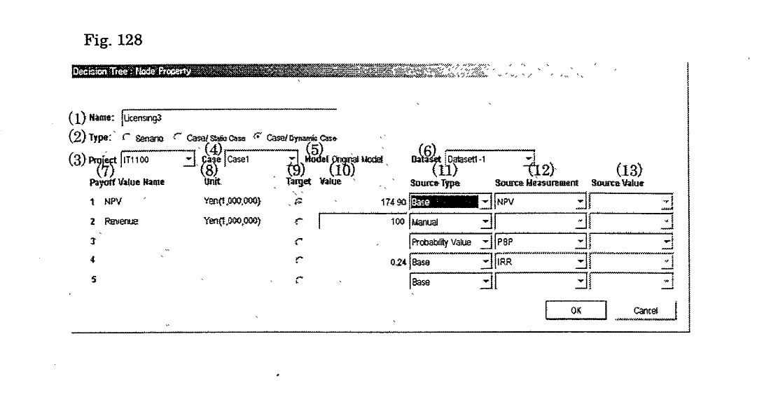

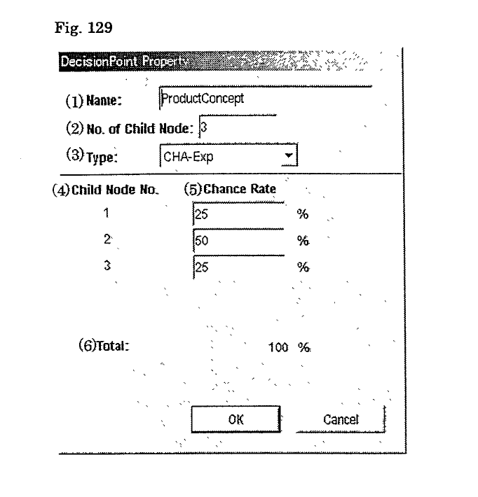

3.5.5 Decision Point Property (refer to FIG. 129):

There are CHA-Exp, SEL-Max, SEL-Min, SEL-Man Types in the Decision Point. Select Property will be described below.

3.5.5.1 When the Decision Point Type is a CHA-Exp:

Select the Chance Rate of the child Node. Calculate the expected Value from the total multiplied by the Target Payoff Value and it's each Chance Rate of a child, then output that to the adult Node.

(1) Name: Maximum of 20 words (necessary).

(2) No. of Child Node: Optional number from 2 to 20. Default will be 2 (necessary).

(3) Type (Milestone Type): (Necessary). Select from CHA-Exp/SEL-Max/SEL-Min/SEL-Man.

(4) Child Node No: (Output only).

(5) Chance Rate: Chance Rate of each child Node. Select it for each child Node, and the total will be 100. Optional number from 1 to 99 (necessary).

(6) Total: Total of Chance Rate. Error if total will not be 100 (output only).

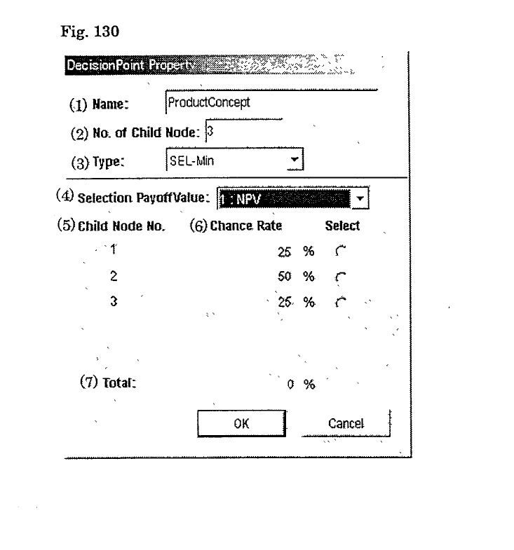

3.5.5.2 When the Decision Point Type is SEL-Max/SEL-Min (refer to FIG. 130):

Test the Target Payoff Value which is stored in the child Node, and select the Node that will have the High and the Low Value. Output all the Payoff Value selected for the Node to the adult Node.

Below is the Decision Point Property.

(1) Name: Maximum of 20 words (necessary).

(2) No. of Child Node: Optional number from 2 to 20. Default will be 2 (necessary).

(3) Type (Milestone Type) (necessary): Select from CHA-Exp/SEL-Max/SEL-Min/SEL-Man.

(4) Selection Payoff Value: Payoff Value used to judge the selection of a child Node. Indicate the Payoff Value Name as an option which is selected from number 1 to 5+ Root Node (necessary).

(5) Child Node No: (Output only).

(6) Chance Rate: Figured out after the calculation.

(7) Total: Total of Chance Rate (output only).

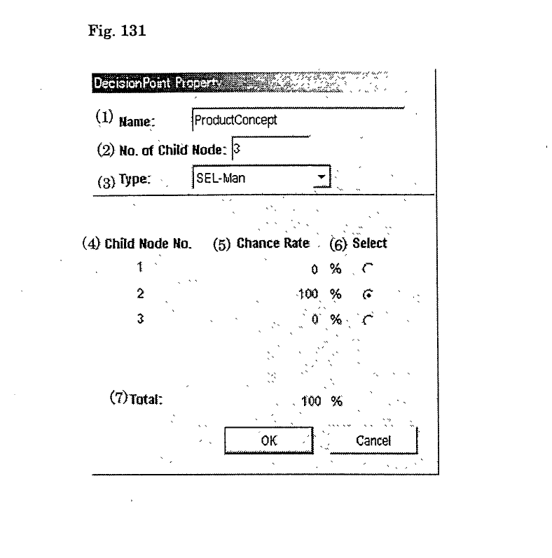

3.5.5.3 When the Decision Point Type is a SEL-Man (refer to FIG. 131):

Select the Node optionally by the user. Output all the Payoff Value for the selected Node to the adult Node. Below is the Decision Point Property.

(1) Name: Maximum of 20 words (necessary).

(2) No. of Child Node: Optional number from 2 to 20. Default will be 2 (necessary).

(3) Type (Milestone Type): (Necessary). Select from CHA-Exp/SEL-Max/SEL-Min/SEL-Man.

(4) Child Node No: Figured out after the calculation (output only).

(5) Chance Rate: Chance Rate for each child Node. Selected child Node will be 100% (output only).

(6) Select: Select the optional child Node. Default will be child Node 1 (necessary).

(7) Total: Total of Chance Rate (output only).

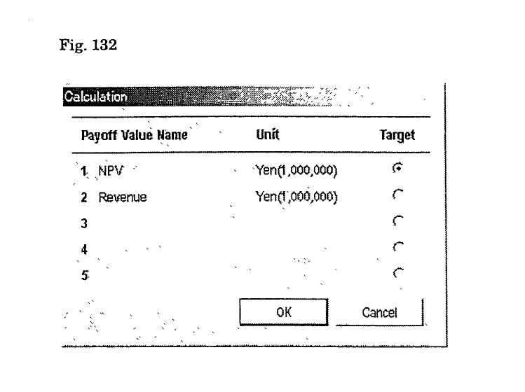

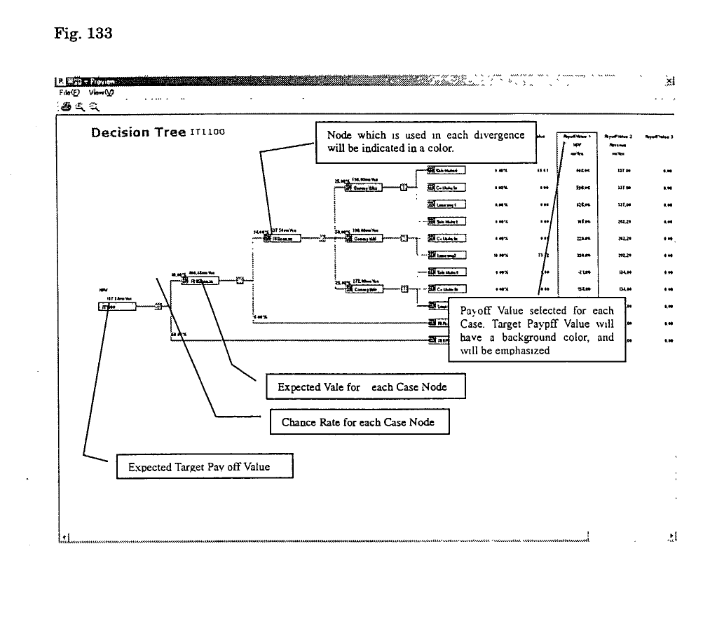

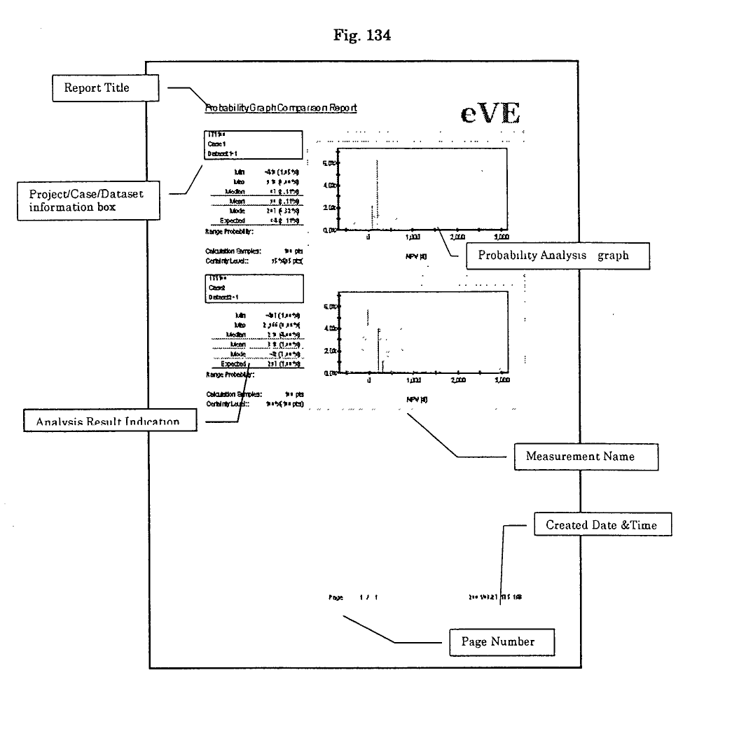

4. Usage of Analysis Window (refer to FIG. 132):

(1) Select File from the Menu.

(2) Select Calculation.

(3) Select the Target Payoff Value on the Calculation Window.

(4) Analysis Window will open after the OK button.

What is a Target Payoff Value: Payoff Value which will be the object for the expected value calculation of a Project Tree. Select during the course of the calculation, and will be indicated as a priority in the analysis window.

Contents of Probability Graph Comparison Report will now be described.

1. What is Probability Graph Comparison Report:

Probability Graph Comparison Report is a function to compare and examine the analysis results for the various Probability Analysis. Probability Analysis results for the Case/Dataset will be a precondition to output the Probability Graph Comparison Report.

2. Form of the Report:

In the Probability Graph Comparison Report, the graduation of the vertical and horizontal axis will be decided by using the lowest and the highest value of the output for all reports. All charts on the report will have the same graduation. Therefore, it is possible to relatively compare the Probability Analysis Graph data between Case/Dataset.

3. Usage of Probability Graph Comparison Report:

(1) Select the Probability Graph Comparison Report button at the Reporting Menu.

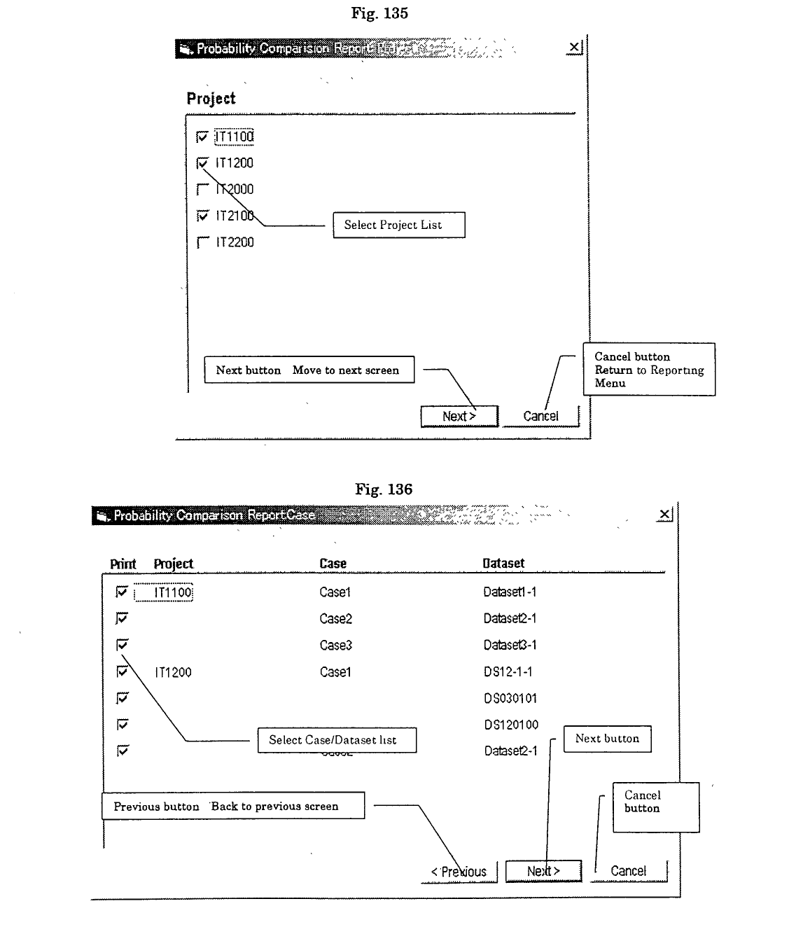

(2) At the Select Project Screen, check the object to be reported from the Select Report Project list (refer to FIG. 135).

(3) At the Select Case Screen, check the object to be reported from the Select Report Case list (refer to FIG. 136).

(4) Set the output order in Select Run-parameter Screen 1. Output default number will be in numerical order. Set the output order number in Select Order box (refer to FIG. 136).

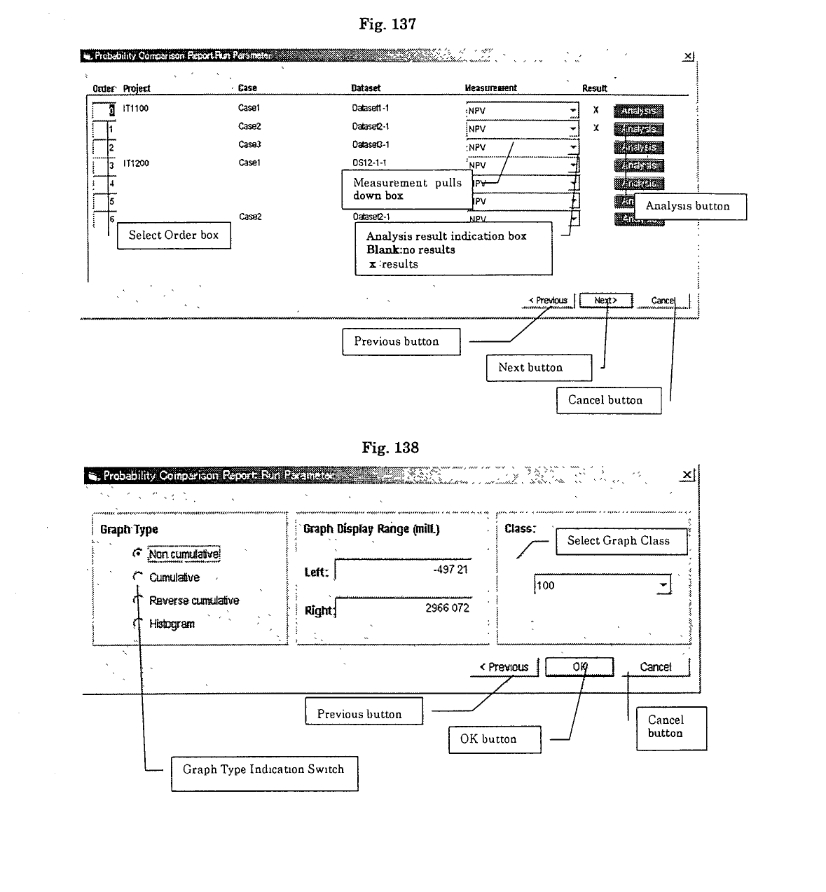

(5) At the Measurement pull down box in Select Run-parameter Screen 1, select the Measurement for each Case (refer to FIG. 137).

(6) Confirm the analysis results at the Select Run-parameter Screen 1. There are no analysis results for the ones without the X mark at the Result. Select the Analysis button to analyze (refer to FIG. 137). See the Probability Analysis description page in this manual for the analysis method.

(7) Select the Graph Type and Graph Display Range at the Select Run-parameter Screen 2 (refer to FIG. 138). See the Probability Analysis description page in this manual for Graph Type, Graph Display Range and Graph Class settings.

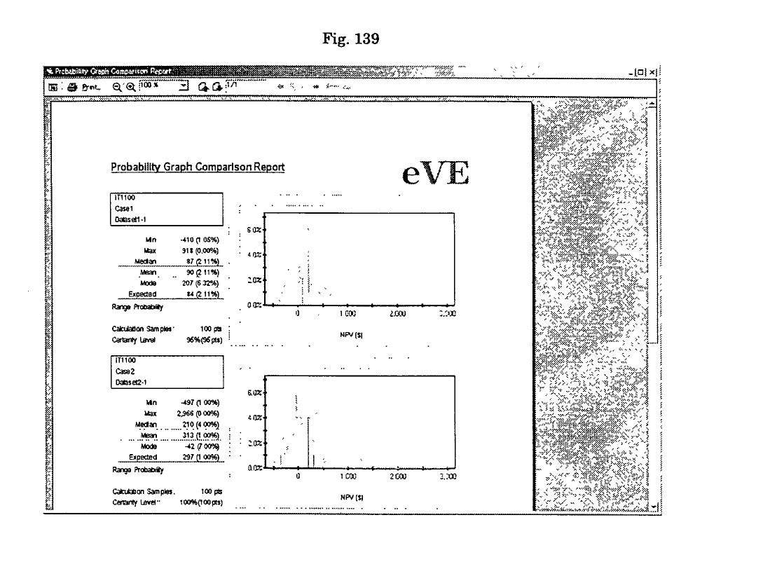

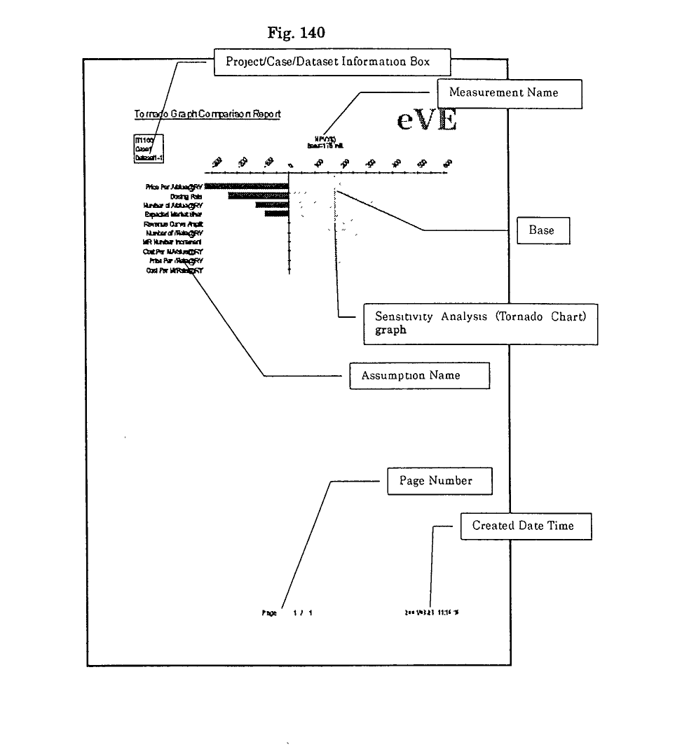

(8) Indicate printer preview screen (refer to FIG. 139). See Common Functions in this manual for printer preview screen.

Contents of Tornado Chart Comparison Report will now be described.

1. What is Tornado Chart Comparison Report:

Sensitivity Comparison Report is a report function to compare and examine the analysis results of the various Sensitivity Analysis.

2. Form of the Report:

In the Tornado Chart Comparison Report, the graduation of the horizontal axis will be decided by using the lowest and the highest value of the data output for all reports. All charts on the report will have the same graduation. Therefore, it is possible to relatively compare the Tornado Chart data between Case/Dataset.

3. Usage of Tornado Chart Comparison Report:

(1) Select the Tornado Chart Comparison Report button at the Reporting Menu.

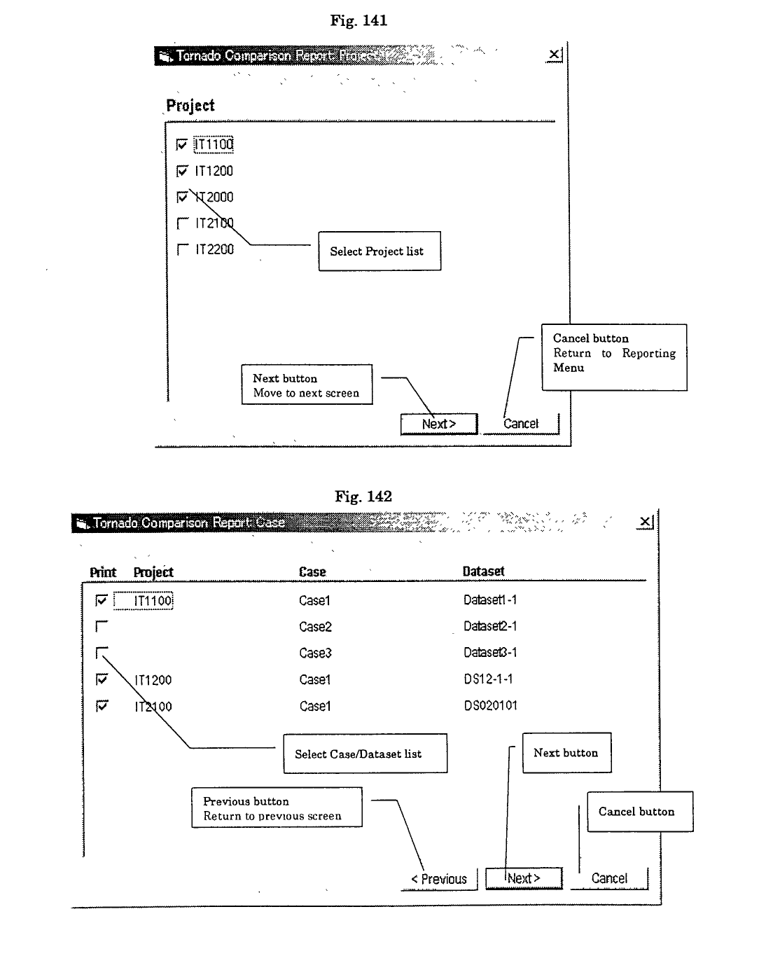

(2) At the Select Project Screen, check the object to be reported from the Select Project list (refer to FIG. 141).

(3) At the Select Case Screen, check the object to be reported from the Select Case/Dataset list (refer to FIG. 142).

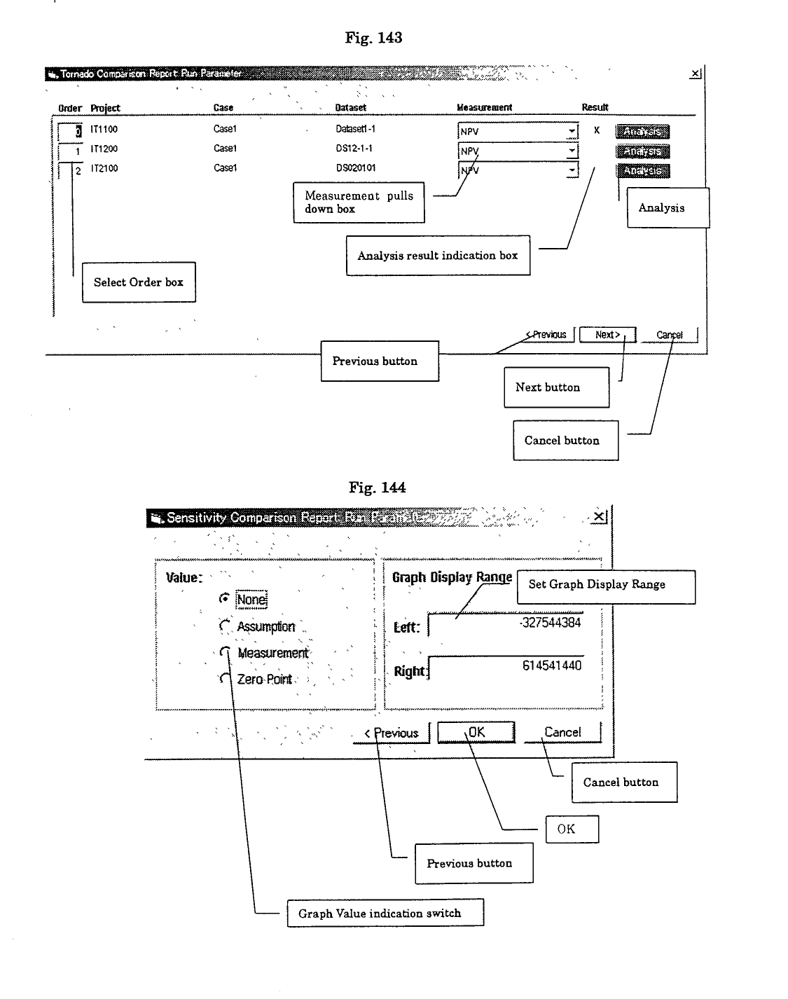

(4) Set the output order in Select Run-parameter Screen 1. Output default number is in numerical order. Set the output order number in Select Order box (refer to FIG. 143).

(5) At the Measurement pull down box in Select Run-parameter Screen 1, select the Measurement for each Case (refer to FIG. 143).

(6) Confirm the analysis results at the Select Run-parameter Screen 1. There are no analysis results for the ones without the X mark at the Result. Select the Analysis button to analyze (refer to FIG. 143). See the Sensitivity Analysis description page in this manual for the analysis method.

(7) Select the Graph Value and Graph Display Range at the Select Run-parameter Screen 2 (refer to FIG. 144). Seethe Sensitivity Analysis description page in this manual for Graph Display Range settings.

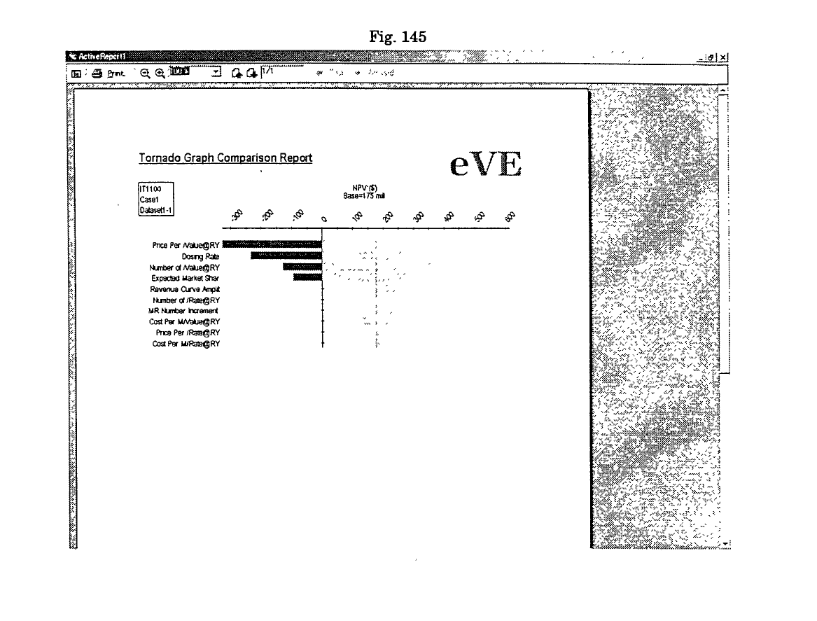

(8) Indicate printer preview screen (refer to FIG. 145). See the Common Functions in this manual for printer preview screen.

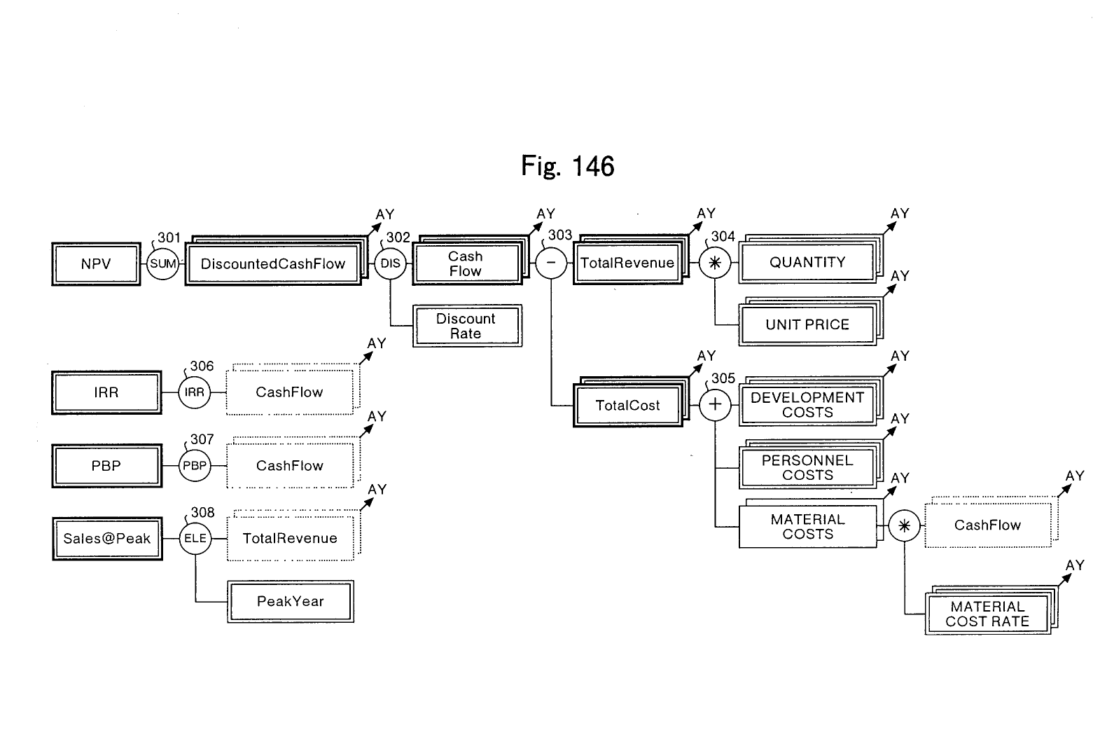

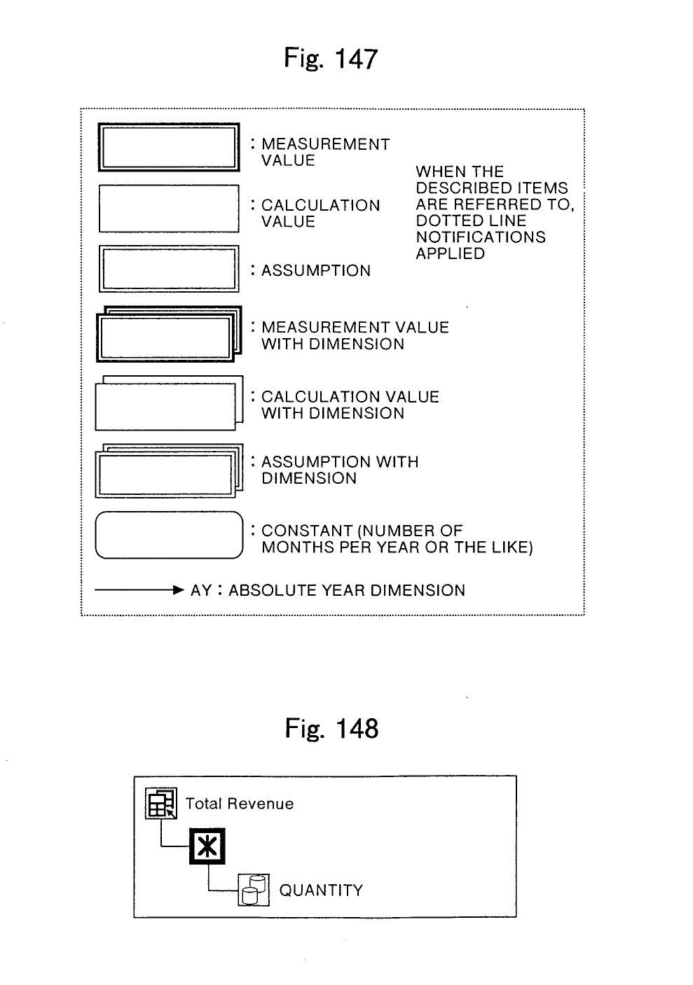

A specific example of a profit model will now be described. FIG. 146 is an explanatory diagram which shows one example of a profit mode, and FIG. 147 is an explanatory diagram which shows contents which shapes of frames of respective items indicate. In FIG. 146, an icon “SUN” 301 is a Total Function, which totals values of the series value from the first year to the end year (namely, a discounted cash flow) to obtain NPV. Also, an icon “DIS” 302 is a Discounting Function, which discounts the Series value (namely, the cash flow) by a Scalar value (namely, a discount rate). The Discount Function outputs a Series value for child 1 value which is discounted by the discount rate defined from the child 2.

Also, an icon “−” 303 shows Subtract, in which a value subtracted from the top item (namely, total revenue) by the following Item (namely, total cost) becomes the cash flow. Also, an icon “*” shows Multiply, in which the total revenue is obtained by multiplying quantity by unit price. Also, an icon “+” shows Add, in which the total cost can be obtained by adding development costs, personnel costs and material costs.

Further, an icon “IRR” 306 shows Internal Rate of Return Function, which calculates the Internal Rate of Return from the Series value (namely, a cash flow). Also, an icon “RBP” 307 shows a Recovery Year Function, which calculates the period until the cumulative value of the Series value will become a plus. Also, an icon “ELE” 308 shows Element Function, in which pulls out the year selected by the Scalar value from the Series value. An element of a number defined in child 2 within the element of child 1 is pulled out.

Thus, the profit model 111 is completed. However, the contents shown in FIG. 146, the configuration has been simplified for convenience sake of explanation, but an actual profit model includes a vast number of items and icons and has a complicated structure.

Contents of Error Display Screen will now be described. FIGS. 148 to 150 show an error display screen, where, since an error display is performed at a time of model creation, a trouble during analysis can be prevented in advance. FIG. 148 is a display screen which shows an error of a calculation logic, in which, when the number of items required for a calculation logic is unsatisfactory, or when the number of items exceeding the required number thereof is provided, the color of a connection frame is changed to a predetermined color (for example, red) to perform an error display. For example, in case that the number of items to be used for Multiply is only one in spite of Multiply, an error display is performed.

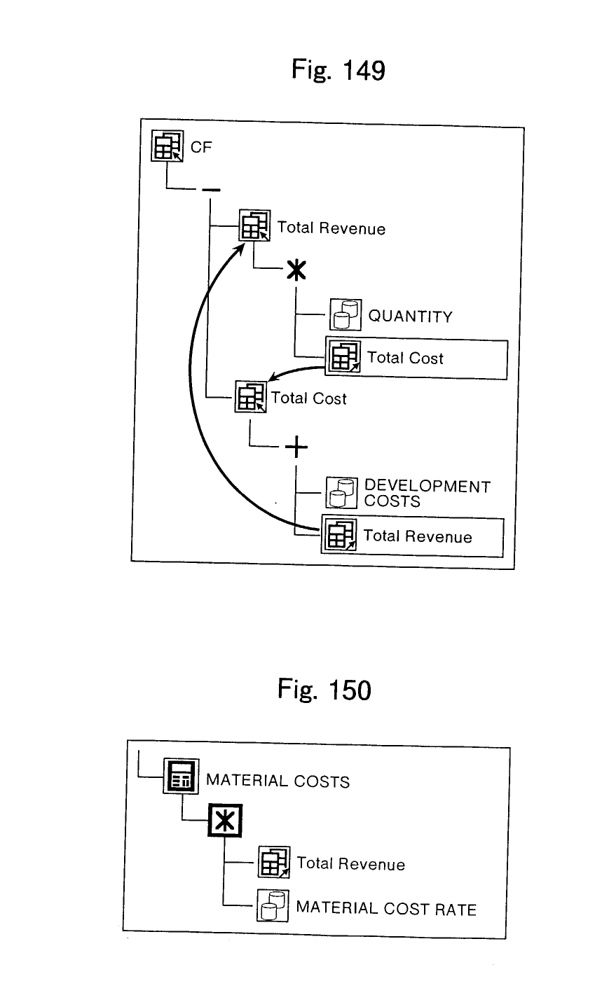

Also, FIG. 149 is a display screen which shows a circulation reference error, in which, when a calculation logic is circulated by a reference Item, the Item is colored to a predetermined color (for example, yellow) to perform an error display. Also, FIG. 150 is a display screen which shows mismatch of series/Scalar Items, where, when a child item includes a series item, a parent item also becomes a Series item. Also, when the child item includes only a Scalar item, the parent item becomes a Scalar item. In case that this condition is not met, a connection is displayed with a predetermined color (for example, red) frame. For example, when the parent item is a Scalar item and the child item is a Series item, the connection is displayed with a red frame.

As explained above, the investment decision making supporting apparatus according to the embodiment of the present invention has the following effects.

Diversified Evaluation:

According to various analysis functions provided by the RadMap, it is made possible to perform an investment evaluation from various points, such as a payability, a realization possibility, a risk, the entire, the optimum and the like. Also, in addition to an evaluation of a business value obtained according to DCF where a strategy has been fixed, a business evaluation according to Real Option utilizing a flexible strategy can be carried out.

Standardization of Analysis Process:

RadMap forms an investment evaluation platform which centralizes or integrate evaluation models, an evaluation processes, outputs for analysis and the like. Since a common platform can be obtained, the efficiency of the investment evaluation work is promoted and simultaneously a more accurate investment evaluation can be achieved.

Fine Analysis:

In the investment evaluation performed by the RadMap, a profit structure model which is established by a user himself/herself is used. It is possible to modify a model to be used according to data contents available, or according to a development strategy/sales strategy employed. By utilizing a profit structure model optimized so as to correspond to the accuracy of data or a business strategy, an investment evaluation with a higher accuracy can be realizes.

Improvement of Evaluation System according to estimated and actual analyses:

In the RadMap, it is possible to manage evaluation models or data to be utilized for analysis and the analysis results in a centralized manner to store and manage both the evaluation results at the time of estimation and the actual results. By performing comparative analysis between the estimate value and the actual value to reflect the resultant data to a profit structure model or future estimate data, an investment evaluation process can be improved successively.

Efficiency Increase of Work:

The analysis engine of the RadMap automates an analysis which will be complicated and time-consumable in a manual work. Thereby, a rapid and accurate investment evaluation process can be achieved.

Also, the investment decision making supporting method in this embodiment may be a computer-readable program which has been prepared in advance, and it may be realized by causing a computer such as a personal computer, a workstation or the like to execute the program. This program is recorded on a computer-readable medium such as a HD (hard disk), a FD (floppy disk), a CD-ROM, an MO, a DVD or the like, and the program is executed by being read from the recording medium by a computer. Also, the program may be a transmission medium which can be distributed via a network such as Internet.

As explained above, since the present invention comprising: Creating or changing a profit model which shows a relationship between any parameter and a cash flow; creating or changing a data set including values of the parameter; saving a case where one profit model created or modified in the profit model editing step is associated with one or plural data sets which has been created or modified in the data set editing unit; performing various analysis processings of a working case comprising the profit model of the case which has been saved in the case saving step the one data set or one of the plural data sets as a minimum unit of simulation; and displaying an analysis result obtained by the analysis processing, various analysis functions are integrated, a common project profit model and uncertainty data managed in a centralized manner can be utilized, the analysis results between respective functions can be utilized commonly, and a common evaluation standard can be realized. Thereby, such an effect can be achieved that a valuation (economic value evaluation) of a R&D project accompanying a high risk and a large scale of investment is performed and an economic value of the project fluctuated according to various uncertainties is simulated so that an investment decision making apparatus, an investment decision making method, and a program which causes a computer to execute the method which can support the optimal investment decision making can be attained.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for supporting an investment decision making, comprising:
a profit model editing unit which creates or modifies a profit model which shows a relationship between any parameter and cash flow;
a data set editing unit which creates and modified a data set including values of the parameter;
a case saving unit which saves a case where a profit model which has been created or modified by the profit model editing unit is associated with one or plural data sets which have been created or modified by the data set editing unit;
an analysis processing unit which performs various analysis processings of a working case comprising the profit model of the case which has been saved by the case saving unit and the one data set or one of the plurality of data sets as the minimum unit of simulation; and
a display unit which displays the analysis result obtained by the analysis processing performed by the analysis processing unit.

2. An apparatus for supporting an investment decision making according to claim 1, further comprising a case editing unit which edits the case.

3. An apparatus for supporting an investment decision making according to claim 2, wherein the case editing unit sets an assumption value to time series data.

4. An apparatus for supporting an investment decision making according to claim 1, wherein the profit model is for calculating the cash flow during a full or partial lifetime of a product from a research and development until a sales finish.

5. An apparatus for supporting an investment decision making according to claim 1, wherein the profit model is constituted by a tree structure.

6. An apparatus for supporting an investment decision making according to claim 1, wherein the parameter is a parameter relating to either one of a macro economic indicator, a price of the product and a resource volume of the product.

7. An apparatus for supporting an investment decision making according to claim 1, wherein the data set further includes information on uncertainty.

8. An apparatus for supporting an investment decision making according to claim 7, wherein the information on uncertainty is a value of a range or distribution representing uncertainty.

9. An apparatus for supporting an investment decision making according to claim 1, wherein, when the profit model editing unit creates or modifies the profit model, the profit model editing unit extracts an error of a computing logic.

10. An apparatus for supporting an investment decision making according to claim 1, wherein, when the profit model editing unit creates or modifies the profit model, the profit model editing unit extracts an error of a circulation reference where a computing logic is circulated according to a reference item.

11. An apparatus for supporting an investment decision making according to claim 1, wherein, in a sensitivity analysis performing analysis about how a modification of the assumption value included in the profit model influences a business value, Tornado chart is used, sensitivities to measurement values obtained when the assumption value is modified are indicated with widths of the bar graphs, the bar graphs are represented in the order from the larger value of the widths thereof from the top, and a bar graph where the assumption value is equal to or less than a base value is represented with a color different from a color of a bar graph where the assumption value is more than the base value.

12. A method for supporting an investment decision making comprising:
a profit model editing step of creating or changing a profit model which shows a relationship between any parameter and a cash flow;
a data set editing step of creating or changing a data set including values of the parameter;
a case saving step of saving a case where one profit model created or modified in the profit model editing step is associated with one or plural data sets which has been created or modified in the data set editing step;
an analysis processing step of performing various analysis processings of a working case comprising the profit model of the case which has been saved in the case saving step the one data set or one of the plural data sets as a minimum unit of simulation; and
a display step of displaying an analysis result obtained by the analysis processing in the analysis processing step.

13. A method for supporting an investment decision making according to claim 12, further comprising a case editing step of editing the case.

14. A method for supporting an investment decision making according to claim 13, wherein the case editing step set an assumption value to time series data.

15. A method for supporting an investment decision making according to claim 12, wherein the profit model is for calculating the cash flow during a full or partial lifetime of a product from a research and development until a sales finish.

16. A method for supporting an investment decision making according to claim 12, wherein the profit model is constituted by a tree structure.

17. A method for supporting an investment decision making according to claim 12, wherein the parameter is a parameter relating to either one of a macro economic indicator, a price of the product and a resource volume of the product.

18. A method for supporting an investment decision making according to claim 12, wherein the data set further includes information on uncertainty.

19. A method for supporting an investment decision making according to claim 18, wherein the information on uncertainty is a value of a range or distribution representing uncertainty.

20. A method for supporting an investment decision making according to claim 12, wherein, when the profit model editing step creates or modifies the profit model, the profit model editing unit extracts an error of a computing logic.

21. A method for supporting an investment decision making according to claim 12, wherein, when the profit model editing step creates or modifies the profit model, the profit model editing unit extracts an error of a circulation reference where a computing logic is circulated according to a reference item.

22. A method for supporting an investment decision making according to claim 12, wherein, in a sensitivity analysis performing analysis about how a modification of the assumption value included in the profit model influences a business value, Tornado chart is used, sensitivities to measurement values obtained when the assumption value is modified are indicated with widths of the bar graphs, the bar graphs are represented in the order from the larger value of the widths thereof from the top, and a bar graph where the assumption value is equal to or less than a base value is represented with a color different from a color of a bar graph where the assumption value is more than the base value.

23. A computer program containing instructions which when executes on a computer a uses the computer to perform:
a profit model editing step of creating or changing a profit model which shows a relationship between any parameter and a cash flow;
a data set editing step of creating or changing a data set including values of the parameter;
a case saving step of saving a case where one profit model created or modified in the profit model editing step is associated with one or plural data sets which has been created or modified in the data set editing step;
an analysis processing step of performing various analysis processings of a working case comprising the profit model of the case which has been saved in the case saving step the one data set or one of the plural data sets as a minimum unit of simulation; and
a display step of displaying an analysis result obtained by the analysis processing in the analysis processing step.

24. The computer program according to claim 23, further comprising a case editing step of editing the case.

25. The computer program according to claim 24, wherein the case editing step set an assumption value to time series data.

26. The computer program according to claim 23, wherein the profit model is for calculating the cash flow during a full or partial lifetime of a product from a research and development until a sales finish.

27. The computer program according to claim 23, wherein the profit model is constituted by a tree structure.

28. The computer program according to claim 23, wherein the parameter is a parameter relating to either one of a macro economic indicator, a price of the product and a resource volume of the product.

29. A method for supporting an investment decision making according to claim 12, wherein the data set further includes information on uncertainty.

30. The computer program according to claim 29, wherein the information on uncertainty is a value of a range or distribution representing uncertainty.

31. The computer program according to claim 23, wherein, when the profit model editing step creates or modifies the profit model, the profit model editing unit extracts an error of a computing logic.

32. The computer program according to claim 23, wherein, when the profit model editing step creates or modifies the profit model, the profit model editing unit extracts an error of a circulation reference where a computing logic is circulated according to a reference item.

33. The computer program according to claim 23, wherein, in a sensitivity analysis performing analysis about how a modification of the assumption value included in the profit model influences a business value, Tornado chart is used, sensitivities to measurement values obtained when the assumption value is modified are indicated with widths of the bar graphs, the bar graphs are represented in the order from the larger value of the widths thereof from the top, and a bar graph where the assumption value is equal to or less than a base value is represented with a color different from a color of a bar graph where the assumption value is more than the base value.
